(19) United States
(12) Patent Application Publication
(10) Pub. No.: US 2023/0245654 A1
(43) Pub. Date: Aug. 3, 2023

(54) Systems and Methods for Implementing Smart Assistant Systems

(71) Applicant: Meta Platforms, Inc., Menlo Park, CA (US)

(72) Inventors: Akshat Shrivastava, Redmond, WA (US); Shrey Desai, Jersey City, NJ (US); Anchit Gupta, Mountain View, CA (US); Ali Elkahky, Seattle, WA (US); Aleksandr Livshits, Sammamish, WA (US); Alexander Kolmykov-Zotov, Sammamish, WA (US); Ahmed Aly, Kirkland, WA (US); Jinsong Yu, BELLEVUE, WA (US); Manali Anand Naik, Seattle, WA (US); Shuhui Yang, Union City, CA (US); Baiyang Liu, Bellevue, WA (US); Surya Teja Appini, Mountain View, CA (US); Tarun Vir Singh, San Jose, CA (US); Hang Su, Seattle, WA (US); Jiedan Zhu, Palo Alto, CA (US); Fuchun Peng, Palo Alto, CA (US); Shoubhik Bhattacharya, Seattle, WA (US); Kshitiz Malik, Palo Alto, CA (US); Shreyan Bakshi, Mountain View, CA (US); Akash Bharadwaj, San Jose, CA (US); Harish Srinivas, Fremont, CA (US); Xiao Yang, Savoy, IL (US); Zhuangqun Huang, Redmond, WA (US); Gil Keren, San Francisco, CA (US); Duc Hoang Le, San Jose, CA (US); Ahmed Kamal Atwa Mohamed, Redmond, WA (US); Zhe Liu, Sunnyvale, CA (US); Pranab Mohanty, Redmond, WA (US)

(21) Appl. No.: 18/157,413

(22) Filed: Jan. 20, 2023

Related U.S. Application Data
(60) Provisional application No. 63/305,061, filed on Jan. 31, 2022.
(60) Provisional application No. 63/379,961, filed on Oct. 18, 2022.
(60) Provisional application No. 63/382,044, filed on Nov. 2, 2022.
(60) Provisional application No. 63/383,579, filed on Nov. 14, 2022.
(60) Provisional application No. 63/477,524, filed on Dec. 28, 2022.

(51) Int. Cl. G10L 15/22; G10L 15/18; G10L 15/30; G10L 15/06; G10L 15/197; H04L 9/40

(52) U.S. Cl. CPC G10L 15/22; G10L 15/1815; G10L 15/30; G10L 15/063; G10L 15/197; H04L 63/0428; G10L 2015/223; G10L 2015/086

(57) ABSTRACT

In one embodiment, a system includes an automatic speech recognition (ASR) module, a natural-language understanding (NLU) module, a dialog manager, one or more agents, an arbitrator, a delivery system, one or more processors, and a non-transitory memory coupled to the processors comprising instructions executable by the processors, the processors operable when executing the instructions to receive a user input, process the user input using the ASR module, the NLU module, the dialog manager, one or more of the agents, the arbitrator, and the delivery system, and provide a response to the user input.

### PRIORITY

This application claims the benefit under 35 U.S.C. § 119(e) of U.S. Provisional Patent Application No. 63/305,061, filed 31 Jan. 2022, U.S. Provisional Patent Application No. 63/379,961, filed 18 Oct. 2022, U.S. Provisional Patent Application No. 63/382,044, filed 2 Nov. 2022, U.S. Provisional Patent Application No. 63/383,579, filed 14 Nov. 2022, U.S. Provisional Patent Application No. 63/477,524, filed 28 Dec. 2022, each of which is incorporated herein by reference.

### TECHNICAL FIELD

This disclosure generally relates to databases and file management within network environments, and in particular relates to hardware and software for smart assistant systems.

### BACKGROUND

An assistant system can provide information or services on behalf of a user based on a combination of user input, location awareness, and the ability to access information from a variety of online sources (such as weather conditions, traffic congestion, news, stock prices, user schedules, retail prices, etc.). The user input may include text (e.g., online chat), especially in an instant messaging application or other applications, voice, images, motion, or a combination of them. The assistant system may perform concierge-type services (e.g., making dinner reservations, purchasing event tickets, making travel arrangements) or provide information based on the user input. The assistant system may also perform management or data-handling tasks based on online information and events without user initiation or interaction. Examples of those tasks that may be performed by an assistant system may include schedule management (e.g., sending an alert to a dinner date that a user is running late due to traffic conditions, update schedules for both parties, and change the restaurant reservation time). The assistant system may be enabled by the combination of computing devices, application programming interfaces (APIs), and the proliferation of applications on user devices.

A social-networking system, which may include a social-networking website, may enable its users (such as persons or organizations) to interact with it and with each other through it. The social-networking system may, with input from a user, create and store in the social-networking system a user profile associated with the user. The user profile may include demographic information, communication-channel information, and information on personal interests of the user. The social-networking system may also, with input from a user, create and store a record of relationships of the user with other users of the social-networking system, as well as provide services (e.g. profile/news feed posts, photo-sharing, event organization, messaging, games, or advertisements) to facilitate social interaction between or among users.

The social-networking system may send over one or more networks content or messages related to its services to a mobile or other computing device of a user. A user may also install software applications on a mobile or other computing device of the user for accessing a user profile of the user and other data within the social-networking system. The social-networking system may generate a personalized set of content objects to display to a user, such as a newsfeed of aggregated stories of other users connected to the user.

### BRIEF DESCRIPTION OF THE DRAWINGS

FIG. 1 illustrates an example network environment associated with an assistant system.

FIG. 2 illustrates an example architecture of the assistant system.

FIG. 3 illustrates an example flow diagram of the assistant system.

FIG. 4 illustrates an example task-centric flow diagram of processing a user input.

FIG. 5 illustrates an example flow diagram of retrieve-and-fill for scenario-based task-oriented semantic parsing.

FIG. 6 illustrates an example visualization of the semantic space for the weather domain as the model is trained on more and more data.

FIG. 7 illustrates an example depiction of scenario visualizations.

FIG. 8 illustrates an example architecture for a conventional voice assistant.

FIG. 9 illustrates an example architecture of one-shot messaging.

FIG. 10 illustrates an example comparison between current experience of conventional voice assistants and with support for message replay.

FIG. 11 illustrates an example comparison between current experience of conventional voice assistants and one-shot messaging with support for message replay.

FIG. 12 illustrates an example comparison between current experience of conventional voice assistants and one-shot messaging with support for message replay and rephrasing.

FIG. 13 illustrates an example comparison between current experience of conventional voice assistants and model-based dialog.

FIG. 14 illustrates an example comparison between different domains.

FIG. 15 illustrates example targets for end-pointer training based on hardcoded binary values and soft-coded float values.

FIG. 16 illustrates an example overall pipeline of end-pointing with regression.

FIG. 17 illustrates an example frequency distribution of the proxy dataset.

FIG. 18 illustrates an example graph showing the Recall@10K for the federated analytics mechanism disclosed herein.

FIGS. 19A-19B illustrate example graphs for hypothesis testing.

FIG. 20 illustrates example impact to recall@10K.

FIG. 21 illustrates an example graph regarding recall@10K for a linear data distribution.

FIG. 22 illustrates example graphs showing recall@10K by running the iterative data collection mechanism disclosed herein for 10 rounds.

FIG. 23 illustrates an example workflow of using semi-supervised learning with lightweight supervision to improve ASR models.

FIG. 24 illustrates an example process of expanding coverage of lightweight supervision.

FIG. 25 illustrates example performances of different RNN-T models trained with live traffic data except the leftmost bar (the baseline model).

FIG. 26 illustrates example evaluations of ASR models trained with different sizes of data on three live traffic test sets.

FIG. 27 illustrates example evaluations of ASR models trained on light-weight supervision on three live traffic test sets.

FIG. 28 illustrates an example view of an embedding space.

FIG. 29 illustrates an example computer system.

### DESCRIPTION OF EXAMPLE EMBODIMENTS

### System Overview

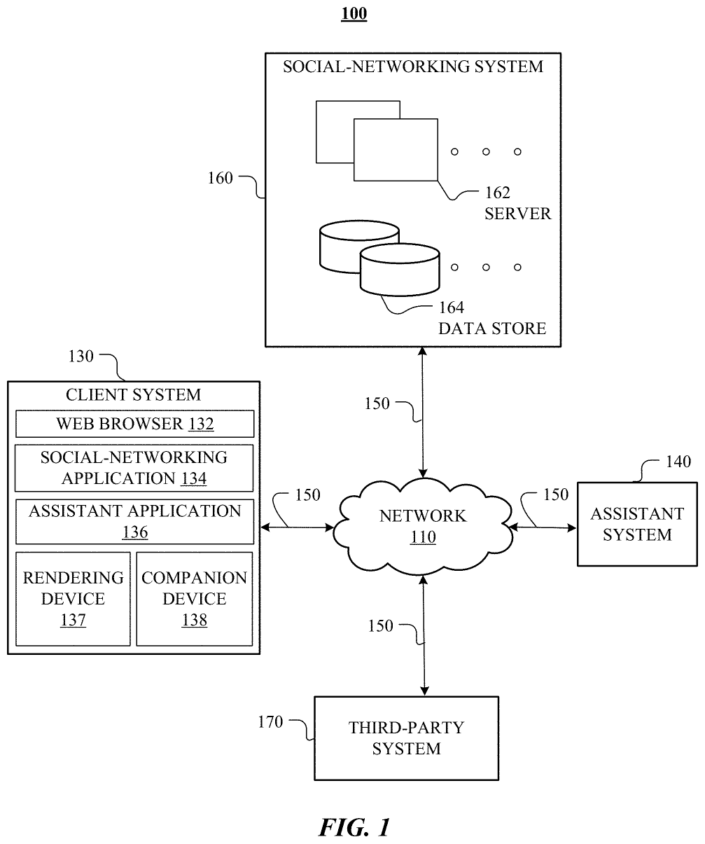

FIG. 1 illustrates an example network environment 100 associated with an assistant system. Network environment 100 includes a client system 130, an assistant system 140, a social-networking system 160, and a third-party system 170 connected to each other by a network 110. Although FIG. 1 illustrates a particular arrangement of a client system 130, an assistant system 140, a social-networking system 160, a third-party system 170, and a network 110, this disclosure contemplates any suitable arrangement of a client system 130, an assistant system 140, a social-networking system 160, a third-party system 170, and a network 110. As an example and not by way of limitation, two or more of a client system 130, a social-networking system 160, an assistant system 140, and a third-party system 170 may be connected to each other directly, bypassing a network 110. As another example, two or more of a client system 130, an assistant system 140, a social-networking system 160, and a third-party system 170 may be physically or logically co-located with each other in whole or in part. Moreover, although FIG. 1 illustrates a particular number of client systems 130, assistant systems 140, social-networking systems 160, third-party systems 170, and networks 110, this disclosure contemplates any suitable number of client systems 130, assistant systems 140, social-networking systems 160, third-party systems 170, and networks 110. As an example and not by way of limitation, network environment 100 may include multiple client systems 130, assistant systems 140, social-networking systems 160, third-party systems 170, and networks 110.

This disclosure contemplates any suitable network 110. As an example and not by way of limitation, one or more portions of a network 110 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular technology-based network, a satellite communications technology-based network, another network 110, or a combination of two or more such networks 110.

Links 150 may connect a client system 130, an assistant system 140, a social-networking system 160, and a third-party system 170 to a communication network 110 or to each other. This disclosure contemplates any suitable links 150. In particular embodiments, one or more links 150 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 150 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 150, or a combination of two or more such links 150. Links 150 need not necessarily be the same throughout a network environment 100. One or more first links 150 may differ in one or more respects from one or more second links 150.

In particular embodiments, a client system 130 may be any suitable electronic device including hardware, software, or embedded logic components, or a combination of two or more such components, and may be capable of carrying out the functionalities implemented or supported by a client system 130. As an example and not by way of limitation, the client system 130 may include a computer system such as a desktop computer, notebook or laptop computer, netbook, a tablet computer, e-book reader, GPS device, camera, personal digital assistant (PDA), handheld electronic device, cellular telephone, smartphone, smart speaker, smart watch, smart glasses, augmented-reality (AR) smart glasses, virtual reality (VR) headset, other suitable electronic device, or any suitable combination thereof. In particular embodiments, the client system 130 may be a smart assistant device. More information on smart assistant devices may be found in U.S. patent application Ser. No. 15/949,011, filed 9 Apr. 2018, U.S. patent application Ser. No. 16/153,574, filed 5 Oct. 2018, U.S. Design patent application Ser. No. 29/631,910, filed 3 Jan. 2018, U.S. Design patent application Ser. No. 29/631,747, filed 2 Jan. 2018, U.S. Design patent application Ser. No. 29/631,913, filed 3 Jan. 2018, and U.S. Design patent application Ser. No. 29/631,914, filed 3 Jan. 2018, each of which is incorporated by reference. This disclosure contemplates any suitable client systems 130. In particular embodiments, a client system 130 may enable a network user at a client system 130 to access a network 110. The client system 130 may also enable the user to communicate with other users at other client systems 130.

In particular embodiments, a client system 130 may include a web browser 132, and may have one or more add-ons, plug-ins, or other extensions. A user at a client system 130 may enter a Uniform Resource Locator (URL) or other address directing a web browser 132 to a particular server (such as server 162, or a server associated with a third-party system 170), and the web browser 132 may generate a Hyper Text Transfer Protocol (HTTP) request and communicate the HTTP request to server. The server may accept the HTTP request and communicate to a client system 130 one or more Hyper Text Markup Language (HTML) files responsive to the HTTP request. The client system 130 may render a web interface (e.g. a webpage) based on the HTML files from the server for presentation to the user. This disclosure contemplates any suitable source files. As an example and not by way of limitation, a web interface may be rendered from HTML files, Extensible Hyper Text Markup Language (XHTML) files, or Extensible Markup Language (XML) files, according to particular needs. Such interfaces may also execute scripts, combinations of markup language and scripts, and the like. Herein, reference to a web interface encompasses one or more corresponding source files (which a browser may use to render the web interface) and vice versa, where appropriate.

In particular embodiments, a client system 130 may include a social-networking application 134 installed on the client system 130. A user at a client system 130 may use the social-networking application 134 to access on online social network. The user at the client system 130 may use the social-networking application 134 to communicate with the user's social connections (e.g., friends, followers, followed accounts, contacts, etc.). The user at the client system 130 may also use the social-networking application 134 to interact with a plurality of content objects (e.g., posts, news articles, ephemeral content, etc.) on the online social network. As an example and not by way of limitation, the user may browse trending topics and breaking news using the social-networking application 134.

In particular embodiments, a client system 130 may include an assistant application 136. A user at a client system 130 may use the assistant application 136 to interact with the assistant system 140. In particular embodiments, the assistant application 136 may include an assistant xbot functionality as a front-end interface for interacting with the user of the client system 130, including receiving user inputs and presenting outputs. In particular embodiments, the assistant application 136 may comprise a stand-alone application. In particular embodiments, the assistant application 136 may be integrated into the social-networking application 134 or another suitable application (e.g., a messaging application). In particular embodiments, the assistant application 136 may be also integrated into the client system 130, an assistant hardware device, or any other suitable hardware devices. In particular embodiments, the assistant application 136 may be also part of the assistant system 140. In particular embodiments, the assistant application 136 may be accessed via the web browser 132. In particular embodiments, the user may interact with the assistant system 140 by providing user input to the assistant application 136 via various modalities (e.g., audio, voice, text, vision, image, video, gesture, motion, activity, location, orientation). The assistant application 136 may communicate the user input to the assistant system 140 (e.g., via the assistant xbot). Based on the user input, the assistant system 140 may generate responses. The assistant system 140 may send the generated responses to the assistant application 136. The assistant application 136 may then present the responses to the user at the client system 130 via various modalities (e.g., audio, text, image, and video). As an example and not by way of limitation, the user may interact with the assistant system 140 by providing a user input (e.g., a verbal request for information regarding a current status of nearby vehicle traffic) to the assistant xbot via a microphone of the client system 130. The assistant application 136 may then communicate the user input to the assistant system 140 over network 110. The assistant system 140 may accordingly analyze the user input, generate a response based on the analysis of the user input (e.g., vehicle traffic information obtained from a third-party source), and communicate the generated response back to the assistant application 136. The assistant application 136 may then present the generated response to the user in any suitable manner (e.g., displaying a text-based push notification and/or image(s) illustrating a local map of nearby vehicle traffic on a display of the client system 130).

In particular embodiments, a client system 130 may implement wake-word detection techniques to allow users to conveniently activate the assistant system 140 using one or more wake-words associated with assistant system 140. As an example and not by way of limitation, the system audio API on client system 130 may continuously monitor user input comprising audio data (e.g., frames of voice data) received at the client system 130. In this example, a wake-word associated with the assistant system 140 may be the voice phrase “hey assistant.” In this example, when the system audio API on client system 130 detects the voice phrase “hey assistant” in the monitored audio data, the assistant system 140 may be activated for subsequent interaction with the user. In alternative embodiments, similar detection techniques may be implemented to activate the assistant system 140 using particular non-audio user inputs associated with the assistant system 140. For example, the non-audio user inputs may be specific visual signals detected by a low-power sensor (e.g., camera) of client system 130. As an example and not by way of limitation, the visual signals may be a static image (e.g., barcode, QR code, universal product code (UPC)), a position of the user (e.g., the user's gaze towards client system 130), a user motion (e.g., the user pointing at an object), or any other suitable visual signal.

In particular embodiments, a client system 130 may include a rendering device 137 and, optionally, a companion device 138. The rendering device 137 may be configured to render outputs generated by the assistant system 140 to the user. The companion device 138 may be configured to perform computations associated with particular tasks (e.g., communications with the assistant system 140) locally (i.e., on-device) on the companion device 138 in particular circumstances (e.g., when the rendering device 137 is unable to perform said computations). In particular embodiments, the client system 130, the rendering device 137, and/or the companion device 138 may each be a suitable electronic device including hardware, software, or embedded logic components, or a combination of two or more such components, and may be capable of carrying out, individually or cooperatively, the functionalities implemented or supported by the client system 130 described herein. As an example and not by way of limitation, the client system 130, the rendering device 137, and/or the companion device 138 may each include a computer system such as a desktop computer, notebook or laptop computer, netbook, a tablet computer, e-book reader, GPS device, camera, personal digital assistant (PDA), handheld electronic device, cellular telephone, smartphone, smart speaker, virtual reality (VR) headset, augmented-reality (AR) smart glasses, other suitable electronic device, or any suitable combination thereof. In particular embodiments, one or more of the client system 130, the rendering device 137, and the companion device 138 may operate as a smart assistant device. As an example and not by way of limitation, the rendering device 137 may comprise smart glasses and the companion device 138 may comprise a smart phone. As another example and not by way of limitation, the rendering device 137 may comprise a smart watch and the companion device 138 may comprise a smart phone. As yet another example and not by way of limitation, the rendering device 137 may comprise smart glasses and the companion device 138 may comprise a smart remote for the smart glasses. As yet another example and not by way of limitation, the rendering device 137 may comprise a VR/AR headset and the companion device 138 may comprise a smart phone.

In particular embodiments, a user may interact with the assistant system 140 using the rendering device 137 or the companion device 138, individually or in combination. In particular embodiments, one or more of the client system 130, the rendering device 137, and the companion device 138 may implement a multi-stage wake-word detection model to enable users to conveniently activate the assistant system 140 by continuously monitoring for one or more wake-words associated with assistant system 140. At a first stage of the wake-word detection model, the rendering device 137 may receive audio user input (e.g., frames of voice data). If a wireless connection between the rendering device 137 and the companion device 138 is available, the application on the rendering device 137 may communicate the received audio user input to the companion application on the companion device 138 via the wireless connection. At a second stage of the wake-word detection model, the companion application on the companion device 138 may process the received audio user input to detect a wake-word associated with the assistant system 140. The companion application on the companion device 138 may then communicate the detected wake-word to a server associated with the assistant system 140 via wireless network 110. At a third stage of the wake-word detection model, the server associated with the assistant system 140 may perform a keyword verification on the detected wake-word to verify whether the user intended to activate and receive assistance from the assistant system 140. In alternative embodiments, any of the processing, detection, or keyword verification may be performed by the rendering device 137 and/or the companion device 138. In particular embodiments, when the assistant system 140 has been activated by the user, an application on the rendering device 137 may be configured to receive user input from the user, and a companion application on the companion device 138 may be configured to handle user inputs (e.g., user requests) received by the application on the rendering device 137. In particular embodiments, the rendering device 137 and the companion device 138 may be associated with each other (i.e., paired) via one or more wireless communication protocols (e.g., Bluetooth).

The following example workflow illustrates how a rendering device 137 and a companion device 138 may handle a user input provided by a user. In this example, an application on the rendering device 137 may receive a user input comprising a user request directed to the rendering device 137. The application on the rendering device 137 may then determine a status of a wireless connection (i.e., tethering status) between the rendering device 137 and the companion device 138. If a wireless connection between the rendering device 137 and the companion device 138 is not available, the application on the rendering device 137 may communicate the user request (optionally including additional data and/or contextual information available to the rendering device 137) to the assistant system 140 via the network 110. The assistant system 140 may then generate a response to the user request and communicate the generated response back to the rendering device 137. The rendering device 137 may then present the response to the user in any suitable manner. Alternatively, if a wireless connection between the rendering device 137 and the companion device 138 is available, the application on the rendering device 137 may communicate the user request (optionally including additional data and/or contextual information available to the rendering device 137) to the companion application on the companion device 138 via the wireless connection. The companion application on the companion device 138 may then communicate the user request (optionally including additional data and/or contextual information available to the companion device 138) to the assistant system 140 via the network 110. The assistant system 140 may then generate a response to the user request and communicate the generated response back to the companion device 138. The companion application on the companion device 138 may then communicate the generated response to the application on the rendering device 137. The rendering device 137 may then present the response to the user in any suitable manner. In the preceding example workflow, the rendering device 137 and the companion device 138 may each perform one or more computations and/or processes at each respective step of the workflow. In particular embodiments, performance of the computations and/or processes disclosed herein may be adaptively switched between the rendering device 137 and the companion device 138 based at least in part on a device state of the rendering device 137 and/or the companion device 138, a task associated with the user input, and/or one or more additional factors. As an example and not by way of limitation, one factor may be signal strength of the wireless connection between the rendering device 137 and the companion device 138. For example, if the signal strength of the wireless connection between the rendering device 137 and the companion device 138 is strong, the computations and processes may be adaptively switched to be substantially performed by the companion device 138 in order to, for example, benefit from the greater processing power of the CPU of the companion device 138. Alternatively, if the signal strength of the wireless connection between the rendering device 137 and the companion device 138 is weak, the computations and processes may be adaptively switched to be substantially performed by the rendering device 137 in a standalone manner. In particular embodiments, if the client system 130 does not comprise a companion device 138, the aforementioned computations and processes may be performed solely by the rendering device 137 in a standalone manner.

In particular embodiments, an assistant system 140 may assist users with various assistant-related tasks. The assistant system 140 may interact with the social-networking system 160 and/or the third-party system 170 when executing these assistant-related tasks.

In particular embodiments, the social-networking system 160 may be a network-addressable computing system that can host an online social network. The social-networking system 160 may generate, store, receive, and send social-networking data, such as, for example, user profile data, concept-profile data, social-graph information, or other suitable data related to the online social network. The social-networking system 160 may be accessed by the other components of network environment 100 either directly or via a network 110. As an example and not by way of limitation, a client system 130 may access the social-networking system 160 using a web browser 132 or a native application associated with the social-networking system 160 (e.g., a mobile social-networking application, a messaging application, another suitable application, or any combination thereof) either directly or via a network 110. In particular embodiments, the social-networking system 160 may include one or more servers 162. Each server 162 may be a unitary server or a distributed server spanning multiple computers or multiple datacenters. As an example and not by way of limitation, each server 162 may be a web server, a news server, a mail server, a message server, an advertising server, a file server, an application server, an exchange server, a database server, a proxy server, another server suitable for performing functions or processes described herein, or any combination thereof. In particular embodiments, each server 162 may include hardware, software, or embedded logic components or a combination of two or more such components for carrying out the appropriate functionalities implemented or supported by server 162. In particular embodiments, the social-networking system 160 may include one or more data stores 164. Data stores 164 may be used to store various types of information. In particular embodiments, the information stored in data stores 164 may be organized according to specific data structures. In particular embodiments, each data store 164 may be a relational, columnar, correlation, or other suitable database. Although this disclosure describes or illustrates particular types of databases, this disclosure contemplates any suitable types of databases. Particular embodiments may provide interfaces that enable a client system 130, a social-networking system 160, an assistant system 140, or a third-party system 170 to manage, retrieve, modify, add, or delete, the information stored in data store 164.

In particular embodiments, the social-networking system 160 may store one or more social graphs in one or more data stores 164. In particular embodiments, a social graph may include multiple nodes—which may include multiple user nodes (each corresponding to a particular user) or multiple concept nodes (each corresponding to a particular concept)—and multiple edges connecting the nodes. The social-networking system 160 may provide users of the online social network the ability to communicate and interact with other users. In particular embodiments, users may join the online social network via the social-networking system 160 and then add connections (e.g., relationships) to a number of other users of the social-networking system 160 whom they want to be connected to. Herein, the term “friend” may refer to any other user of the social-networking system 160 with whom a user has formed a connection, association, or relationship via the social-networking system 160.

In particular embodiments, the social-networking system 160 may provide users with the ability to take actions on various types of items or objects, supported by the social-networking system 160. As an example and not by way of limitation, the items and objects may include groups or social networks to which users of the social-networking system 160 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in the social-networking system 160 or by an external system of a third-party system 170, which is separate from the social-networking system 160 and coupled to the social-networking system 160 via a network 110.

In particular embodiments, the social-networking system 160 may be capable of linking a variety of entities. As an example and not by way of limitation, the social-networking system 160 may enable users to interact with each other as well as receive content from third-party systems 170 or other entities, or to allow users to interact with these entities through an application programming interfaces (API) or other communication channels.

In particular embodiments, a third-party system 170 may include one or more types of servers, one or more data stores, one or more interfaces, including but not limited to APIs, one or more web services, one or more content sources, one or more networks, or any other suitable components, e.g., that servers may communicate with. A third-party system 170 may be operated by a different entity from an entity operating the social-networking system 160. In particular embodiments, however, the social-networking system 160 and third-party systems 170 may operate in conjunction with each other to provide social-networking services to users of the social-networking system 160 or third-party systems 170. In this sense, the social-networking system 160 may provide a platform, or backbone, which other systems, such as third-party systems 170, may use to provide social-networking services and functionality to users across the Internet.

In particular embodiments, a third-party system 170 may include a third-party content object provider. A third-party content object provider may include one or more sources of content objects, which may be communicated to a client system 130. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects. In particular embodiments, a third-party content provider may use one or more third-party agents to provide content objects and/or services. A third-party agent may be an implementation that is hosted and executing on the third-party system 170.

In particular embodiments, the social-networking system 160 also includes user-generated content objects, which may enhance a user's interactions with the social-networking system 160. User-generated content may include anything a user can add, upload, send, or “post” to the social-networking system 160. As an example and not by way of limitation, a user communicates posts to the social-networking system 160 from a client system 130. Posts may include data such as status updates or other textual data, location information, photos, videos, links, music or other similar data or media. Content may also be added to the social-networking system 160 by a third-party through a “communication channel,” such as a newsfeed or stream.

In particular embodiments, the social-networking system 160 may include a variety of servers, sub-systems, programs, modules, logs, and data stores. In particular embodiments, the social-networking system 160 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. The social-networking system 160 may also include suitable components such as network interfaces, security mechanisms, load balancers, failover servers, management-and-network-operations consoles, other suitable components, or any suitable combination thereof. In particular embodiments, the social-networking system 160 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking the social-networking system 160 to one or more client systems 130 or one or more third-party systems 170 via a network 110. The web server may include a mail server or other messaging functionality for receiving and routing messages between the social-networking system 160 and one or more client systems 130. An API-request server may allow, for example, an assistant system 140 or a third-party system 170 to access information from the social-networking system 160 by calling one or more APIs. An action logger may be used to receive communications from a web server about a user's actions on or off the social-networking system 160. In conjunction with the action log, a third-party-content-object log may be maintained of user exposures to third-party-content objects. A notification controller may provide information regarding content objects to a client system 130. Information may be pushed to a client system 130 as notifications, or information may be pulled from a client system 130 responsive to a user input comprising a user request received from a client system 130. Authorization servers may be used to enforce one or more privacy settings of the users of the social-networking system 160. A privacy setting of a user may determine how particular information associated with a user can be shared. The authorization server may allow users to opt in to or opt out of having their actions logged by the social-networking system 160 or shared with other systems (e.g., a third-party system 170), such as, for example, by setting appropriate privacy settings. Third-party-content-object stores may be used to store content objects received from third parties, such as a third-party system 170. Location stores may be used for storing location information received from client systems 130 associated with users. Advertisement-pricing modules may combine social information, the current time, location information, or other suitable information to provide relevant advertisements, in the form of notifications, to a user.

### Assistant Systems

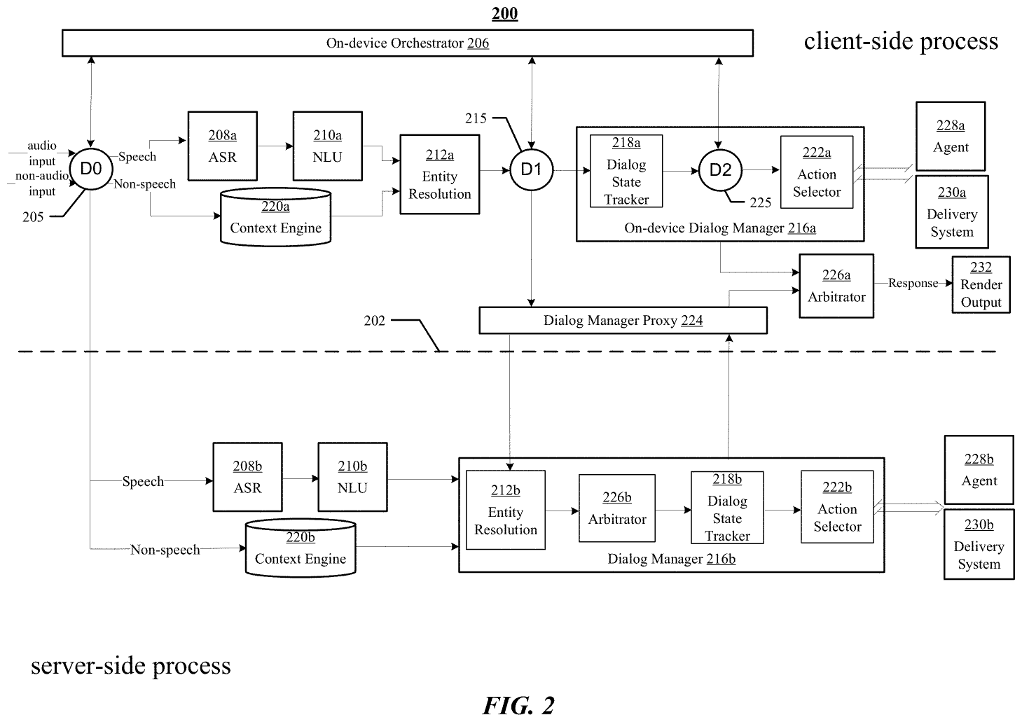

FIG. 2 illustrates an example architecture 200 of the assistant system 140. In particular embodiments, the assistant system 140 may assist a user to obtain information or services. The assistant system 140 may enable the user to interact with the assistant system 140 via user inputs of various modalities (e.g., audio, voice, text, vision, image, video, gesture, motion, activity, location, orientation) in stateful and multi-turn conversations to receive assistance from the assistant system 140. As an example and not by way of limitation, a user input may comprise an audio input based on the user's voice (e.g., a verbal command), which may be processed by a system audio API (application programming interface) on client system 130. The system audio API may perform techniques including echo cancellation, noise removal, beam forming, self-user voice activation, speaker identification, voice activity detection (VAD), and/or any other suitable acoustic technique in order to generate audio data that is readily processable by the assistant system 140. In particular embodiments, the assistant system 140 may support mono-modal inputs (e.g., only voice inputs), multi-modal inputs (e.g., voice inputs and text inputs), hybrid/multi-modal inputs, or any combination thereof. In particular embodiments, a user input may be a user-generated input that is sent to the assistant system 140 in a single turn. User inputs provided by a user may be associated with particular assistant-related tasks, and may include, for example, user requests (e.g., verbal requests for information or performance of an action), user interactions with the assistant application 136 associated with the assistant system 140 (e.g., selection of UI elements via touch or gesture), or any other type of suitable user input that may be detected and understood by the assistant system 140 (e.g., user movements detected by the client device 130 of the user).

In particular embodiments, the assistant system 140 may create and store a user profile comprising both personal and contextual information associated with the user. In particular embodiments, the assistant system 140 may analyze the user input using natural-language understanding (NLU) techniques. The analysis may be based at least in part on the user profile of the user for more personalized and context-aware understanding. The assistant system 140 may resolve entities associated with the user input based on the analysis. In particular embodiments, the assistant system 140 may interact with different agents to obtain information or services that are associated with the resolved entities. The assistant system 140 may generate a response for the user regarding the information or services by using natural-language generation (NLG). Through the interaction with the user, the assistant system 140 may use dialog management techniques to manage and forward the conversation flow with the user. In particular embodiments, the assistant system 140 may further assist the user to effectively and efficiently digest the obtained information by summarizing the information. The assistant system 140 may also assist the user to be more engaging with an online social network by providing tools that help the user interact with the online social network (e.g., creating posts, comments, messages). The assistant system 140 may additionally assist the user to manage different tasks such as keeping track of events. In particular embodiments, the assistant system 140 may proactively execute, without a user input, pre-authorized tasks that are relevant to user interests and preferences based on the user profile, at a time relevant for the user. In particular embodiments, the assistant system 140 may check privacy settings to ensure that accessing a user's profile or other user information and executing different tasks are permitted subject to the user's privacy settings. More information on assisting users subject to privacy settings may be found in U.S. patent application Ser. No. 16/182,542, filed 6 Nov. 2018, which is incorporated by reference.

In particular embodiments, the assistant system 140 may assist a user via an architecture built upon client-side processes and server-side processes which may operate in various operational modes. In FIG. 2, the client-side process is illustrated above the dashed line 202 whereas the server-side process is illustrated below the dashed line 202. A first operational mode (i.e., on-device mode) may be a workflow in which the assistant system 140 processes a user input and provides assistance to the user by primarily or exclusively performing client-side processes locally on the client system 130. For example, if the client system 130 is not connected to a network 110 (i.e., when client system 130 is offline), the assistant system 140 may handle a user input in the first operational mode utilizing only client-side processes. A second operational mode (i.e., cloud mode) may be a workflow in which the assistant system 140 processes a user input and provides assistance to the user by primarily or exclusively performing server-side processes on one or more remote servers (e.g., a server associated with assistant system 140). As illustrated in FIG. 2, a third operational mode (i.e., blended mode) may be a parallel workflow in which the assistant system 140 processes a user input and provides assistance to the user by performing client-side processes locally on the client system 130 in conjunction with server-side processes on one or more remote servers (e.g., a server associated with assistant system 140). For example, the client system 130 and the server associated with assistant system 140 may both perform automatic speech recognition (ASR) and natural-language understanding (NLU) processes, but the client system 130 may delegate dialog, agent, and natural-language generation (NLG) processes to be performed by the server associated with assistant system 140.

In particular embodiments, selection of an operational mode may be based at least in part on a device state, a task associated with a user input, and/or one or more additional factors. As an example and not by way of limitation, as described above, one factor may be a network connectivity status for client system 130. For example, if the client system 130 is not connected to a network 110 (i.e., when client system 130 is offline), the assistant system 140 may handle a user input in the first operational mode (i.e., on-device mode). As another example and not by way of limitation, another factor may be based on a measure of available battery power (i.e., battery status) for the client system 130. For example, if there is a need for client system 130 to conserve battery power (e.g., when client system 130 has minimal available battery power or the user has indicated a desire to conserve the battery power of the client system 130), the assistant system 140 may handle a user input in the second operational mode (i.e., cloud mode) or the third operational mode (i.e., blended mode) in order to perform fewer power-intensive operations on the client system 130. As yet another example and not by way of limitation, another factor may be one or more privacy constraints (e.g., specified privacy settings, applicable privacy policies). For example, if one or more privacy constraints limits or precludes particular data from being transmitted to a remote server (e.g., a server associated with the assistant system 140), the assistant system 140 may handle a user input in the first operational mode (i.e., on-device mode) in order to protect user privacy. As yet another example and not by way of limitation, another factor may be desynchronized context data between the client system 130 and a remote server (e.g., the server associated with assistant system 140). For example, the client system 130 and the server associated with assistant system 140 may be determined to have inconsistent, missing, and/or unreconciled context data, the assistant system 140 may handle a user input in the third operational mode (i.e., blended mode) to reduce the likelihood of an inadequate analysis associated with the user input. As yet another example and not by way of limitation, another factor may be a measure of latency for the connection between client system 130 and a remote server (e.g., the server associated with assistant system 140). For example, if a task associated with a user input may significantly benefit from and/or require prompt or immediate execution (e.g., photo capturing tasks), the assistant system 140 may handle the user input in the first operational mode (i.e., on-device mode) to ensure the task is performed in a timely manner. As yet another example and not by way of limitation, another factor may be, for a feature relevant to a task associated with a user input, whether the feature is only supported by a remote server (e.g., the server associated with assistant system 140). For example, if the relevant feature requires advanced technical functionality (e.g., high-powered processing capabilities, rapid update cycles) that is only supported by the server associated with assistant system 140 and is not supported by client system 130 at the time of the user input, the assistant system 140 may handle the user input in the second operational mode (i.e., cloud mode) or the third operational mode (i.e., blended mode) in order to benefit from the relevant feature.

In particular embodiments, an on-device orchestrator 206 on the client system 130 may coordinate receiving a user input and may determine, at one or more decision points in an example workflow, which of the operational modes described above should be used to process or continue processing the user input. As discussed above, selection of an operational mode may be based at least in part on a device state, a task associated with a user input, and/or one or more additional factors. As an example and not by way of limitation, with reference to the workflow architecture illustrated in FIG. 2, after a user input is received from a user, the on-device orchestrator 206 may determine, at decision point (DO) 205, whether to begin processing the user input in the first operational mode (i.e., on-device mode), the second operational mode (i.e., cloud mode), or the third operational mode (i.e., blended mode). For example, at decision point (DO) 205, the on-device orchestrator 206 may select the first operational mode (i.e., on-device mode) if the client system 130 is not connected to network 110 (i.e., when client system 130 is offline), if one or more privacy constraints expressly require on-device processing (e.g., adding or removing another person to a private call between users), or if the user input is associated with a task which does not require or benefit from server-side processing (e.g., setting an alarm or calling another user). As another example, at decision point (DO) 205, the on-device orchestrator 206 may select the second operational mode (i.e., cloud mode) or the third operational mode (i.e., blended mode) if the client system 130 has a need to conserve battery power (e.g., when client system 130 has minimal available battery power or the user has indicated a desire to conserve the battery power of the client system 130) or has a need to limit additional utilization of computing resources (e.g., when other processes operating on client device 130 require high CPU utilization (e.g., SMS messaging applications)).

In particular embodiments, if the on-device orchestrator 206 determines at decision point (DO) 205 that the user input should be processed using the first operational mode (i.e., on-device mode) or the third operational mode (i.e., blended mode), the client-side process may continue as illustrated in FIG. 2. As an example and not by way of limitation, if the user input comprises speech data, the speech data may be received at a local automatic speech recognition (ASR) module 208a on the client system 130. The ASR module 208a may allow a user to dictate and have speech transcribed as written text, have a document synthesized as an audio stream, or issue commands that are recognized as such by the system.

In particular embodiments, the output of the ASR module 208a may be sent to a local natural-language understanding (NLU) module 210a. The NLU module 210a may perform named entity resolution (NER), or named entity resolution may be performed by the entity resolution module 212a, as described below. In particular embodiments, one or more of an intent, a slot, or a domain may be an output of the NLU module 210a.

In particular embodiments, the user input may comprise non-speech data, which may be received at a local context engine 220a. As an example and not by way of limitation, the non-speech data may comprise locations, visuals, touch, gestures, world updates, social updates, contextual information, information related to people, activity data, and/or any other suitable type of non-speech data. The non-speech data may further comprise sensory data received by client system 130 sensors (e.g., microphone, camera), which may be accessed subject to privacy constraints and further analyzed by computer vision technologies. In particular embodiments, the computer vision technologies may comprise object detection, scene recognition, hand tracking, eye tracking, and/or any other suitable computer vision technologies. In particular embodiments, the non-speech data may be subject to geometric constructions, which may comprise constructing objects surrounding a user using any suitable type of data collected by a client system 130. As an example and not by way of limitation, a user may be wearing AR glasses, and geometric constructions may be utilized to determine spatial locations of surfaces and items (e.g., a floor, a wall, a user's hands). In particular embodiments, the non-speech data may be inertial data captured by AR glasses or a VR headset, and which may be data associated with linear and angular motions (e.g., measurements associated with a user's body movements). In particular embodiments, the context engine 220a may determine various types of events and context based on the non-speech data.

In particular embodiments, the outputs of the NLU module 210a and/or the context engine 220a may be sent to an entity resolution module 212a. The entity resolution module 212a may resolve entities associated with one or more slots output by NLU module 210a. In particular embodiments, each resolved entity may be associated with one or more entity identifiers. As an example and not by way of limitation, an identifier may comprise a unique user identifier (ID) corresponding to a particular user (e.g., a unique username or user ID number for the social-networking system 160). In particular embodiments, each resolved entity may also be associated with a confidence score. More information on resolving entities may be found in U.S. Pat. No. 10,803,050, filed 27 Jul. 2018, and U.S. patent application Ser. No. 16/048,072, filed 27 Jul. 2018, each of which is incorporated by reference.

In particular embodiments, at decision point (DO) 205, the on-device orchestrator 206 may determine that a user input should be handled in the second operational mode (i.e., cloud mode) or the third operational mode (i.e., blended mode). In these operational modes, the user input may be handled by certain server-side modules in a similar manner as the client-side process described above.

In particular embodiments, if the user input comprises speech data, the speech data of the user input may be received at a remote automatic speech recognition (ASR) module 208b on a remote server (e.g., the server associated with assistant system 140). The ASR module 208b may allow a user to dictate and have speech transcribed as written text, have a document synthesized as an audio stream, or issue commands that are recognized as such by the system.

In particular embodiments, the output of the ASR module 208b may be sent to a remote natural-language understanding (NLU) module 210b. In particular embodiments, the NLU module 210b may perform named entity resolution (NER) or named entity resolution may be performed by entity resolution module 212b of dialog manager module 216b as described below. In particular embodiments, one or more of an intent, a slot, or a domain may be an output of the NLU module 210b.

In particular embodiments, the user input may comprise non-speech data, which may be received at a remote context engine 220b. In particular embodiments, the remote context engine 220b may determine various types of events and context based on the non-speech data. In particular embodiments, the output of the NLU module 210b and/or the context engine 220b may be sent to a remote dialog manager 216b.

In particular embodiments, as discussed above, an on-device orchestrator 206 on the client system 130 may coordinate receiving a user input and may determine, at one or more decision points in an example workflow, which of the operational modes described above should be used to process or continue processing the user input. As further discussed above, selection of an operational mode may be based at least in part on a device state, a task associated with a user input, and/or one or more additional factors. As an example and not by way of limitation, with continued reference to the workflow architecture illustrated in FIG. 2, after the entity resolution module 212a generates an output or a null output, the on-device orchestrator 206 may determine, at decision point (D1) 215, whether to continue processing the user input in the first operational mode (i.e., on-device mode), the second operational mode (i.e., cloud mode), or the third operational mode (i.e., blended mode). For example, at decision point (D1) 215, the on-device orchestrator 206 may select the first operational mode (i.e., on-device mode) if an identified intent is associated with a latency sensitive processing task (e.g., taking a photo, pausing a stopwatch). As another example and not by way of limitation, if a messaging task is not supported by on-device processing on the client system 130, the on-device orchestrator 206 may select the third operational mode (i.e., blended mode) to process the user input associated with a messaging request. As yet another example, at decision point (D1) 215, the on-device orchestrator 206 may select the second operational mode (i.e., cloud mode) or the third operational mode (i.e., blended mode) if the task being processed requires access to a social graph, a knowledge graph, or a concept graph not stored on the client system 130. Alternatively, the on-device orchestrator 206 may instead select the first operational mode (i.e., on-device mode) if a sufficient version of an informational graph including requisite information for the task exists on the client system 130 (e.g., a smaller and/or bootstrapped version of a knowledge graph).

In particular embodiments, if the on-device orchestrator 206 determines at decision point (D1) 215 that processing should continue using the first operational mode (i.e., on-device mode) or the third operational mode (i.e., blended mode), the client-side process may continue as illustrated in FIG. 2. As an example and not by way of limitation, the output from the entity resolution module 212a may be sent to an on-device dialog manager 216a. In particular embodiments, the on-device dialog manager 216a may comprise a dialog state tracker 218a and an action selector 222a. The on-device dialog manager 216a may have complex dialog logic and product-related business logic to manage the dialog state and flow of the conversation between the user and the assistant system 140. The on-device dialog manager 216a may include full functionality for end-to-end integration and multi-turn support (e.g., confirmation, disambiguation). The on-device dialog manager 216a may also be lightweight with respect to computing limitations and resources including memory, computation (CPU), and binary size constraints. The on-device dialog manager 216a may also be scalable to improve developer experience. In particular embodiments, the on-device dialog manager 216a may benefit the assistant system 140, for example, by providing offline support to alleviate network connectivity issues (e.g., unstable or unavailable network connections), by using client-side processes to prevent privacy-sensitive information from being transmitted off of client system 130, and by providing a stable user experience in high-latency sensitive scenarios.

In particular embodiments, the on-device dialog manager 216a may further conduct false trigger mitigation. Implementation of false trigger mitigation may detect and prevent false triggers from user inputs which would otherwise invoke the assistant system 140 (e.g., an unintended wake-word) and may further prevent the assistant system 140 from generating data records based on the false trigger that may be inaccurate and/or subject to privacy constraints. As an example and not by way of limitation, if a user is in a voice call, the user's conversation during the voice call may be considered private, and the false trigger mitigation may limit detection of wake-words to audio user inputs received locally by the user's client system 130. In particular embodiments, the on-device dialog manager 216a may implement false trigger mitigation based on a nonsense detector. If the nonsense detector determines with a high confidence that a received wake-word is not logically and/or contextually sensible at the point in time at which it was received from the user, the on-device dialog manager 216a may determine that the user did not intend to invoke the assistant system 140.

In particular embodiments, due to a limited computing power of the client system 130, the on-device dialog manager 216a may conduct on-device learning based on learning algorithms particularly tailored for client system 130. As an example and not by way of limitation, federated learning techniques may be implemented by the on-device dialog manager 216a. Federated learning is a specific category of distributed machine learning techniques which may train machine-learning models using decentralized data stored on end devices (e.g., mobile phones). In particular embodiments, the on-device dialog manager 216a may use federated user representation learning model to extend existing neural-network personalization techniques to implementation of federated learning by the on-device dialog manager 216a. Federated user representation learning may personalize federated learning models by learning task-specific user representations (i.e., embeddings) and/or by personalizing model weights. Federated user representation learning is a simple, scalable, privacy-preserving, and resource-efficient. Federated user representation learning may divide model parameters into federated and private parameters. Private parameters, such as private user embeddings, may be trained locally on a client system 130 instead of being transferred to or averaged by a remote server (e.g., the server associated with assistant system 140). Federated parameters, by contrast, may be trained remotely on the server. In particular embodiments, the on-device dialog manager 216a may use an active federated learning model, which may transmit a global model trained on the remote server to client systems 130 and calculate gradients locally on the client systems 130. Active federated learning may enable the on-device dialog manager 216a to minimize the transmission costs associated with downloading models and uploading gradients. For active federated learning, in each round, client systems 130 may be selected in a semi-random manner based at least in part on a probability conditioned on the current model and the data on the client systems 130 in order to optimize efficiency for training the federated learning model.

In particular embodiments, the dialog state tracker 218a may track state changes over time as a user interacts with the world and the assistant system 140 interacts with the user. As an example and not by way of limitation, the dialog state tracker 218a may track, for example, what the user is talking about, whom the user is with, where the user is, what tasks are currently in progress, and where the user's gaze is at subject to applicable privacy policies.

In particular embodiments, at decision point (D1) 215, the on-device orchestrator 206 may determine to forward the user input to the server for either the second operational mode (i.e., cloud mode) or the third operational mode (i.e., blended mode). As an example and not by way of limitation, if particular functionalities or processes (e.g., messaging) are not supported by on the client system 130, the on-device orchestrator 206 may determine at decision point (D1) 215 to use the third operational mode (i.e., blended mode). In particular embodiments, the on-device orchestrator 206 may cause the outputs from the NLU module 210a, the context engine 220a, and the entity resolution module 212a, via a dialog manager proxy 224, to be forwarded to an entity resolution module 212b of the remote dialog manager 216b to continue the processing. The dialog manager proxy 224 may be a communication channel for information/events exchange between the client system 130 and the server. In particular embodiments, the dialog manager 216b may additionally comprise a remote arbitrator 226b, a remote dialog state tracker 218b, and a remote action selector 222b. In particular embodiments, the assistant system 140 may have started processing a user input with the second operational mode (i.e., cloud mode) at decision point (DO) 205 and the on-device orchestrator 206 may determine to continue processing the user input based on the second operational mode (i.e., cloud mode) at decision point (D1) 215. Accordingly, the output from the NLU module 210b and the context engine 220b may be received at the remote entity resolution module 212b. The remote entity resolution module 212b may have similar functionality as the local entity resolution module 212a, which may comprise resolving entities associated with the slots. In particular embodiments, the entity resolution module 212b may access one or more of the social graph, the knowledge graph, or the concept graph when resolving the entities. The output from the entity resolution module 212b may be received at the arbitrator 226b.

In particular embodiments, the remote arbitrator 226b may be responsible for choosing between client-side and server-side upstream results (e.g., results from the NLU module 210a/b, results from the entity resolution module 212a/b, and results from the context engine 220a/b). The arbitrator 226b may send the selected upstream results to the remote dialog state tracker 218b. In particular embodiments, similarly to the local dialog state tracker 218a, the remote dialog state tracker 218b may convert the upstream results into candidate tasks using task specifications and resolve arguments with entity resolution.

In particular embodiments, at decision point (D2) 225, the on-device orchestrator 206 may determine whether to continue processing the user input based on the first operational mode (i.e., on-device mode) or forward the user input to the server for the third operational mode (i.e., blended mode). The decision may depend on, for example, whether the client-side process is able to resolve the task and slots successfully, whether there is a valid task policy with a specific feature support, and/or the context differences between the client-side process and the server-side process. In particular embodiments, decisions made at decision point (D2) 225 may be for multi-turn scenarios. In particular embodiments, there may be at least two possible scenarios. In a first scenario, the assistant system 140 may have started processing a user input in the first operational mode (i.e., on-device mode) using client-side dialog state. If at some point the assistant system 140 decides to switch to having the remote server process the user input, the assistant system 140 may create a programmatic/predefined task with the current task state and forward it to the remote server. For subsequent turns, the assistant system 140 may continue processing in the third operational mode (i.e., blended mode) using the server-side dialog state. In another scenario, the assistant system 140 may have started processing the user input in either the second operational mode (i.e., cloud mode) or the third operational mode (i.e., blended mode) and may substantially rely on server-side dialog state for all subsequent turns. If the on-device orchestrator 206 determines to continue processing the user input based on the first operational mode (i.e., on-device mode), the output from the dialog state tracker 218a may be received at the action selector 222a.

In particular embodiments, at decision point (D2) 225, the on-device orchestrator 206 may determine to forward the user input to the remote server and continue processing the user input in either the second operational mode (i.e., cloud mode) or the third operational mode (i.e., blended mode). The assistant system 140 may create a programmatic/predefined task with the current task state and forward it to the server, which may be received at the action selector 222b. In particular embodiments, the assistant system 140 may have started processing the user input in the second operational mode (i.e., cloud mode), and the on-device orchestrator 206 may determine to continue processing the user input in the second operational mode (i.e., cloud mode) at decision point (D2) 225. Accordingly, the output from the dialog state tracker 218b may be received at the action selector 222b.

In particular embodiments, the action selector 222a/b may perform interaction management. The action selector 222a/b may determine and trigger a set of general executable actions. The actions may be executed either on the client system 130 or at the remote server. As an example and not by way of limitation, these actions may include providing information or suggestions to the user. In particular embodiments, the actions may interact with agents 228a/b, users, and/or the assistant system 140 itself. These actions may comprise actions including one or more of a slot request, a confirmation, a disambiguation, or an agent execution. The actions may be independent of the underlying implementation of the action selector 222a/b. For more complicated scenarios such as, for example, multi-turn tasks or tasks with complex business logic, the local action selector 222a may call one or more local agents 228a, and the remote action selector 222b may call one or more remote agents 228b to execute the actions. Agents 228a/b may be invoked via task ID, and any actions may be routed to the correct agent 228a/b using that task ID. In particular embodiments, an agent 228a/b may be configured to serve as a broker across a plurality of content providers for one domain. A content provider may be an entity responsible for carrying out an action associated with an intent or completing a task associated with the intent. In particular embodiments, agents 228a/b may provide several functionalities for the assistant system 140 including, for example, native template generation, task specific business logic, and querying external APIs. When executing actions for a task, agents 228a/b may use context from the dialog state tracker 218a/b, and may also update the dialog state tracker 218a/b. In particular embodiments, agents 228a/b may also generate partial payloads from a dialog act.

In particular embodiments, the local agents 228a may have different implementations to be compiled/registered for different platforms (e.g., smart glasses versus a VR headset). In particular embodiments, multiple device-specific implementations (e.g., real-time calls for a client system 130 or a messaging application on the client system 130) may be handled internally by a single agent 228a. Alternatively, device-specific implementations may be handled by multiple agents 228a associated with multiple domains. As an example and not by way of limitation, calling an agent 228a on smart glasses may be implemented in a different manner than calling an agent 228a on a smart phone. Different platforms may also utilize varying numbers of agents 228a. The agents 228a may also be cross-platform (i.e., different operating systems on the client system 130). In addition, the agents 228a may have minimized startup time or binary size impact. Local agents 228a may be suitable for particular use cases. As an example and not by way of limitation, one use case may be emergency calling on the client system 130. As another example and not by way of limitation, another use case may be responding to a user input without network connectivity. As yet another example and not by way of limitation, another use case may be that particular domains/tasks may be privacy sensitive and may prohibit user inputs being sent to the remote server.

In particular embodiments, the local action selector 222a may call a local delivery system 230a for executing the actions, and the remote action selector 222b may call a remote delivery system 230b for executing the actions. The delivery system 230a/b may deliver a predefined event upon receiving triggering signals from the dialog state tracker 218a/b by executing corresponding actions. The delivery system 230a/b may ensure that events get delivered to a host with a living connection. As an example and not by way of limitation, the delivery system 230a/b may broadcast to all online devices that belong to one user. As another example and not by way of limitation, the delivery system 230a/b may deliver events to target-specific devices. The delivery system 230a/b may further render a payload using up-to-date device context.

In particular embodiments, the on-device dialog manager 216a may additionally comprise a separate local action execution module, and the remote dialog manager 216b may additionally comprise a separate remote action execution module. The local execution module and the remote action execution module may have similar functionality. In particular embodiments, the action execution module may call the agents 228a/b to execute tasks. The action execution module may additionally perform a set of general executable actions determined by the action selector 222a/b. The set of executable actions may interact with agents 228a/b, users, and the assistant system 140 itself via the delivery system 230a/b.

In particular embodiments, if the user input is handled using the first operational mode (i.e., on-device mode), results from the agents 228a and/or the delivery system 230a may be returned to the on-device dialog manager 216a. The on-device dialog manager 216a may then instruct a local arbitrator 226a to generate a final response based on these results. The arbitrator 226a may aggregate the results and evaluate them. As an example and not by way of limitation, the arbitrator 226a may rank and select a best result for responding to the user input. If the user request is handled in the second operational mode (i.e., cloud mode), the results from the agents 228b and/or the delivery system 230b may be returned to the remote dialog manager 216b. The remote dialog manager 216b may instruct, via the dialog manager proxy 224, the arbitrator 226a to generate the final response based on these results. Similarly, the arbitrator 226a may analyze the results and select the best result to provide to the user. If the user input is handled based on the third operational mode (i.e., blended mode), the client-side results and server-side results (e.g., from agents 228a/b and/or delivery system 230a/b) may both be provided to the arbitrator 226a by the on-device dialog manager 216a and remote dialog manager 216b, respectively. The arbitrator 226 may then choose between the client-side and server-side side results to determine the final result to be presented to the user. In particular embodiments, the logic to decide between these results may depend on the specific use-case.

In particular embodiments, the local arbitrator 226a may generate a response based on the final result and send it to a render output module 232. The render output module 232 may determine how to render the output in a way that is suitable for the client system 130. As an example and not by way of limitation, for a VR headset or AR smart glasses, the render output module 232 may determine to render the output using a visual-based modality (e.g., an image or a video clip) that may be displayed via the VR headset or AR smart glasses. As another example, the response may be rendered as audio signals that may be played by the user via a VR headset or AR smart glasses. As yet another example, the response may be rendered as augmented-reality data for enhancing user experience.

In particular embodiments, in addition to determining an operational mode to process the user input, the on-device orchestrator 206 may also determine whether to process the user input on the rendering device 137, process the user input on the companion device 138, or process the user request on the remote server. The rendering device 137 and/or the companion device 138 may each use the assistant stack in a similar manner as disclosed above to process the user input. As an example and not by, the on-device orchestrator 206 may determine that part of the processing should be done on the rendering device 137, part of the processing should be done on the companion device 138, and the remaining processing should be done on the remote server.

In particular embodiments, the assistant system 140 may have a variety of capabilities including audio cognition, visual cognition, signals intelligence, reasoning, and memories. In particular embodiments, the capability of audio cognition may enable the assistant system 140 to, for example, understand a user's input associated with various domains in different languages, understand and summarize a conversation, perform on-device audio cognition for complex commands, identify a user by voice, extract topics from a conversation and auto-tag sections of the conversation, enable audio interaction without a wake-word, filter and amplify user voice from ambient noise and conversations, and/or understand which client system 130 a user is talking to if multiple client systems 130 are in vicinity.

In particular embodiments, the capability of visual cognition may enable the assistant system 140 to, for example, recognize interesting objects in the world through a combination of existing machine-learning models and one-shot learning, recognize an interesting moment and auto-capture it, achieve semantic understanding over multiple visual frames across different episodes of time, provide platform support for additional capabilities in places or objects recognition, recognize a full set of settings and micro-locations including personalized locations, recognize complex activities, recognize complex gestures to control a client system 130, handle images/videos from egocentric cameras (e.g., with motion, capture angles, resolution), accomplish similar levels of accuracy and speed regarding images with lower resolution, conduct one-shot registration and recognition of places and objects, and/or perform visual recognition on a client system 130.

In particular embodiments, the assistant system 140 may leverage computer vision techniques to achieve visual cognition. Besides computer vision techniques, the assistant system 140 may explore options that may supplement these techniques to scale up the recognition of objects. In particular embodiments, the assistant system 140 may use supplemental signals such as, for example, optical character recognition (OCR) of an object's labels, GPS signals for places recognition, and/or signals from a user's client system 130 to identify the user. In particular embodiments, the assistant system 140 may perform general scene recognition (e.g., home, work, public spaces) to set a context for the user and reduce the computer-vision search space to identify likely objects or people. In particular embodiments, the assistant system 140 may guide users to train the assistant system 140. For example, crowdsourcing may be used to get users to tag objects and help the assistant system 140 recognize more objects over time. As another example, users may register their personal objects as part of an initial setup when using the assistant system 140. The assistant system 140 may further allow users to provide positive/negative signals for objects they interact with to train and improve personalized models for them.

In particular embodiments, the capability of signals intelligence may enable the assistant system 140 to, for example, determine user location, understand date/time, determine family locations, understand users' calendars and future desired locations, integrate richer sound understanding to identify setting/context through sound alone, and/or build signals intelligence models at runtime which may be personalized to a user's individual routines.

In particular embodiments, the capability of reasoning may enable the assistant system 140 to, for example, pick up previous conversation threads at any point in the future, synthesize all signals to understand micro and personalized context, learn interaction patterns and preferences from users' historical behavior and accurately suggest interactions that they may value, generate highly predictive proactive suggestions based on micro-context understanding, understand what content a user may want to see at what time of a day, and/or understand the changes in a scene and how that may impact the user's desired content.

In particular embodiments, the capabilities of memories may enable the assistant system 140 to, for example, remember which social connections a user previously called or interacted with, write into memory and query memory at will (i.e., open dictation and auto tags), extract richer preferences based on prior interactions and long-term learning, remember a user's life history, extract rich information from egocentric streams of data and auto catalog, and/or write to memory in structured form to form rich short, episodic and long-term memories.

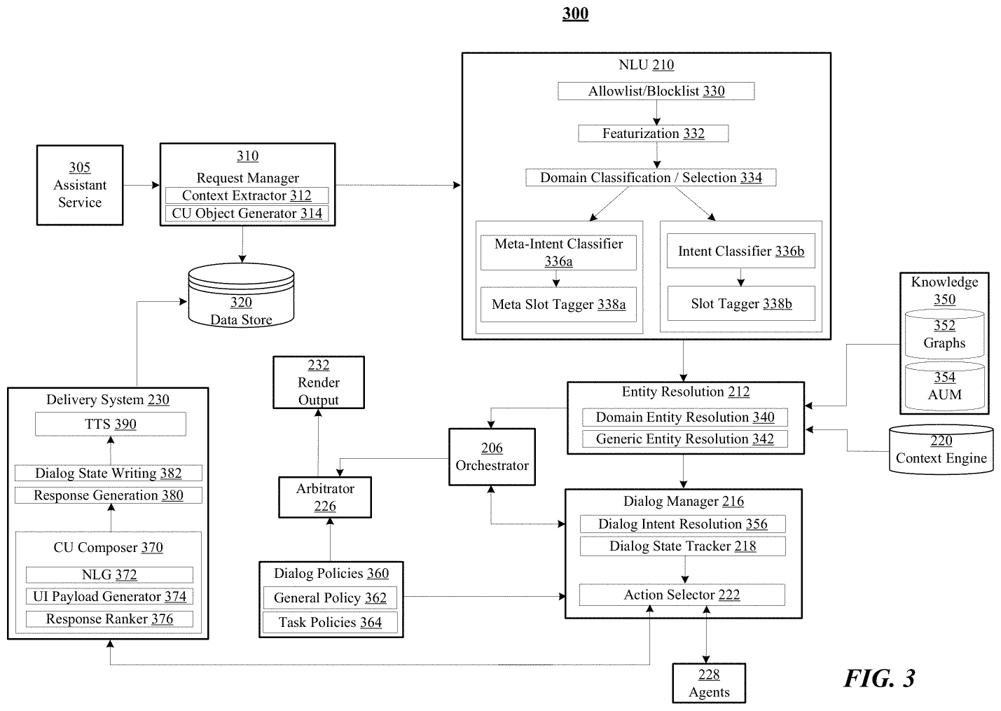

FIG. 3 illustrates an example flow diagram 300 of the assistant system 140. In particular embodiments, an assistant service module 305 may access a request manager 310 upon receiving a user input. In particular embodiments, the request manager 310 may comprise a context extractor 312 and a conversational understanding object generator (CU object generator) 314. The context extractor 312 may extract contextual information associated with the user input. The context extractor 312 may also update contextual information based on the assistant application 136 executing on the client system 130. As an example and not by way of limitation, the update of contextual information may comprise content items are displayed on the client system 130. As another example and not by way of limitation, the update of contextual information may comprise whether an alarm is set on the client system 130. As another example and not by way of limitation, the update of contextual information may comprise whether a song is playing on the client system 130. The CU object generator 314 may generate particular CU objects relevant to the user input. The CU objects may comprise dialog-session data and features associated with the user input, which may be shared with all the modules of the assistant system 140. In particular embodiments, the request manager 310 may store the contextual information and the generated CU objects in a data store 320 which is a particular data store implemented in the assistant system 140.

In particular embodiments, the request manger 310 may send the generated CU objects to the NLU module 210. The NLU module 210 may perform a plurality of steps to process the CU objects. The NLU module 210 may first run the CU objects through an allowlist/blocklist 330. In particular embodiments, the allowlist/blocklist 330 may comprise interpretation data matching the user input. The NLU module 210 may then perform a featurization 332 of the CU objects. The NLU module 210 may then perform domain classification/selection 334 on user input based on the features resulted from the featurization 332 to classify the user input into predefined domains. In particular embodiments, a domain may denote a social context of interaction (e.g., education), or a namespace for a set of intents (e.g., music). The domain classification/selection results may be further processed based on two related procedures. In one procedure, the NLU module 210 may process the domain classification/selection results using a meta-intent classifier 336a. The meta-intent classifier 336a may determine categories that describe the user's intent. An intent may be an element in a pre-defined taxonomy of semantic intentions, which may indicate a purpose of a user interaction with the assistant system 140. The NLU module 210a may classify a user input into a member of the pre-defined taxonomy. For example, the user input may be “Play Beethoven's 5th,” and the NLU module 210a may classify the input as having the intent [IN:play_music]. In particular embodiments, intents that are common to multiple domains may be processed by the meta-intent classifier 336a. As an example and not by way of limitation, the meta-intent classifier 336a may be based on a machine-learning model that may take the domain classification/selection results as input and calculate a probability of the input being associated with a particular predefined meta-intent. The NLU module 210 may then use a meta slot tagger 338a to annotate one or more meta slots for the classification result from the meta-intent classifier 336a. A slot may be a named sub-string corresponding to a character string within the user input representing a basic semantic entity. For example, a slot for “pizza” may be [SL:dish]. In particular embodiments, a set of valid or expected named slots may be conditioned on the classified intent. As an example and not by way of limitation, for the intent [IN:play_music], a valid slot may be [SL:song_name]. In particular embodiments, the meta slot tagger 338a may tag generic slots such as references to items (e.g., the first), the type of slot, the value of the slot, etc. In particular embodiments, the NLU module 210 may process the domain classification/selection results using an intent classifier 336b. The intent classifier 336b may determine the user's intent associated with the user input. In particular embodiments, there may be one intent classifier 336b for each domain to determine the most possible intents in a given domain. As an example and not by way of limitation, the intent classifier 336b may be based on a machine-learning model that may take the domain classification/selection results as input and calculate a probability of the input being associated with a particular predefined intent. The NLU module 210 may then use a slot tagger 338b to annotate one or more slots associated with the user input. In particular embodiments, the slot tagger 338b may annotate the one or more slots for the n-grams of the user input. As an example and not by way of limitation, a user input may comprise “change 500 dollars in my account to Japanese yen.” The intent classifier 336b may take the user input as input and formulate it into a vector. The intent classifier 336b may then calculate probabilities of the user input being associated with different predefined intents based on a vector comparison between the vector representing the user input and the vectors representing different predefined intents. In a similar manner, the slot tagger 338b may take the user input as input and formulate each word into a vector. The slot tagger 338b may then calculate probabilities of each word being associated with different predefined slots based on a vector comparison between the vector representing the word and the vectors representing different predefined slots. The intent of the user may be classified as “changing money”. The slots of the user input may comprise “500”, “dollars”, “account”, and “Japanese yen”. The meta-intent of the user may be classified as “financial service”. The meta slot may comprise “finance”.

In particular embodiments, the natural-language understanding (NLU) module 210 may additionally extract information from one or more of a social graph, a knowledge graph, or a concept graph, and may retrieve a user's profile stored locally on the client system 130. The NLU module 210 may additionally consider contextual information when analyzing the user input. The NLU module 210 may further process information from these different sources by identifying and aggregating information, annotating n-grams of the user input, ranking the n-grams with confidence scores based on the aggregated information, and formulating the ranked n-grams into features that may be used by the NLU module 210 for understanding the user input. In particular embodiments, the NLU module 210 may identify one or more of a domain, an intent, or a slot from the user input in a personalized and context-aware manner. As an example and not by way of limitation, a user input may comprise “show me how to get to the coffee shop.” The NLU module 210 may identify a particular coffee shop that the user wants to go to based on the user's personal information and the associated contextual information. In particular embodiments, the NLU module 210 may comprise a lexicon of a particular language, a parser, and grammar rules to partition sentences into an internal representation. The NLU module 210 may also comprise one or more programs that perform naive semantics or stochastic semantic analysis, and may further use pragmatics to understand a user input. In particular embodiments, the parser may be based on a deep learning architecture comprising multiple long-short term memory (LSTM) networks. As an example and not by way of limitation, the parser may be based on a recurrent neural network grammar (RNNG) model, which is a type of recurrent and recursive LSTM algorithm. More information on natural-language understanding (NLU) may be found in U.S. patent application Ser. No. 16/011,062, filed 18 Jun. 2018, U.S. patent application Ser. No. 16/025,317, filed 2 Jul. 2018, and U.S. patent application Ser. No. 16/038,120, filed 17 Jul. 2018, each of which is incorporated by reference.

In particular embodiments, the output of the NLU module 210 may be sent to the entity resolution module 212 to resolve relevant entities. Entities may include, for example, unique users or concepts, each of which may have a unique identifier (ID). The entities may include one or more of a real-world entity (from general knowledge base), a user entity (from user memory), a contextual entity (device context/dialog context), or a value resolution (numbers, datetime, etc.). In particular embodiments, the entity resolution module 212 may comprise domain entity resolution 340 and generic entity resolution 342. The entity resolution module 212 may execute generic and domain-specific entity resolution. The generic entity resolution 342 may resolve the entities by categorizing the slots and meta slots into different generic topics. The domain entity resolution 340 may resolve the entities by categorizing the slots and meta slots into different domains. As an example and not by way of limitation, in response to the input of an inquiry of the advantages of a particular brand of electric car, the generic entity resolution 342 may resolve the referenced brand of electric car as vehicle and the domain entity resolution 340 may resolve the referenced brand of electric car as electric car.

In particular embodiments, entities may be resolved based on knowledge 350 about the world and the user. The assistant system 140 may extract ontology data from the graphs 352. As an example and not by way of limitation, the graphs 352 may comprise one or more of a knowledge graph, a social graph, or a concept graph. The ontology data may comprise the structural relationship between different slots/meta-slots and domains. The ontology data may also comprise information of how the slots/meta-slots may be grouped, related within a hierarchy where the higher level comprises the domain, and subdivided according to similarities and differences. For example, the knowledge graph may comprise a plurality of entities. Each entity may comprise a single record associated with one or more attribute values. The particular record may be associated with a unique entity identifier. Each record may have diverse values for an attribute of the entity. Each attribute value may be associated with a confidence probability and/or a semantic weight. A confidence probability for an attribute value represents a probability that the value is accurate for the given attribute. A semantic weight for an attribute value may represent how the value semantically appropriate for the given attribute considering all the available information. For example, the knowledge graph may comprise an entity of a book titled “BookName”, which may include information extracted from multiple content sources (e.g., an online social network, online encyclopedias, book review sources, media databases, and entertainment content sources), which may be deduped, resolved, and fused to generate the single unique record for the knowledge graph. In this example, the entity titled “BookName” may be associated with a “fantasy” attribute value for a “genre” entity attribute. More information on the knowledge graph may be found in U.S. patent application Ser. No. 16/048,049, filed 27 Jul. 2018, and U.S. patent application Ser. No. 16/048,101, filed 27 Jul. 2018, each of which is incorporated by reference.

In particular embodiments, the assistant user memory (AUM) 354 may comprise user episodic memories which help determine how to assist a user more effectively. The AUM 354 may be the central place for storing, retrieving, indexing, and searching over user data. As an example and not by way of limitation, the AUM 354 may store information such as contacts, photos, reminders, etc. Additionally, the AUM 354 may automatically synchronize data to the server and other devices (only for non-sensitive data). As an example and not by way of limitation, if the user sets a nickname for a contact on one device, all devices may synchronize and get that nickname based on the AUM 354. In particular embodiments, the AUM 354 may first prepare events, user sate, reminder, and trigger state for storing in a data store. Memory node identifiers (ID) may be created to store entry objects in the AUM 354, where an entry may be some piece of information about the user (e.g., photo, reminder, etc.) As an example and not by way of limitation, the first few bits of the memory node ID may indicate that this is a memory node ID type, the next bits may be the user ID, and the next bits may be the time of creation. The AUM 354 may then index these data for retrieval as needed. Index ID may be created for such purpose. In particular embodiments, given an “index key” (e.g., PHOTO_LOCATION) and “index value” (e.g., “San Francisco”), the AUM 354 may get a list of memory IDs that have that attribute (e.g., photos in San Francisco). As an example and not by way of limitation, the first few bits may indicate this is an index ID type, the next bits may be the user ID, and the next bits may encode an “index key” and “index value”. The AUM 354 may further conduct information retrieval with a flexible query language. Relation index ID may be created for such purpose. In particular embodiments, given a source memory node and an edge type, the AUM 354 may get memory IDs of all target nodes with that type of outgoing edge from the source. As an example and not by way of limitation, the first few bits may indicate this is a relation index ID type, the next bits may be the user ID, and the next bits may be a source node ID and edge type. In particular embodiments, the AUM 354 may help detect concurrent updates of different events. More information on episodic memories may be found in U.S. patent application Ser. No. 16/552,559, filed 27 Aug. 2019, which is incorporated by reference.

In particular embodiments, the entity resolution module 212 may use different techniques to resolve different types of entities. For real-world entities, the entity resolution module 212 may use a knowledge graph to resolve the span to the entities, such as “music track”, “movie”, etc. For user entities, the entity resolution module 212 may use user memory or some agents to resolve the span to user-specific entities, such as “contact”, “reminders”, or “relationship”. For contextual entities, the entity resolution module 212 may perform coreference based on information from the context engine 220 to resolve the references to entities in the context, such as “him”, “her”, “the first one”, or “the last one”. In particular embodiments, for coreference, the entity resolution module 212 may create references for entities determined by the NLU module 210. The entity resolution module 212 may then resolve these references accurately. As an example and not by way of limitation, a user input may comprise “find me the nearest grocery store and direct me there”. Based on coreference, the entity resolution module 212 may interpret “there” as “the nearest grocery store”. In particular embodiments, coreference may depend on the information from the context engine 220 and the dialog manager 216 so as to interpret references with improved accuracy. In particular embodiments, the entity resolution module 212 may additionally resolve an entity under the context (device context or dialog context), such as, for example, the entity shown on the screen or an entity from the last conversation history. For value resolutions, the entity resolution module 212 may resolve the mention to exact value in standardized form, such as numerical value, date time, address, etc.

In particular embodiments, the entity resolution module 212 may first perform a check on applicable privacy constraints in order to guarantee that performing entity resolution does not violate any applicable privacy policies. As an example and not by way of limitation, an entity to be resolved may be another user who specifies in their privacy settings that their identity should not be searchable on the online social network. In this case, the entity resolution module 212 may refrain from returning that user's entity identifier in response to a user input. By utilizing the described information obtained from the social graph, the knowledge graph, the concept graph, and the user profile, and by complying with any applicable privacy policies, the entity resolution module 212 may resolve entities associated with a user input in a personalized, context-aware, and privacy-protected manner.

In particular embodiments, the entity resolution module 212 may work with the ASR module 208 to perform entity resolution. The following example illustrates how the entity resolution module 212 may resolve an entity name. The entity resolution module 212 may first expand names associated with a user into their respective normalized text forms as phonetic consonant representations which may be phonetically transcribed using a double metaphone algorithm. The entity resolution module 212 may then determine an n-best set of candidate transcriptions and perform a parallel comprehension process on all of the phonetic transcriptions in the n-best set of candidate transcriptions. In particular embodiments, each transcription that resolves to the same intent may then be collapsed into a single intent. Each intent may then be assigned a score corresponding to the highest scoring candidate transcription for that intent. During the collapse, the entity resolution module 212 may identify various possible text transcriptions associated with each slot, correlated by boundary timing offsets associated with the slot's transcription. The entity resolution module 212 may then extract a subset of possible candidate transcriptions for each slot from a plurality (e.g., 1000) of candidate transcriptions, regardless of whether they are classified to the same intent. In this manner, the slots and intents may be scored lists of phrases. In particular embodiments, a new or running task capable of handling the intent may be identified and provided with the intent (e.g., a message composition task for an intent to send a message to another user). The identified task may then trigger the entity resolution module 212 by providing it with the scored lists of phrases associated with one of its slots and the categories against which it should be resolved. As an example and not by way of limitation, if an entity attribute is specified as “friend,” the entity resolution module 212 may run every candidate list of terms through the same expansion that may be run at matcher compilation time. Each candidate expansion of the terms may be matched in the precompiled trie matching structure. Matches may be scored using a function based at least in part on the transcribed input, matched form, and friend name. As another example and not by way of limitation, if an entity attribute is specified as “celebrity/notable person,” the entity resolution module 212 may perform parallel searches against the knowledge graph for each candidate set of terms for the slot output from the ASR module 208. The entity resolution module 212 may score matches based on matched person popularity and ASR-provided score signal. In particular embodiments, when the memory category is specified, the entity resolution module 212 may perform the same search against user memory. The entity resolution module 212 may crawl backward through user memory and attempt to match each memory (e.g., person recently mentioned in conversation, or seen and recognized via visual signals, etc.). For each entity, the entity resolution module 212 may employ matching similarly to how friends are matched (i.e., phonetic). In particular embodiments, scoring may comprise a temporal decay factor associated with a recency with which the name was previously mentioned. The entity resolution module 212 may further combine, sort, and dedupe all matches. In particular embodiments, the task may receive the set of candidates. When multiple high scoring candidates are present, the entity resolution module 212 may perform user-facilitated disambiguation (e.g., getting real-time user feedback from users on these candidates).

In particular embodiments, the context engine 220 may help the entity resolution module 212 improve entity resolution. The context engine 220 may comprise offline aggregators and an online inference service. The offline aggregators may process a plurality of data associated with the user that are collected from a prior time window. As an example and not by way of limitation, the data may include news feed posts/comments, interactions with news feed posts/comments, search history, etc., that are collected during a predetermined timeframe (e.g., from a prior 90-day window). The processing result may be stored in the context engine 220 as part of the user profile. The user profile of the user may comprise user profile data including demographic information, social information, and contextual information associated with the user. The user profile data may also include user interests and preferences on a plurality of topics, aggregated through conversations on news feed, search logs, messaging platforms, etc. The usage of a user profile may be subject to privacy constraints to ensure that a user's information can be used only for his/her benefit, and not shared with anyone else. More information on user profiles may be found in U.S. patent application Ser. No. 15/967,239, filed 30 Apr. 2018, which is incorporated by reference. In particular embodiments, the online inference service may analyze the conversational data associated with the user that are received by the assistant system 140 at a current time. The analysis result may be stored in the context engine 220 also as part of the user profile. In particular embodiments, both the offline aggregators and online inference service may extract personalization features from the plurality of data. The extracted personalization features may be used by other modules of the assistant system 140 to better understand user input. In particular embodiments, the entity resolution module 212 may process the information from the context engine 220 (e.g., a user profile) in the following steps based on natural-language processing (NLP). In particular embodiments, the entity resolution module 212 may tokenize text by text normalization, extract syntax features from text, and extract semantic features from text based on NLP. The entity resolution module 212 may additionally extract features from contextual information, which is accessed from dialog history between a user and the assistant system 140. The entity resolution module 212 may further conduct global word embedding, domain-specific embedding, and/or dynamic embedding based on the contextual information. The processing result may be annotated with entities by an entity tagger. Based on the annotations, the entity resolution module 212 may generate dictionaries. In particular embodiments, the dictionaries may comprise global dictionary features which can be updated dynamically offline. The entity resolution module 212 may rank the entities tagged by the entity tagger. In particular embodiments, the entity resolution module 212 may communicate with different graphs 352 including one or more of the social graph, the knowledge graph, or the concept graph to extract ontology data that is relevant to the retrieved information from the context engine 220. In particular embodiments, the entity resolution module 212 may further resolve entities based on the user profile, the ranked entities, and the information from the graphs 352.

In particular embodiments, the entity resolution module 212 may be driven by the task (corresponding to an agent 228). This inversion of processing order may make it possible for domain knowledge present in a task to be applied to pre-filter or bias the set of resolution targets when it is obvious and appropriate to do so. As an example and not by way of limitation, for the utterance “who is John?” no clear category is implied in the utterance. Therefore, the entity resolution module 212 may resolve “John” against everything. As another example and not by way of limitation, for the utterance “send a message to John”, the entity resolution module 212 may easily determine “John” refers to a person that one can message. As a result, the entity resolution module 212 may bias the resolution to a friend. As another example and not by way of limitation, for the utterance “what is John's most famous album?” To resolve “John”, the entity resolution module 212 may first determine the task corresponding to the utterance, which is finding a music album. The entity resolution module 212 may determine that entities related to music albums include singers, producers, and recording studios. Therefore, the entity resolution module 212 may search among these types of entities in a music domain to resolve “John.”

In particular embodiments, the output of the entity resolution module 212 may be sent to the dialog manager 216 to advance the flow of the conversation with the user. The dialog manager 216 may be an asynchronous state machine that repeatedly updates the state and selects actions based on the new state. The dialog manager 216 may additionally store previous conversations between the user and the assistant system 140. In particular embodiments, the dialog manager 216 may conduct dialog optimization. Dialog optimization relates to the challenge of understanding and identifying the most likely branching options in a dialog with a user. As an example and not by way of limitation, the assistant system 140 may implement dialog optimization techniques to obviate the need to confirm who a user wants to call because the assistant system 140 may determine a high confidence that a person inferred based on context and available data is the intended recipient. In particular embodiments, the dialog manager 216 may implement reinforcement learning frameworks to improve the dialog optimization. The dialog manager 216 may comprise dialog intent resolution 356, the dialog state tracker 218, and the action selector 222. In particular embodiments, the dialog manager 216 may execute the selected actions and then call the dialog state tracker 218 again until the action selected requires a user response, or there are no more actions to execute. Each action selected may depend on the execution result from previous actions. In particular embodiments, the dialog intent resolution 356 may resolve the user intent associated with the current dialog session based on dialog history between the user and the assistant system 140. The dialog intent resolution 356 may map intents determined by the NLU module 210 to different dialog intents. The dialog intent resolution 356 may further rank dialog intents based on signals from the NLU module 210, the entity resolution module 212, and dialog history between the user and the assistant system 140.

In particular embodiments, the dialog state tracker 218 may use a set of operators to track the dialog state. The operators may comprise necessary data and logic to update the dialog state. Each operator may act as delta of the dialog state after processing an incoming user input. In particular embodiments, the dialog state tracker 218 may a comprise a task tracker, which may be based on task specifications and different rules. The dialog state tracker 218 may also comprise a slot tracker and coreference component, which may be rule based and/or recency based. The coreference component may help the entity resolution module 212 to resolve entities. In alternative embodiments, with the coreference component, the dialog state tracker 218 may replace the entity resolution module 212 and may resolve any references/mentions and keep track of the state. In particular embodiments, the dialog state tracker 218 may convert the upstream results into candidate tasks using task specifications and resolve arguments with entity resolution. Both user state (e.g., user's current activity) and task state (e.g., triggering conditions) may be tracked. Given the current state, the dialog state tracker 218 may generate candidate tasks the assistant system 140 may process and perform for the user. As an example and not by way of limitation, candidate tasks may include “show suggestion,” “get weather information,” or “take photo.” In particular embodiments, the dialog state tracker 218 may generate candidate tasks based on available data from, for example, a knowledge graph, a user memory, and a user task history. In particular embodiments, the dialog state tracker 218 may then resolve the triggers object using the resolved arguments. As an example and not by way of limitation, a user input “remind me to call mom when she's online and I'm home tonight” may perform the conversion from the NLU output to the triggers representation by the dialog state tracker 218 as illustrated in Table 1 below:

TABLE 1
Example Conversion from NLU Output to Triggers Representation

| NLU Ontology Representation: | | Triggers Representation: |
|---|---|---|
| [IN:CREATE_SMART_REMINDER | [symbol] | Triggers: { |
| Remind me to | | andTriggers: [ |
| [SL:TODO call mom] when | | condition: {ContextualEvent(mom is |
| [SL:TRIGGER_CONJUNCTION | | online)}, |
| [IN:GET_TRIGGER | | condition: {ContextualEvent(location is |
| [SL:TRIGGER_SOCIAL_UPDATE | | home)}, |
| she's online] and I'm | | condition: {ContextualEvent(time is |
| [SL:TRIGGER_LOCATION home] | | tonight)}]))]} |
| [SL:DATE_TIME tonight] | | |
| ] | | |
| ] | | |
| ] | | |

In the above example, “mom,” “home,” and “tonight” are represented by their respective entities: personEntity, locationEntity, datetimeEntity.

In particular embodiments, the dialog manager 216 may map events determined by the context engine 220 to actions. As an example and not by way of limitation, an action may be a natural-language generation (NLG) action, a display or overlay, a device action, or a retrieval action. The dialog manager 216 may also perform context tracking and interaction management. Context tracking may comprise aggregating real-time stream of events into a unified user state. Interaction management may comprise selecting optimal action in each state. In particular embodiments, the dialog state tracker 218 may perform context tracking (i.e., tracking events related to the user). To support processing of event streams, the dialog state tracker 218a may use an event handler (e.g., for disambiguation, confirmation, request) that may consume various types of events and update an internal assistant state. Each event type may have one or more handlers. Each event handler may be modifying a certain slice of the assistant state. In particular embodiments, the event handlers may be operating on disjoint subsets of the state (i.e., only one handler may have write-access to a particular field in the state). In particular embodiments, all event handlers may have an opportunity to process a given event. As an example and not by way of limitation, the dialog state tracker 218 may run all event handlers in parallel on every event, and then may merge the state updates proposed by each event handler (e.g., for each event, most handlers may return a NULL update).

In particular embodiments, the dialog state tracker 218 may work as any programmatic handler (logic) that requires versioning. In particular embodiments, instead of directly altering the dialog state, the dialog state tracker 218 may be a side-effect free component and generate n-best candidates of dialog state update operators that propose updates to the dialog state. The dialog state tracker 218 may comprise intent resolvers containing logic to handle different types of NLU intent based on the dialog state and generate the operators. In particular embodiments, the logic may be organized by intent handler, such as a disambiguation intent handler to handle the intents when the assistant system 140 asks for disambiguation, a confirmation intent handler that comprises the logic to handle confirmations, etc. Intent resolvers may combine the turn intent together with the dialog state to generate the contextual updates for a conversation with the user. A slot resolution component may then recursively resolve the slots in the update operators with resolution providers including the knowledge graph and domain agents. In particular embodiments, the dialog state tracker 218 may update/rank the dialog state of the current dialog session. As an example and not by way of limitation, the dialog state tracker 218 may update the dialog state as “completed” if the dialog session is over. As another example and not by way of limitation, the dialog state tracker 218 may rank the dialog state based on a priority associated with it.

In particular embodiments, the dialog state tracker 218 may communicate with the action selector 222 about the dialog intents and associated content objects. In particular embodiments, the action selector 222 may rank different dialog hypotheses for different dialog intents. The action selector 222 may take candidate operators of dialog state and consult the dialog policies 360 to decide what actions should be executed. In particular embodiments, a dialog policy 360 may a tree-based policy, which is a pre-constructed dialog plan. Based on the current dialog state, a dialog policy 360 may choose a node to execute and generate the corresponding actions. As an example and not by way of limitation, the tree-based policy may comprise topic grouping nodes and dialog action (leaf) nodes. In particular embodiments, a dialog policy 360 may also comprise a data structure that describes an execution plan of an action by an agent 228. A dialog policy 360 may further comprise multiple goals related to each other through logical operators. In particular embodiments, a goal may be an outcome of a portion of the dialog policy and it may be constructed by the dialog manager 216. A goal may be represented by an identifier (e.g., string) with one or more named arguments, which parameterize the goal. As an example and not by way of limitation, a goal with its associated goal argument may be represented as {confirm_artist, args:{artist: “Madonna” }}. In particular embodiments, goals may be mapped to leaves of the tree of the tree-structured representation of the dialog policy 360.

In particular embodiments, the assistant system 140 may use hierarchical dialog policies 360 with general policy 362 handling the cross-domain business logic and task policies 364 handling the task/domain specific logic. The general policy 362 may be used for actions that are not specific to individual tasks. The general policy 362 may be used to determine task stacking and switching, proactive tasks, notifications, etc. The general policy 362 may comprise handling low-confidence intents, internal errors, unacceptable user response with retries, and/or skipping or inserting confirmation based on ASR or NLU confidence scores. The general policy 362 may also comprise the logic of ranking dialog state update candidates from the dialog state tracker 218 output and pick the one to update (such as picking the top ranked task intent). In particular embodiments, the assistant system 140 may have a particular interface for the general policy 362, which allows for consolidating scattered cross-domain policy/business-rules, especial those found in the dialog state tracker 218, into a function of the action selector 222. The interface for the general policy 362 may also allow for authoring of self-contained sub-policy units that may be tied to specific situations or clients (e.g., policy functions that may be easily switched on or off based on clients, situation). The interface for the general policy 362 may also allow for providing a layering of policies with back-off, i.e., multiple policy units, with highly specialized policy units that deal with specific situations being backed up by more general policies 362 that apply in wider circumstances. In this context the general policy 362 may alternatively comprise intent or task specific policy.

In particular embodiments, a task policy 364 may comprise the logic for action selector 222 based on the task and current state. The task policy 364 may be dynamic and ad-hoc. In particular embodiments, the types of task policies 364 may include one or more of the following types: (1) manually crafted tree-based dialog plans; (2) coded policy that directly implements the interface for generating actions; (3) configurator-specified slot-filling tasks; or (4) machine-learning model based policy learned from data. In particular embodiments, the assistant system 140 may bootstrap new domains with rule-based logic and later refine the task policies 364 with machine-learning models. In particular embodiments, the general policy 362 may pick one operator from the candidate operators to update the dialog state, followed by the selection of a user facing action by a task policy 364. Once a task is active in the dialog state, the corresponding task policy 364 may be consulted to select right actions.

In particular embodiments, the action selector 222 may select an action based on one or more of the event determined by the context engine 220, the dialog intent and state, the associated content objects, and the guidance from dialog policies 360. Each dialog policy 360 may be subscribed to specific conditions over the fields of the state. After an event is processed and the state is updated, the action selector 222 may run a fast search algorithm (e.g., similarly to the Boolean satisfiability) to identify which policies should be triggered based on the current state. In particular embodiments, if multiple policies are triggered, the action selector 222 may use a tie-breaking mechanism to pick a particular policy. Alternatively, the action selector 222 may use a more sophisticated approach which may dry-run each policy and then pick a particular policy which may be determined to have a high likelihood of success. In particular embodiments, mapping events to actions may result in several technical advantages for the assistant system 140. One technical advantage may include that each event may be a state update from the user or the user's physical/digital environment, which may or may not trigger an action from assistant system 140. Another technical advantage may include possibilities to handle rapid bursts of events (e.g., user enters a new building and sees many people) by first consuming all events to update state, and then triggering action(s) from the final state. Another technical advantage may include consuming all events into a single global assistant state.

In particular embodiments, the action selector 222 may take the dialog state update operators as part of the input to select the dialog action. The execution of the dialog action may generate a set of expectations to instruct the dialog state tracker 218 to handle future turns. In particular embodiments, an expectation may be used to provide context to the dialog state tracker 218 when handling the user input from next turn. As an example and not by way of limitation, slot request dialog action may have the expectation of proving a value for the requested slot. In particular embodiments, both the dialog state tracker 218 and the action selector 222 may not change the dialog state until the selected action is executed. This may allow the assistant system 140 to execute the dialog state tracker 218 and the action selector 222 for processing speculative ASR results and to do n-best ranking with dry runs.

In particular embodiments, the action selector 222 may call different agents 228 for task execution. Meanwhile, the dialog manager 216 may receive an instruction to update the dialog state. As an example and not by way of limitation, the update may comprise awaiting agents' 228 response. An agent 228 may select among registered content providers to complete the action. The data structure may be constructed by the dialog manager 216 based on an intent and one or more slots associated with the intent. In particular embodiments, the agents 228 may comprise first-party agents and third-party agents. In particular embodiments, first-party agents may comprise internal agents that are accessible and controllable by the assistant system 140 (e.g. agents associated with services provided by the online social network, such as messaging services or photo-share services). In particular embodiments, third-party agents may comprise external agents that the assistant system 140 has no control over (e.g., third-party online music application agents, ticket sales agents). The first-party agents may be associated with first-party providers that provide content objects and/or services hosted by the social-networking system 160. The third-party agents may be associated with third-party providers that provide content objects and/or services hosted by the third-party system 170. In particular embodiments, each of the first-party agents or third-party agents may be designated for a particular domain. As an example and not by way of limitation, the domain may comprise weather, transportation, music, shopping, social, videos, photos, events, locations, and/or work. In particular embodiments, the assistant system 140 may use a plurality of agents 228 collaboratively to respond to a user input. As an example and not by way of limitation, the user input may comprise “direct me to my next meeting.” The assistant system 140 may use a calendar agent to retrieve the location of the next meeting. The assistant system 140 may then use a navigation agent to direct the user to the next meeting.

In particular embodiments, the dialog manager 216 may support multi-turn compositional resolution of slot mentions. For a compositional parse from the NLU module 210, the resolver may recursively resolve the nested slots. The dialog manager 216 may additionally support disambiguation for the nested slots. As an example and not by way of limitation, the user input may be “remind me to call Alex”. The resolver may need to know which Alex to call before creating an actionable reminder to-do entity. The resolver may halt the resolution and set the resolution state when further user clarification is necessary for a particular slot. The general policy 362 may examine the resolution state and create corresponding dialog action for user clarification. In dialog state tracker 218, based on the user input and the last dialog action, the dialog manager 216 may update the nested slot. This capability may allow the assistant system 140 to interact with the user not only to collect missing slot values but also to reduce ambiguity of more complex/ambiguous utterances to complete the task. In particular embodiments, the dialog manager 216 may further support requesting missing slots in a nested intent and multi-intent user inputs (e.g., “take this photo and send it to Dad”). In particular embodiments, the dialog manager 216 may support machine-learning models for more robust dialog experience. As an example and not by way of limitation, the dialog state tracker 218 may use neural network based models (or any other suitable machine-learning models) to model belief over task hypotheses. As another example and not by way of limitation, for action selector 222, highest priority policy units may comprise white-list/black-list overrides, which may have to occur by design; middle priority units may comprise machine-learning models designed for action selection; and lower priority units may comprise rule-based fallbacks when the machine-learning models elect not to handle a situation. In particular embodiments, machine-learning model based general policy unit may help the assistant system 140 reduce redundant disambiguation or confirmation steps, thereby reducing the number of turns to execute the user input.

In particular embodiments, the determined actions by the action selector 222 may be sent to the delivery system 230. The delivery system 230 may comprise a CU composer 370, a response generation component 380, a dialog state writing component 382, and a text-to-speech (TTS) component 390. Specifically, the output of the action selector 222 may be received at the CU composer 370. In particular embodiments, the output from the action selector 222 may be formulated as a <k,c,u,d> tuple, in which k indicates a knowledge source, c indicates a communicative goal, u indicates a user model, and d indicates a discourse model.

In particular embodiments, the CU composer 370 may generate a communication content for the user using a natural-language generation (NLG) component 372. In particular embodiments, the NLG component 372 may use different language models and/or language templates to generate natural-language outputs. The generation of natural-language outputs may be application specific. The generation of natural-language outputs may be also personalized for each user. In particular embodiments, the NLG component 372 may comprise a content determination component, a sentence planner, and a surface realization component. The content determination component may determine the communication content based on the knowledge source, communicative goal, and the user's expectations. As an example and not by way of limitation, the determining may be based on a description logic. The description logic may comprise, for example, three fundamental notions which are individuals (representing objects in the domain), concepts (describing sets of individuals), and roles (representing binary relations between individuals or concepts). The description logic may be characterized by a set of constructors that allow the natural-language generator to build complex concepts/roles from atomic ones. In particular embodiments, the content determination component may perform the following tasks to determine the communication content. The first task may comprise a translation task, in which the input to the NLG component 372 may be translated to concepts. The second task may comprise a selection task, in which relevant concepts may be selected among those resulted from the translation task based on the user model. The third task may comprise a verification task, in which the coherence of the selected concepts may be verified. The fourth task may comprise an instantiation task, in which the verified concepts may be instantiated as an executable file that can be processed by the NLG component 372. The sentence planner may determine the organization of the communication content to make it human understandable. The surface realization component may determine specific words to use, the sequence of the sentences, and the style of the communication content.

In particular embodiments, the CU composer 370 may also determine a modality of the generated communication content using the UI payload generator 374. Since the generated communication content may be considered as a response to the user input, the CU composer 370 may additionally rank the generated communication content using a response ranker 376. As an example and not by way of limitation, the ranking may indicate the priority of the response. In particular embodiments, the CU composer 370 may comprise a natural-language synthesis (NLS) component that may be separate from the NLG component 372. The NLS component may specify attributes of the synthesized speech generated by the CU composer 370, including gender, volume, pace, style, or register, in order to customize the response for a particular user, task, or agent. The NLS component may tune language synthesis without engaging the implementation of associated tasks. In particular embodiments, the CU composer 370 may check privacy constraints associated with the user to make sure the generation of the communication content follows the privacy policies. More information on customizing natural-language generation (NLG) may be found in U.S. patent application Ser. No. 15/967,279, filed 30 Apr. 2018, and U.S. patent application Ser. No. 15/966,455, filed 30 Apr. 2018, which is incorporated by reference.

In particular embodiments, the delivery system 230 may perform different tasks based on the output of the CU composer 370. These tasks may include writing (i.e., storing/updating) the dialog state into the data store 330 using the dialog state writing component 382 and generating responses using the response generation component 380. In particular embodiments, the output of the CU composer 370 may be additionally sent to the TTS component 390 if the determined modality of the communication content is audio. In particular embodiments, the output from the delivery system 230 comprising one or more of the generated responses, the communication content, or the speech generated by the TTS component 390 may be then sent back to the dialog manager 216.

In particular embodiments, the orchestrator 206 may determine, based on the output of the entity resolution module 212, whether to processing a user input on the client system 130 or on the server, or in the third operational mode (i.e., blended mode) using both. Besides determining how to process the user input, the orchestrator 206 may receive the results from the agents 228 and/or the results from the delivery system 230 provided by the dialog manager 216. The orchestrator 206 may then forward these results to the arbitrator 226. The arbitrator 226 may aggregate these results, analyze them, select the best result, and provide the selected result to the render output module 232. In particular embodiments, the arbitrator 226 may consult with dialog policies 360 to obtain the guidance when analyzing these results. In particular embodiments, the render output module 232 may generate a response that is suitable for the client system 130.

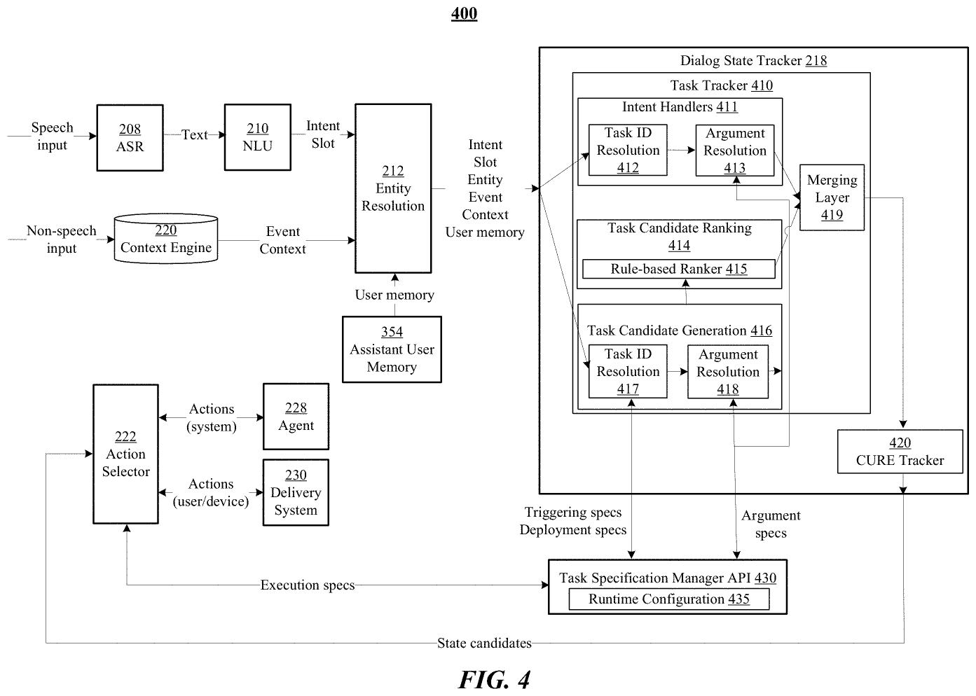

FIG. 4 illustrates an example task-centric flow diagram 400 of processing a user input. In particular embodiments, the assistant system 140 may assist users not only with voice-initiated experiences but also more proactive, multi-modal experiences that are initiated on understanding user context. In particular embodiments, the assistant system 140 may rely on assistant tasks for such purpose. An assistant task may be a central concept that is shared across the whole assistant stack to understand user intention, interact with the user and the world to complete the right task for the user. In particular embodiments, an assistant task may be the primitive unit of assistant capability. It may comprise data fetching, updating some state, executing some command, or complex tasks composed of a smaller set of tasks. Completing a task correctly and successfully to deliver the value to the user may be the goal that the assistant system 140 is optimized for. In particular embodiments, an assistant task may be defined as a capability or a feature. The assistant task may be shared across multiple product surfaces if they have exactly the same requirements so it may be easily tracked. It may also be passed from device to device, and easily picked up mid-task by another device since the primitive unit is consistent. In addition, the consistent format of the assistant task may allow developers working on different modules in the assistant stack to more easily design around it. Furthermore, it may allow for task sharing. As an example and not by way of limitation, if a user is listening to music on smart glasses, the user may say “play this music on my phone.” In the event that the phone hasn't been woken or has a task to execute, the smart glasses may formulate a task that is provided to the phone, which may then be executed by the phone to start playing music. In particular embodiments, the assistant task may be retained by each surface separately if they have different expected behaviors. In particular embodiments, the assistant system 140 may identify the right task based on user inputs in different modality or other signals, conduct conversation to collect all necessary information, and complete that task with action selector 222 implemented internally or externally, on server or locally product surfaces. In particular embodiments, the assistant stack may comprise a set of processing components from wake-up, recognizing user inputs, understanding user intention, reasoning about the tasks, fulfilling a task to generate natural-language response with voices.

In particular embodiments, the user input may comprise speech input. The speech input may be received at the ASR module 208 for extracting the text transcription from the speech input. The ASR module 208 may use statistical models to determine the most likely sequences of words that correspond to a given portion of speech received by the assistant system 140 as audio input. The models may include one or more of hidden Markov models, neural networks, deep learning models, or any combination thereof. The received audio input may be encoded into digital data at a particular sampling rate (e.g., 16, 44.1, or 96 kHz) and with a particular number of bits representing each sample (e.g., 8, 16, of 24 bits).

In particular embodiments, the ASR module 208 may comprise one or more of a grapheme-to-phoneme (G2P) model, a pronunciation learning model, a personalized acoustic model, a personalized language model (PLM), or an end-pointing model. In particular embodiments, the grapheme-to-phoneme (G2P) model may be used to determine a user's grapheme-to-phoneme style (i.e., what it may sound like when a particular user speaks a particular word). In particular embodiments, the personalized acoustic model may be a model of the relationship between audio signals and the sounds of phonetic units in the language. Therefore, such personalized acoustic model may identify how a user's voice sounds. The personalized acoustical model may be generated using training data such as training speech received as audio input and the corresponding phonetic units that correspond to the speech. The personalized acoustical model may be trained or refined using the voice of a particular user to recognize that user's speech. In particular embodiments, the personalized language model may then determine the most likely phrase that corresponds to the identified phonetic units for a particular audio input. The personalized language model may be a model of the probabilities that various word sequences may occur in the language. The sounds of the phonetic units in the audio input may be matched with word sequences using the personalized language model, and greater weights may be assigned to the word sequences that are more likely to be phrases in the language. The word sequence having the highest weight may be then selected as the text that corresponds to the audio input. In particular embodiments, the personalized language model may also be used to predict what words a user is most likely to say given a context. In particular embodiments, the end-pointing model may detect when the end of an utterance is reached. In particular embodiments, based at least in part on a limited computing power of the client system 130, the assistant system 140 may optimize the personalized language model at runtime during the client-side process. As an example and not by way of limitation, the assistant system 140 may pre-compute a plurality of personalized language models for a plurality of possible subjects a user may talk about. When a user input is associated with a request for assistance, the assistant system 140 may promptly switch between and locally optimize the pre-computed language models at runtime based on user activities. As a result, the assistant system 140 may preserve computational resources while efficiently identifying a subject matter associated with the user input. In particular embodiments, the assistant system 140 may also dynamically re-learn user pronunciations at runtime.

In particular embodiments, the user input may comprise non-speech input. The non-speech input may be received at the context engine 220 for determining events and context from the non-speech input. The context engine 220 may determine multi-modal events comprising voice/text intents, location updates, visual events, touch, gaze, gestures, activities, device/application events, and/or any other suitable type of events. The voice/text intents may depend on the ASR module 208 and the NLU module 210. The location updates may be consumed by the dialog manager 216 to support various proactive/reactive scenarios. The visual events may be based on person or object appearing in the user's field of view. These events may be consumed by the dialog manager 216 and recorded in transient user state to support visual co-reference (e.g., resolving “that” in “how much is that shirt?” and resolving “him” in “send him my contact”). The gaze, gesture, and activity may result in flags being set in the transient user state (e.g., user is running) which may condition the action selector 222. For the device/application events, if an application makes an update to the device state, this may be published to the assistant system 140 so that the dialog manager 216 may use this context (what is currently displayed to the user) to handle reactive and proactive scenarios. As an example and not by way of limitation, the context engine 220 may cause a push notification message to be displayed on a display screen of the user's client system 130. The user may interact with the push notification message, which may initiate a multi-modal event (e.g., an event workflow for replying to a message received from another user). Other example multi-modal events may include seeing a friend, seeing a landmark, being at home, running, starting a call with touch, taking a photo with touch, opening an application, etc. In particular embodiments, the context engine 220 may also determine world/social events based on world/social updates (e.g., weather changes, a friend getting online). The social updates may comprise events that a user is subscribed to, (e.g., friend's birthday, posts, comments, other notifications). These updates may be consumed by the dialog manager 216 to trigger proactive actions based on context (e.g., suggesting a user call a friend on their birthday, but only if the user is not focused on something else). As an example and not by way of limitation, receiving a message may be a social event, which may trigger the task of reading the message to the user.

In particular embodiments, the text transcription from the ASR module 208 may be sent to the NLU module 210. The NLU module 210 may process the text transcription and extract the user intention (i.e., intents) and parse the slots or parsing result based on the linguistic ontology. In particular embodiments, the intents and slots from the NLU module 210 and/or the events and contexts from the context engine 220 may be sent to the entity resolution module 212. In particular embodiments, the entity resolution module 212 may resolve entities associated with the user input based on the output from the NLU module 210 and/or the context engine 220. The entity resolution module 212 may use different techniques to resolve the entities, including accessing user memory from the assistant user memory (AUM) 354. In particular embodiments, the AUM 354 may comprise user episodic memories helpful for resolving the entities by the entity resolution module 212. The AUM 354 may be the central place for storing, retrieving, indexing, and searching over user data.

In particular embodiments, the entity resolution module 212 may provide one or more of the intents, slots, entities, events, context, or user memory to the dialog state tracker 218. The dialog state tracker 218 may identify a set of state candidates for a task accordingly, conduct interaction with the user to collect necessary information to fill the state, and call the action selector 222 to fulfill the task. In particular embodiments, the dialog state tracker 218 may comprise a task tracker 410. The task tracker 410 may track the task state associated with an assistant task. In particular embodiments, a task state may be a data structure persistent cross interaction turns and updates in real time to capture the state of the task during the whole interaction. The task state may comprise all the current information about a task execution status, such as arguments, confirmation status, confidence score, etc. Any incorrect or outdated information in the task state may lead to failure or incorrect task execution. The task state may also serve as a set of contextual information for many other components such as the ASR module 208, the NLU module 210, etc.

In particular embodiments, the task tracker 410 may comprise intent handlers 411, task candidate ranking module 414, task candidate generation module 416, and merging layer 419. In particular embodiments, a task may be identified by its ID name. The task ID may be used to associate corresponding component assets if it is not explicitly set in the task specification, such as dialog policy 360, agent execution, NLG dialog act, etc. Therefore, the output from the entity resolution module 212 may be received by a task ID resolution component 417 of the task candidate generation module 416 to resolve the task ID of the corresponding task. In particular embodiments, the task ID resolution component 417 may call a task specification manager API 430 to access the triggering specifications and deployment specifications for resolving the task ID. Given these specifications, the task ID resolution component 417 may resolve the task ID using intents, slots, dialog state, context, and user memory.

In particular embodiments, the technical specification of a task may be defined by a task specification. The task specification may be used by the assistant system 140 to trigger a task, conduct dialog conversation, and find a right execution module (e.g., agents 228) to execute the task. The task specification may be an implementation of the product requirement document. It may serve as the general contract and requirements that all the components agreed on. It may be considered as an assembly specification for a product, while all development partners deliver the modules based on the specification. In particular embodiments, an assistant task may be defined in the implementation by a specification. As an example and not by way of limitation, the task specification may be defined as the following categories. One category may be a basic task schema which comprises the basic identification information such as ID, name, and the schema of the input arguments. Another category may be a triggering specification, which is about how a task can be triggered, such as intents, event message ID, etc. Another category may be a conversational specification, which is for dialog manager 216 to conduct the conversation with users and systems. Another category may be an execution specification, which is about how the task will be executed and fulfilled. Another category may be a deployment specification, which is about how a feature will be deployed to certain surfaces, local, and group of users.

In particular embodiments, the task specification manager API 430 may be an API for accessing a task specification manager. The task specification manager may be a module in the runtime stack for loading the specifications from all the tasks and providing interfaces to access all the tasks specifications for detailed information or generating task candidates. In particular embodiments, the task specification manager may be accessible for all components in the runtime stack via the task specification manager API 430. The task specification manager may comprise a set of static utility functions to manage tasks with the task specification manager, such as filtering task candidates by platform. Before landing the task specification, the assistant system 140 may also dynamically load the task specifications to support end-to-end development on the development stage.

In particular embodiments, the task specifications may be grouped by domains and stored in runtime configurations 435. The runtime stack may load all the task specifications from the runtime configurations 435 during the building time. In particular embodiments, in the runtime configurations 435, for a domain, there may be a cconffile and a cinc file (e.g., sidechef_task.cconf and sidechef_task.inc). As an example and not by way of limitation, <domain>_tasks.cconf may comprise all the details of the task specifications. As another example and not by way of limitation, <domain>_tasks.cinc may provide a way to override the generated specification if there is no support for that feature yet.

In particular embodiments, a task execution may require a set of arguments to execute. Therefore, an argument resolution component 418 may resolve the argument names using the argument specifications for the resolved task ID. These arguments may be resolved based on NLU outputs (e.g., slot [SL:contact]), dialog state (e.g., short-term calling history), user memory (such as user preferences, location, long-term calling history, etc.), or device context (such as timer states, screen content, etc.). In particular embodiments, the argument modality may be text, audio, images or other structured data. The slot to argument mapping may be defined by a filling strategy and/or language ontology. In particular embodiments, given the task triggering specifications, the task candidate generation module 416 may look for the list of tasks to be triggered as task candidates based on the resolved task ID and arguments.

In particular embodiments, the generated task candidates may be sent to the task candidate ranking module 414 to be further ranked. The task candidate ranking module 414 may use a rule-based ranker 415 to rank them. In particular embodiments, the rule-based ranker 415 may comprise a set of heuristics to bias certain domain tasks. The ranking logic may be described as below with principles of context priority. In particular embodiments, the priority of a user specified task may be higher than an on-foreground task. The priority of the on-foreground task may be higher than a device-domain task when the intent is a meta intent. The priority of the device-domain task may be higher than a task of a triggering intent domain. As an example and not by way of limitation, the ranking may pick the task if the task domain is mentioned or specified in the utterance, such as “create a timer in TIMER app”. As another example and not by way of imitation, the ranking may pick the task if the task domain is on foreground or active state, such as “stop the timer” to stop the timer while the TIMER app is on foreground and there is an active timer. As yet another example and not by way of imitation, the ranking may pick the task if the intent is general meta intent, and the task is device control while there is no other active application or active state. As yet another example and not by way of imitation, the ranking may pick the task if the task is the same as the intent domain. In particular embodiments, the task candidate ranking module 414 may customize some more logic to check the match of intent/slot/entity types. The ranked task candidates may be sent to the merging layer 419.

In particular embodiments, the output from the entity resolution module 212 may also sent to a task ID resolution component 412 of the intent handlers 411. The task ID resolution component 412 may resolve the task ID of the corresponding task similarly to the task ID resolution component 417. In particular embodiments, the intent handlers 411 may additionally comprise an argument resolution component 413. The argument resolution component 413 may resolve the argument names using the argument specifications for the resolved task ID similarly to the argument resolution component 418. In particular embodiments, intent handlers 411 may deal with task agnostic features and may not be expressed within the task specifications which are task specific. Intent handlers 411 may output state candidates other than task candidates such as argument update, confirmation update, disambiguation update, etc. In particular embodiments, some tasks may require very complex triggering conditions or very complex argument filling logic that may not be reusable by other tasks even if they were supported in the task specifications (e.g., in-call voice commands, media tasks via [IN:PLAY_MEDIA], etc.). Intent handlers 411 may be also suitable for such type of tasks. In particular embodiments, the results from the intent handlers 411 may take precedence over the results from the task candidate ranking module 414. The results from the intent handlers 411 may be also sent to the merging layer 419.

In particular embodiments, the merging layer 419 may combine the results from the intent handlers 411 and the results from the task candidate ranking module 414. The dialog state tracker 218 may suggest each task as a new state for the dialog policies 360 to select from, thereby generating a list of state candidates. The merged results may be further sent to a conversational understanding reinforcement engine (CURE) tracker 420. In particular embodiments, the CURE tracker 420 may be a personalized learning process to improve the determination of the state candidates by the dialog state tracker 218 under different contexts using real-time user feedback. More information on conversational understanding reinforcement engine may be found in U.S. patent application Ser. No. 17/186,459, filed 26 Feb. 2021, which is incorporated by reference.

In particular embodiments, the state candidates generated by the CURE tracker 420 may be sent to the action selector 222. The action selector 222 may consult with the task policies 364, which may be generated from execution specifications accessed via the task specification manager API 430. In particular embodiments, the execution specifications may describe how a task should be executed and what actions the action selector 222 may need to take to complete the task.

In particular embodiments, the action selector 222 may determine actions associated with the system. Such actions may involve the agents 228 to execute. As a result, the action selector 222 may send the system actions to the agents 228 and the agents 228 may return the execution results of these actions. In particular embodiments, the action selector may determine actions associated with the user or device. Such actions may need to be executed by the delivery system 230. As a result, the action selector 222 may send the user/device actions to the delivery system 230 and the delivery system 230 may return the execution results of these actions.

The embodiments disclosed herein may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured content (e.g., real-world photographs). The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HM4D, a mobile device or computing system, or any other hardware platform capable of providing artificial reality content to one or more viewers.

Retrieve-and-Fill for Scenario-Based Task-Oriented Semantic Parsinz

### Introduction

Task-oriented semantic parsing models have achieved strong results in recent years, but unfortunately may not strike an appealing balance between model size, runtime latency, and cross-domain generalizability. The embodiments disclosed herein may tackle this problem by introducing scenario-based semantic parsing: a variant of the original task which first requires disambiguating an utterance's “scenario” (an intent-slot template with variable leaf spans) before generating its frame, complete with ontology and utterance tokens. This formulation may enable the assistant system 140 to isolate coarse-grained and fine-grained aspects of the task, each of which we may solve with off-the-shelf neural modules, also optimizing for the axes outlined above. Concretely, we create a Retrieve-and-Fill (RAF) architecture comprised of (1) a retrieval module which ranks the best scenario given an utterance and (2) a filling module which imputes spans into the scenario to create the frame. Our model may be modular, differentiable, interpretable, and allow us to garner extra supervision from scenarios. RAF achieves strong results in high-resource, low-resource, and multilingual settings, outperforming recent approaches by wide margins despite, using base pre-trained encoders, small sequence lengths, and constant-time inference.

Task-oriented conversational assistants may first use semantic parsers to map textual utterances into structured frames for language understanding (Hemphill et al., 1990; Coucke et al., 2018; Gupta et al., 2018; Rongali et al., 2020; Aghajanyan et al., 2020). While these parsers achieve strong performance with rich supervision, they may face obstacles adapting to novel settings, especially ones with distinct semantics and scarce data. Recent approaches address this by improving parsers' data efficiency, such as by using pre-trained representations (Aghajanyan et al., 2020; Rongali et al., 2020), optimizing loss functions (Chen et al., 2020b), and supplying natural language prompts (Desai et al., 2021). However, these approaches may rely on larger models and longer contexts, impeding their applicability in real-world conversational assistants. Even though non-autoregressive models may alleviate some concerns (Babu et al., 2021; Shrivastava et al., 2021; Zhu et al., 2020), to the best of our knowledge, there exists no approach which strikes an appealing balance between model size, runtime latency, and cross-domain generalizability.

We begin tackling this problem by introducing scenario-based task-oriented semantic parsing, a slight variation on our original task, which may proceed in two steps: (1) given an utterance, the assistant system 140 may disambiguate its scenario and (2) the assistant system 140 may refine this scenario into a frame. Here, a scenario may be akin to a incomplete frame; it may be, precisely, an intent-slot template with variables as leaf spans (e.g., IN:GET_WEATHER [SL:LOCATION x₁ 1 1), indicating it maps to a family of linguistically similar utterances. Our intuition is that, by establishing this intermediate step, we may isolate both the coarse-grained and fine-grained aspects of semantic parsing, then tackle each sub-task independently while optimizing for the axes we outlined above.

Concretely, the embodiments disclosed herein propose RAF (Retrieve-and-Fill), a modular yet differentiable architecture for scenario-based task-oriented semantic parsing. Guided by the definition of our task, RAF may also proceed in two steps: (1) given an utterance, a retrieval module may find the highest ranking scenario and (2) given the utterance and retrieved scenario, a filling module may impute spans into the scenario, creating the final frame. This approach may require no extra supervision despite performing auxiliary inference: utterances and frames may be provided, and scenarios may be obtained by stripping leaf text in frames. We design RAF to capitalize on the advantages of prior work but avoid their disadvantages; using base pre-trained encoders across-the-board, our retrieval module may cache intrinsic representations during inference and our filling module may non-autoregressively decode leaf spans in a generalizable fashion.

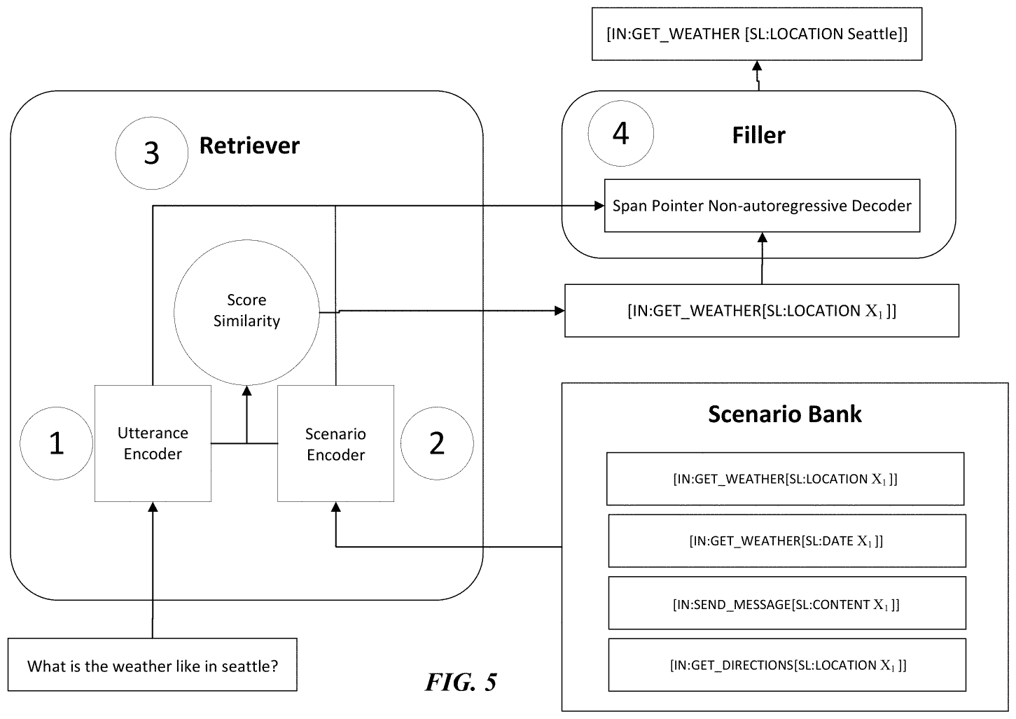

FIG. 5 illustrates an example flow diagram of retrieve-and-fill for scenario-based task-oriented semantic parsing. Retrieve-and-Fill (RAF) may comprise 4 steps: (1) Encode the utterance via an utterance encoder (e.g., RoBERTa); (2) Encode all scenarios (Desai et al., 2021) in the scenario bank into a cached index via a scenario encoder (e.g., RoBERTa); (3) Compute the dot product similarity amongst the incoming utterance and the index of all scenarios, obtaining the top-n candidates; (4) For each retrieved scenario, leverage the non-autoregressive span pointer decoder (Shrivastava et al., 2021) to impute each scenario's spans.

We evaluate our approach in high-resource, low-resource, and multilingual settings using standard task-oriented semantic parsing datasets. RAF achieves 87.52% EM on TOPv2 (Chen et al., 2020b) and 86.14% EM on TOP (Gupta et al., 2018), outperforming recent autoregressive and non-autoregressive models. RAF may also excel in weakly supervised settings: on TOPv2-DA (Desai et al., 2021), we outperform Inventory (Desai et al., 2021) on 4 domains (alarm, music, timer, weather) despite using <128 token sequence lengths and 2-4× less parameters, on TOPv2-LR (Chen et al., 2020b), we outperform BART (Lewis et al., 2020), RINE (Mansimov and Zhang, 2021), and RoBERTa+Span Pointer (Shrivastava et al., 2021) by wide margins on weather, and on MTOP (Li et al., 2021), we outperform XLM-R+Span Pointer (Shrivastava et al., 2021), achieving 42% EM averaged across en→{es, fr, de, hi, th} transfer tasks.

To summarize, our contributions may include: (1) Introducing scenario-based task-oriented semantic parsing, a novel task which may require disambiguating scenarios during typical utterance→frame predictions; (2) Creating RAF (Retrieve-and-Fill), a modular yet differentiable architecture composed of a retrieval and filling module for solving scenario-based task-oriented semantic parsing; and (3) Achieving strong results in high-resource, low-resource, and multilingual settings, outperforming recent models such as Span Pointer, Inventory, and RINE by large margins, while also optimizing for model size, runtime latency, and cross-domain generalizability.

Scenario-Based Semantic Parsing

We formally introduce the task of scenario-based semantic parsing. Task-oriented conversational assistants may support a wide range of domains (e.g., calling, reminders, weather) to maximize coverage over users' needs. Over time, in response to requests and feedback, developers may iterate on assistants' skill-sets by adding new domains. Though the crowdsourcing process of collecting and annotating samples-utterances and frames—for new domains may be accomplished in many ways, we propose a two-step methodology where developers may (a) develop scenarios which roughly describe a family of samples and (b) collect linguistically-varied samples consistent with each scenario. We elaborate more on our scenario-based methodology below.

Scenario Definition. We define a scenario as an intent-slot rule which abstracts away linguistic variation in utterances. More specifically, it may be a de-coupled semantic frame (Aghajanyan et al., 2020) with variables in leaf spans, indicating it can subclass utterances with similar syntactic and semantic structure, an example is showing in Table 2. Our notion of a scenario is inspired by production rules in constituency parsing (Chomsky, 1959), but the parallel may be not exact given our scenarios have semantic not syntactic types.

TABLE 2
Scenario Description. Scenarios may be intent-slot templates with missing slot text, suggesting
they subclass linguistically similar utterances. We show examples of utterances, scenarios, and
frames in the weather domain; each scenario consists of multiple (utterance, frame) pairs.

| | |
|---|---|
| Utterance | Frame |

Scenario: [IN:GET_WEATHER [SL:LOCATION x₁ ] ]

| | |
|---|---|
| what's the weather in seattle | [IN:GET_WEATHER [SL:LOCATION seattle ] ] |
| how's the forecast in sf | [IN:GET_WEATHER [SL:LOCATION sf ] ] |

Scenario: [IN:GET_WEATHER [SL:LOCATION x₁ ] [SL:DATE_TIME x₂] ]

| | |
|---|---|
| what's the weather in seattle tomorrow | [IN:GET_WEATHER [SL:LOCATION seattle ] [SL:DATE_TIME tomorrow ] ] |
| how's the forecast in sf at 8pm | [IN:GET_WEATHER [SL:LOCATION sf ] [SL:DATE_TIME 8pm ] ] |

Using scenarios, we may effectively quantize the space of possible utterances by identifying and defining slices of user requests. Our solution may also offer fine-grained control over precision and recall, which may be important in real-world systems; we may collect more paraphrases to improve precision and we may create more scenarios to improve recall.

Case Study: Weather. FIG. 5 shows an example setting where we crowdsource weather domain samples using the scenario-based methodology outlined above. To begin, we may envision building a weather system which supports requests with location and/or date-time information. Therefore, we can define two scenarios: (1) a family of samples with one location span; and (2) a family of samples with one location span and one date-time span. Each scenario may explicitly outline the intents and slots that must be present, as scenarios may be not “one-size-fits-all” rules with optional slotting. So, as an example, the utterance “how's the forecast in sf” may not be compatible with the scenario [IN:GET_WEATHER [SL:LOCATION x₁][SL:DATE_TIME x₂] ] since it may not have a date-time span as specified by the x₂ variable.

Generalization Types. There may be multiple types of generalization developers may care about when building conversational systems; we specifically focus on two, namely intra-scenario and extra-scenario generalization. By intra-scenario generalization, we refer to a systems' ability to parse linguistic variations of the same scenario, and by extra-scenario generalization, we refer to a systems' ability to parse scenarios with unseen intent-slot combinations. Using the weather example in Table 2, a system trained on the first scenario only may exhibit the following behavior: with intra-scenario generalization, it may be able to parse utterances inside the training scenario, and with extra-scenario, it may be able to parse utterances outside the training scenario. Our focus is primarily on intra-scenario generalization, as we argue high precision over an illustrative set of scenarios may be more important in the early stages of domain development. But, extra-scenario generalization may be also an interesting avenue, as it may offer opportunities to explore techniques with data augmentation (Andreas, 2020), inductive biases (Oren et al., 2020), compositionality (Gupta et al., 2018), etc.

Task Definition. Finally, we may precisely define our task of scenario-based semantic parsing. For the typical task of semantic parsing, we define U as a random variable over utterances, F as a random variable over frames, and model P(F|U): find the most likely frame given the utterance. However, because we introduce scenarios as a coarse, intermediate representation of frames, we additionally define S as a random variable over scenarios and are given all supported scenarios a priori, and model P(F|U, S)P(S|U): a coarse-to-fine objective where we (a) find the most likely scenario given the utterance and (b) find the most likely frame given the utterance and scenario.

This objective may be similar, in spirit, to other coarse-to-fine setups in syntactic and semantic parsing (Dong and Lapata, 2018), but we explore different parameterizations of the likelihood functions, as further discussed in the next section.

RAF: Retrieve and Fill

We propose a model called RAF (Retrieve and Fill) for our scenario-based semantic parsing task. Given an utterance u and scenarios s₁, . . . , sₙ, as well as a gold scenario s* and gold frame f*, we may learn our model as follows:
1. Retrieve (Coarse Step): A retrieval module may maximize P(S=s*|U=u) by learning to retrieve scenario sᵢ given utterance u, e.g., “what's the weather in seattle”→[IN:GET_WEATHER [SL:LOCATION x₁]].
2. Fill (Fine Step): A filling module may maximize P(F=f*|U=u, S=s*) by decoding the most likely frame f given the structure of scenario sᵢ* and spans of utterance u, e.g., [IN:GET_WEATHER [SL:LOCATION x1] ]→[IN:GET_WEATHER [SL:LOCATION seattle] ].

RAF may be a composable yet differentiable model which implements coarse-to-fine processing: we may first develop a coarse-grained sketch of an utterance's frame, then impute fine-grained details to achieve the final frame. In these types of approaches, there may exist a trade-off when creating the intermediate representation; if it is “too coarse”, the filling module may suffer, but if it is be “too fine”, the retrieval module may suffer. We find scenarios that offer the most appealing solution, as the retrieval module unearths rough syntactic-semantic structure, while the filling module focuses in on imputing exact leaf spans.

In the following disclosure, we discuss the technical details behind the retrieval and filling modules, as well as describe the training and inference procedures.

First, we discuss the coarse-grained step of RAF, which may aim to find the best-fitting scenario for an utterance.

A typical solution may be learning a classifier which explicitly maximizes the conditional probability P(S=s*|U=u) of an utterance u mapping to a scenario s*. The classifier may be parameterized with a pre-trained encoder, and its parameters may be learned via maximum likelihood estimation. However, the multi-class classification approach may have a couple of disadvantages; each scenario s* may contain useful signal in its structure (e.g., its intents and slots) which may be not utilized and the output space itself may not be “hot swapped” during inference, such as if new scenarios were to be dynamically added.

An alternative may be formulating this task as a metric learning problem. Here, we may maximize the similarity sim(u, s*) between an utterance u and scenario s* as judged by a scalar metric. This may offer numerous advantages: we may explore ad-hoc encodings of utterances and scenarios, adjust the output space dynamically during inference, and compute exact conditional probabilities by leveraging a (tractable) partition function.

Following retrieval modeling in open-domain QA (Karpukhin et al., 2020), we specifically leverage pre-trained encoders (E_{U} for utterances and E_{S} for scenarios) to compute dense vector representations, then maximize the dot product similarity sim(u, s*)=E_{U}(u)^{T}E_{S}(R(s*)) between utterance-scenario pairs (u, s*); the precise nature of R is discussed in the following disclosure. To learn such a metric space and avoid degenerate solutions we may need to train the encoders to pull positive pairs together and push negative pairs apart. Hence, we may need access to both positive (gold; (u, s⁺)) and negative (non-gold; (u, s⁻)) pairs.

The choice of negatives may have a large impact on retrieval performance, which is consistent with findings in information retrieval (Zhan et al., 2021; Karpukhin et al., 2020). We explore two types of negative sampling to improve retrieval performance: in-batch negatives and model-based negatives.

In-Batch Negatives. We mine positive and negative pairs from each training batch using in-batch negatives (Karpukhin et al., 2020). Let U and S be the utterance and scenario matrices, each being a (B×d) matrix consisting of d-dimensional embeddings up to batch size B. We may obtain B² similarity scores upon computing the similarity matrix M=US^{T}, where Mᵢ₌ⱼ consists of positive scores and Mᵢ≠ⱼ consists of negative scores. For each positive utterance-scenario pair (uᵢ, sᵢ⁺), we now have (B−1) negative pairs {(ui, s_{i̅j̅})}_{i≠j}. Having collected multiple negative pairs per positive pair, we may leverage the contrastive loss defined in Karpukhin et al. (2020); Chen et al. (2020a):

$${L}_{retrieval} ( {u}_{i} , {s}_{i}^{+} , {s}_{i}^{-} , … , {s}_{im}^{-} ) = log \frac{exp ( sim ( {u}_{i} , {s}_{i}^{+} ) )}{exp ( sim ( {u}_{i} , {s}_{i}^{+} ) ) + {\sum }_{i \neq j}^{m} exp ( sim ( {u}_{i} , {s}_{ij}^{-} ) )} \qquad ( 1 )$$

Model-Based Negatives. While in-batch negatives may greatly expand the number of negatives, these negatives may not be particularly challenging as they are randomly sampled from the training dataset. To increase the quality of our utterance-scenario metric, we explore augmenting in-batch negatives with model-based negatives. Specifically, given a retrieval module from training round t with metric sim^{t}(u, s)=E_{U}^{t} (u)^{T} E_{S}^{t} (s), we find the top-k neighbors for each positive pair (uᵢ, sᵢ⁺) by computing argmax_{(1 . . . k)} {sim^{t} (uᵢ, sₖ)|1≤k≤n∧i≠k}. Using this algorithm, we cache each training example's hard negatives, then in training round (t+1), we fine-tune the retrieval module using both in-batch and model-based negatives. Each non-seed training round t>1 may therefore feature at most (B(k+1)−1) negatives per positive pair. This procedure may be similar to iterative training used in (Oguz et al., 2021).

Identity Masking. The precise number of negatives may be empirically slightly less, as sometimes we may see conflicts between each training examples' negative pairs. Let (uᵢ, sᵢ) and (uⱼ, sⱼ) be two training examples within the same batch. During model-based negatives sampling in training round t, (uⱼ, sⱼ) may include sᵢ as a top-k negative pair. This may complicate metric learning as sᵢ becomes a positive and negative for uᵢ simultaneously. We therefore implement an identity mask on each training example's negatives which may ensure no conflicts when mixing in-batch and model-based negatives.

While we have covered scenario-based retrieval above, we have not yet precisely described how dense vectors for scenarios are computed. Recall our definition of utterance-scenario similarity: our objective is to maximize sim(u, s)=E_{U} (u)^{T}E_{S}(R(s)), where R is a string transformation applied to scenarios.

Because we parameterize E_{U} and E_{S} with standard pre-trained encoders (e.g., RoBERTa), it may follow that E_{U}(u) and E_{S}(s) must return approximately similar vectors in order to have a high dot product. However, a task setup using vanilla utterances and scenarios may not achieve this. Consider the utterance “what's the weather in seattle” and scenario IN:GET_WEATHER [SL:LOCATION x₁] ]. Pre-trained encoders may return strong return representations for the utterance, but not necessarily for the scenario; because they have been pre-trained on naturally-occurring, large-scale text corpora, they may be unlikely to glean as much value from dataset-specific concepts, such as IN:GET_WEATHER and SL:LOCATION.

An effective solution to this problem, as proposed by Desai et al. (2021), may leverage intrinsic modeling to rewrite intents and slots as a composition of their intrinsic parts in a single string. Desai et al. (2021) define two, in particular: the categorical type (e.g., “intent” or “slot”) and language span (e.g., “get weather” or “location”). Using this methodology, we may transform the scenario IN:GET_WEATHER [SL:LOCATION x1]]→[intent|get weather [slot|location x1] ], which may be inherently more natural and descriptive.

Guided by the general concept of intrinsic modeling, our goal here may be to define R such that E_{U}(u)^{T}E_{S}(s)≤E_{U}(u)^{T}E_{S}(R(s)), all else being equal. We discuss our approach in detail in the following disclosure.

Desai et al. (2021) chiefly use an automatic method to extract language spans from ontology labels. For example, using standard string processing functions, we may extract “get weather” from IN:GET_WEATHER. While this method may be a surprisingly strong baseline, it may heavily rely on a third-party developers' notion of ontology nomenclature, which may not always be pragmatically useful. In TOPv2 (Chen et al., 2020b), our principal evaluation dataset, there exists ambiguous labels like SL:AGE—is this referring to the age of a person, place, or thing?

Therefore, to improve consistency and descriptiveness, we propose a handmade method where we manually design language spans for each ontology label. (See Appendix B for our curated intent and slot descriptions, respectively.) This approach may be similar to prompting (Brown et al., 2020; Schick and Schütze, 2021; Gao et al., 2020; Shin et al., 2020), but unlike typical prompt-engineering methods, we attempt to assign intuitive descriptions with no trial-and-error. While it may be certainly possible to achieve better results with state-of-the-art methods, our aim is to be as generalizable as possible while still reaping the benefits of descriptive prompting.

The most frequent techniques we use are (1) using the label as-is (e.g., IN:GET_WEATHER→“get weather”); (2) inserting or rearranging prepositions (e.g., IN:ADD_TO_PLAYLIST_MUSIC→“add music to playlist”; and (3) elaborating using domain knowledge (e.g., IN:UNSUPPORTED_ALARM→“unsupported alarm request”).

Despite using curation to improve ontology label descriptions, there may be still many labels which remain ambiguous. One such example may be SL:SOURCE; this may refer to a travel source or messaging source, but without seeing its exact manifestations, it may be challenging to fully grasp its meaning. This motivates us to explore example priming: augmenting scenario representations with randomly sampled, dataset-specific slot values. This may help our model further narrow down the set of spans each slot maps to during parsing. Furthermore, our examples are just spans, so they may be straightforward to incorporate into our representation. For example, for the slot SL:WEATHER_TEMPERATURE_UNIT, we may augment and contextualize its representation “slot|unit of weather temperature” with “slot|unit of weather temperature|F/C” where “F” and “C” are examples which appear in our dataset.

Our scenario-based retrieval task may perform reasoning over a compact set of scenarios, unlike large-scale, open-domain tasks such as information retrieval and question answering which inculcate millions of documents. As such, the chance our system overfits to a particular representation may be much greater, no matter what it is set to. So, we instead make R stochastic by uniformly sampling unique frame representations for encoding scenarios. We re-define R as a discrete random variable with outcomes {r₁, . . . , rₙ} where

$$P ( R = {r}_{i} ) = \frac{1}{n} .$$

Each rᵢ denotes a unique scenario representation (e.g., a string using curated descriptions without examples); Table 11 enumerates the complete set of outcomes. While we intend to improve the generalizability of our system during training, we typically want deterministic behavior during testing, and therefore we restrict the outcomes to a singleton {rᵢ}.

Next, we discuss the fine-grained step of RAF, which aims to infill a retrieved scenario with utterance spans in leaf slots. Unlike the coarse-grained step, the fine-grained step may be modeled with off-the-shelf models from prior work in task-oriented semantic parsing.

This step may be typically modeled as a seq2seq problem where a decoder maps a scenario s* to a frame f* using cross-attention on an utterance u, which may result in the objective P(F=f*|U=u, S=s*). Because frame f*is a sequence, this objective may be factorized in multiple ways: an autoregressive approach Πᵢ₌₁ⁿP(fᵢ*|f_{<i-1}*, u, s*) assumes conditional dependence on prior frame tokens while a non-autoregressive approach Πᵢ₌₁ⁿ P(fᵢ*| u, s*) assumes conditional independence. We elect to use the latter given its recent successes in task-oriented semantic parsing; we refer interested readers to Babu et al. (2021); Shrivastava et al. (2021) for technical details. We largely use their model as-is, but one modification we make is scenario fusion. Rather than the decoder learning an embedding matrix for scenario tokens from scratch, we may initialize the decoder's embeddings with the scenario encoder's final state. Our final objective is L_{filling}=NLL(f*, f)+αLS(f) where LS refers to label smoothing (Pereyra et al., 2017).

Once we combine the coarse-grained and fine-grained steps, we now have an end-to-end system which may map an utterance (“get weather in seattle”) to a frame with ontology tokens (intents and slots) and utterance spans (e.g., [IN:GET_WEATHER [SL:LOCATION seattle] ]).

Because our system may require strong negatives for accurate retrieval, we may decompose training into three steps: (1) Train RAF using in-batch negatives only; (2) Sample the top-n frames as model-based negatives from RAF in Step (1) by running it over the training set; (3) Train RAF using both in-batch negatives and model-based negatives. RAF may three sets of parameters to train: the retrieval module consists of an utterance encoder θ_{U} and scenario encoder θ_{S}, while the filling module consists of a frame decoder θ_{F}. Our system may be modularized and differentiable, therefore we may fine-tune these modules using a joint loss [symbol] (θ_{U}, θ_{S}, θ_{F})= [symbol] ᵣₑₜᵣᵢₑᵥₐₗ (θ_{U}, θ_{S})+β [symbol] _{filling} (θ_{U}, θ_{S}, θ_{F}) where β is a scalar weighting term. In the low-resource setting, we further augment our loss with an optional R3F term (Aghajanyan et al., 2021) to encourage robust representations following Shrivastava et al. (2021).

During inference, we may pipeline RAF's components: given an utterance u, the retrieval module may find the best scenario s′=argmax_{s′}P(s|u), and using the predicted scenario as a template, the filling module may output a frame f′=argmax_{f′}P(f|u,s^{l}) with ontology tokens (intents and slots) and utterance spans. Importantly, to maintain inference efficiency, the scenario encoders' embeddings over the scenario set can be cached, since these are known a priori.

### EXPERIMENTS AND RESULTS

We evaluate RAF in three settings: a high-resource setting (100,000+ training samples), low-resource setting (1-1,000 training samples), and multilingual setting (0 training samples). Our goal here is to show that our system both achieves competitive performance on established benchmarks and offers substantial benefits in resource-constrained environments where training samples are limited.

Following prior work in task-oriented semantic parsing Babu et al. (2021); Aghajanyan et al. (2020); Shrivastava et al. (2021); Mansimov and Zhang (2021); Desai and Aly (2021); Desai et al. (2021); Gupta et al. (2021); Rongali et al. (2020), we use 5 datasets for evaluation: TOP (Gupta et al., 2018), TOPv2 (Chen et al., 2020b), TOPv2-LR (Low Resource; Chen et al. (2020b)), TOPv2-DA (Domain Adaptation; Desai et al. (2021)), and MTOP (Li et al., 2021). TOP and TOPv2 are used for high-resource experiments, TOPv2-LR and TOPv2-DA are used for low-resource experiments, and MTOP is used in multilingual experiments.

We compare against multiple task-oriented semantic parsing models, which cover autoregressive (AR), and non-autoregressive (NAR) training. See Aghajanyan et al. (2020); Mansimov and Zhang (2021); Babu et al. (2021); Shrivastava et al. (2021) for detailed descriptions of these models.

The autoregressive models consist of BART (Lewis et al., 2020) and RoBERTa (Liu et al., 2019), and RINE (Mansimov and Zhang, 2021), and the non-autoregressive models are RoBERTa NAR (Babu et al., 2021) and RoBERTa NAR+Span Pointer (Shrivastava et al., 2021). These models are applicable to both high-resource and low-resource settings; though, for the latter, we also add baselines from Desai et al. (2021): CopyGen (BART+copy-gen decoder) and Inventory (BART+intrinsic modeling). The multilingual setting only requires swapping RoBERTa with XLM-R (Conneau et al., 2020).

TABLE 3
High-Resource Results. Exact Match (EM) on TOPv2 (Chen et al.,
2020b) and TOP (Gupta et al., 2018). We compare various semantic
parsing paradigms: autoregressive, non-autoregressive, and scenario.
RAF achieves strong performance on TOPv2 and TOP, illustrating
its competitiveness with state-of-the-art models.

| | | |
|---|---|---|
| Model | TOPv2 | TOP |

Type: Autoregressive Modeling (Prior)

| | | |
|---|---|---|
| RoBERTa_{BASE} | 86.62 | 83.17 |
| RoBERTa_{LARGE} | 86.25 | 82.24 |
| BART_{BASE} | 86.73 | 84.33 |
| BART_{LARGE} | 87.48 | 85.71 |

Type: Non-Autoregressive Modeling (Prior)

| | | |
|---|---|---|
| RoBERTa_{BASE} | 85.78 | 82.37 |
| + Span Pointer | 86.93 | 84.45 |
| RoBERTa_{LARGE} | 86.25 | 83.40 |
| + Span Pointer | 87.37 | 85.07 |

Type: Scenario Modeling (Ours)

| | | |
|---|---|---|
| RAF_{BASE} | 87.11 | 86.00 |
| RAF_{LARGE} | 87.52 | 86.14 |

We denote our system as RAF in our experiments. Unless noted otherwise, we use RoBERTa_{BASE} for the utterance encoder θ_{U} and secnario θ_{S} and a random-init, copy-gen, trans-former decoder for the frame decoder θ_{F}. As alluded to before, we swap RoBERTa_{BASE} with XLM-R_{BASE} for multilingual experiments.

First, we evaluate RAF in a high-resource setting where hundreds of thousands are samples are available for supervised training; Table 3 shows the results. RAF achieves strong results across-the-board, using both base and large pre-trained encoders: RAF_{BASE} consistently outperforms other base variants by 0.25-0.5 EM and RAF_{LARGE} comparatively achieves the best results on TOP and TOPv2.

TABLE 4
High-Difficulty Low-Resource Results. EM on the 1 SPIS
split of TOPv2-DA (Desai et al., 2021). Compared to
Inventory and CopyGen baselines, RAF achieves competitive
performance with a fraction of parameter usage.

| | alarm | music | timer | weather |
|---|---|---|---|---|
| CopyGen_{BASE} | 47.24 | 25.58 | 16.62 | 47.24 |
| CopyGen_{LARGE} | 36.91 | 23.84 | 32.64 | 53.08 |
| Inventory_{BASE} | 62.13 | 23.00 | 28.92 | 54.53 |
| Inventory_{LARGE} | 67.25 | 38.68 | 48.45 | 61.77 |
| RAF_{BASE} (ours) | 62.71 | 35.47 | 55.06 | 61.05 |

Having established our system is competitive in high-resource settings, we now turn towards evaluating it in low-resource settings, where training samples are not as readily available. Here, we chiefly consider two setting types: a high difficulty setting (TOPv2-DA) with 1-10 samples and a medium difficulty setting (TOPv2-LR) with 1001,000 samples. The exact number of samples in a few-shot training subset depend on both the sub-set's cardinality and sampling algorithm.

Tables 4 and 5 show results on the high and medium difficulty settings, respectively. RAF achieves competitive results in the high-difficulty setting, outperforming both CopyGen_{BASE} and Inventory_{BASE} by large margins; notably, on timer, we nearly double Inventory_{BASE's} exact match score. RAF also performs well in the medium-difficulty setting; our system consistently outperforms prior autoregressive, and non-autoregressive models. These results particularly highlight the effectiveness of coarse-to-fine modeling: our retrieval module learns a generalizable notion of utterance scenario mappings, especially given that utterance and scenarios are scored on semantic alignment, and our filling module precisely infills utterance spans into the scenario template.

TABLE 5
Medium-Difficulty Low-Resource Results.

| Weather Domain (SPIS) | | | | | |
|---|---|---|---|---|---|
| 10 | 25 | 50 | 100 | 500 | 1000 |

Type: Autoregressive Modeling (Prior)

| | | | | | | |
|---|---|---|---|---|---|---|
| RoBERTa_{BASE} AR | 69.71 | 74.90 | 77.02 | 78.69 | — | 86.36 |
| BART_{BASE} AR | 73.34 | 73.35 | 76.58 | 79.16 | — | 86.25 |
| RINE_{BASE} | — | 74.53 | — | — | 87.80 | — |
| RINE_{LARGE} | — | 77.03 | — | — | 87.50 | — |

Type: Non-Autoregressive Modeling (Prior)

| | | | | | | |
|---|---|---|---|---|---|---|
| RoBERTa_{BASE} NAR | 59.01 | 72.12 | 73.41 | 78.48 | — | 87.42 |
| +Span Pointer | 72.03 | 74.74 | 74.85 | 78.14 | — | 88.47 |

Type: Scenario Modeling (Ours)

| | | | | | | |
|---|---|---|---|---|---|---|
| RAF_{BASE} | 75.10 | 78.74 | 77.53 | 79.67 | 87.91 | 88.17 |

EM on various SPIS splits of the TOPv2 (Chen et al., 2020b) weather domain. RAF largely outperforms autoregressive and non-autoregressive models, trailing RoBERTa-Base + Span Pointer only in a high-resource split.

Finally, we consider a multilingual setting, where a model trained on English samples undergoes zero-shot transfer to non-English samples. In Table 6, we see that, compared to XLM-RBASE NAR+Span Pointer, RAF achieves+2.3 EM averaged across all 5 non-English languages. Upon inspecting this result more closely, RAF's performance is strong across both typologically similar languages (+4.8 EM on Spanish, +3.5 EM on French) and distinct languages (+2.7 EM on Hindi and Thai). A key reason for RAF's strong performance may be most of the domain shift is localized to the retrieval module. In MTOP, utterances across multiple languages have linguistic variation but their scenarios are the exact same, and so a bulk of our system's work may be in retrieving the correct scenario. While our results illustrate the efficacy of a monolingual retriever, we may explore creating a multilingual retriever; due to our system's modularity, such a retriever may simply be a drop-in replacement for the current one.

TABLE 6
Multilingual Results.

| | | Zero-Shot Evaluation | | | | | |
|---|---|---|---|---|---|---|---|
| | en | en→es | en→fr | en→de | en→hi | en→th | Avg |
| XLM-R_{BASE} NAR | 78.3 | 35.2 | 32.2 | 23.6 | 18.1 | 16.7 | 25.2 |
| +Span Pointer | 83.0 | 51.2 | 51.4 | 42.0 | 29.6 | 27.3 | 40.3 |
| RAF_{BASE} (ours) | 81.1 | 56.0 | 54.9 | 40.1 | 32.1 | 30.0 | 42.6 |

We perform zero-shot experiments where we fine-tune a parser on English (en), then evaluate it a non-English language-Spanish (es), French (fr), German (de), Hindi (hi), and Thai (th)-without fine-tuning. Average EM (Avg) is taken over the five non-English languages. RAF outperforms XLM-R-Base + Span Pointer by +2.3% on average.

Ablations and Analysis

While our experiments show RAF achieves strong performance in high-resource, low-resource, and multilingual settings, we have not yet isolated the contribution of its different components. Here, we perform several experiments to better understand RAF's design decisions.

First, we perform model ablations on RAF, removing core retrieval- and filling-related components. From Table 7, we draw the following conclusions:

Negatives are important for accurate scenario retrieval. The metric learning objective for retrieval may precisely delineate between positive and negative samples. Our ab-lations show model-based negatives and identity masking may be critical to achieve best performance; when removing model-based negatives, for example, retrieval accuracy drops by 3%+. We also investigate training RAF with heuristic-based negatives: a simple algorithm which finds top-k similar scenarios with string-based edit distance (See Appendix A). However, heuristic-based negatives may regress both retrieval-only and end-to-end approach, suggesting model-based negatives are more informative.

Sharing parameters between retrieval encoders improves quality. Our retrieval module has two encoders: an utterance encoder EU and a scenario encoder ES. An important design decision we make may be tying both encoders' parameters together with RoBERTa (Liu et al., 2019); this improves end-to-end performance by roughly+0.6 EM. We believe that parameter sharing among retrieval encoders may improve generalizability: because there may be more vastly more unique utterances than scenarios, the scenario encoder may overfit to a select set of scenarios, so weight tying may enable the joint optimization of both encoders.

Scenario fusion enables better end-to-end modeling. Because RAF is composed of two neural modules—the retrieval and filling modules—chaining them together arbitrarily may result in information loss. The filling module may chiefly use scenario token embeddings to reason over the retrieval module's outputs. Our results show that scenario fusion, initializing these embeddings using the scenario encoder's final state, improves upon random init by +0.77 EM and +0.65 EM-S.

TABLE 7
Model Ablations. We assess several components of our
model, individually removing them and evaluating
EM (Exact Match) and EM-S (Exact Match of Scenarios,
i.e., intent-slot templates without slot text) on
the TOPv2 (Chen et al., 2020b) validation set.

| Model | EM | EM-S |
|---|---|---|
| Classify and Fill | 84.80 | 87.16 |
| RAF_{BASE} | 87.03 | 89.34 |
| − Hard Negatives | 83.69 | 86.00 |
| − Identity Masking | 85.87 | 88.23 |
| − Scenario Fusion | 86.26 | 88.69 |
| − Parameter sharing | 86.76 | 89.10 |
| − Repr. Sampling | 86.70 | 89.05 |
| + Heuristic negatives | 85.66 | 89.10 |

Our results above demonstrate representation sampling may be a key piece of end-to-end modeling. But, do we need to include all representations outlined in Appendix B in our sampling scheme? The principal reason we use intrinsic representations is for cross-domain robustness, and so we focus our ablation on a low-resource setting, Weather (25 SPIS) in TOPv2-LR. Using the typical low-resource fine-tuning algorithm (Section XXX), we adapt multiple versions of RAF to Weather, each omitting a representation (intrinsic automatic, handmade, or examples) from the sampling algorithm.

Table 8 shows these results. When comparing the high-level scenario representation, we see that canonical (e.g., “[IN:GET_WEATHER [SL:LOCATION]”) underperforms intrinsic (e.g., “[intent|get weather [slot|location] ]”) by a wide margin (−4.49%) in the target domain. This may imply RAF better understands scenarios' natural language descriptions even if they contain unseen, domain-specific terms. Furthermore, we see leveraging all concepts (handmade, automatic, examples) achieves both competitive source and target performance. Even though excluding handmade improves target performance (+0.53%), it regresses source performance (−0.28%), suggesting sampling all representations may be more generalizable.

TABLE 8
Scenario representation ablation, where the target domain is a 25
SPIS split of the TOPv2 (Chen et al., 2020b) weather domain. Following
the typical few-shot fine-tuning methodology, we perform source
fine-tuning on all domains except weather and reminder, then perform
target fine-tuning on a specific split. Encouragingly, we see intrinsic
representations result in better EM and EM-S.

| | Source Fine-Tuning | | Target Fine-Tuning | |
|---|---|---|---|---|
| Model | EM | EM-S | EM | EM-S |
| Canonical Repr. | 86.67 | 88.74 | 74.25 | 76.80 |
| Intrinsic Repr. | 87.10 | 89.15 | 78.74 | 81.70 |
| − Automatic | 87.02 | 89.06 | 78.92 | 81.80 |
| − Handmade | 86.85 | 88.87 | 79.27 | 82.29 |
| − Examples | 86.91 | 88.90 | 78.25 | 80.89 |

We now turn towards better understanding the aspects our model struggles with. Because RAF jointly optimizes both the retrieval and filling modules, one question we pose is whether the retrieval or filling task is more difficult. We create three versions of RAF: (1) standard retrieval+standard filling, (2) oracle retrieval+standard filling, and (3) standard retrieval+oracle filling. By comparing models (1), (2), and (3), we may judge the relative difficulty of each task.

TABLE 9
Evaluating whether retrieval or filling is the most challenging components of RAF in
low-resource settings. We fine-tune several variants of RAF, using either a standard/oracle
retriever and a standard/oracle filler, on various SPIS splits of the TOPv2 (Chen et
al., 2020b) weather domain. RAF with oracle retrieval achieves the best performance,
suggesting utterance→scenario retrieval is the most difficult piece to model.

| | Weather Domain (SPIS) | | | | | | | |
|---|---|---|---|---|---|---|---|---|
| | 0 | 10 | 25 | 50 | 100 | 500 | 1000 | Avg |
| RAF_{BASE} | | | | | | | | |
| Standard Retrieval + Standard Filling | 26.19 | 75.10 | 78.74 | 77.53 | 79.67 | 87.91 | 88.17 | 73.33 |
| Oracle Retrieval + Standard Filling | 81.68 | 90.43 | 92.13 | 91.97 | 93.35 | 95.74 | 96.27 | 91.65 |
| Standard Retrieval + Oracle Filling | 27.67 | 77.84 | 81.70 | 79.92 | 81.78 | 89.88 | 90.44 | 75.60 |

We begin by evaluating these models in a high-resource setting; on the TOPv2 eval dataset, the standard model gets 87.03%, retrieval oracle gets 96.56%, and filling oracle gets 89.34%. Here, the gap between models (1)-(2) is +9.53%, while the gap between models (1)-(3) is +2.31%, indicating the retrieval module may be the main performance bottleneck. We also perform experiments in low-resource and multilingual settings, displaying results in Tables 9 and 10, respectively. These results also confirm the same trend: in both settings, the retrieval oracle achieves the best performance, notably achieving +18.3% averaged across 5 multilingual transfer experiments.

TABLE 10
Evaluating whether retrieval or filling is the most challenging components
of RAF in low-resource settings. See Table 9 for a description of our
methodology; we use MTOP (Li et al., 2021) for evaluation instead.

| | | Zero-Shot Evaluation | | | | | |
|---|---|---|---|---|---|---|---|
| | en | en→es | en→fr | en→de | en→hi | en→th | Avg |
| RAF_{BASE} | | | | | | | |
| Standard Retrieval + Standard Filling | 81.1 | 56.0 | 54.9 | 40.1 | 32.1 | 30.0 | 42.6 |
| Oracle Retrieval + Standard Filling | 91.0 | 68.9 | 71.6 | 67.5 | 47.5 | 48.9 | 60.9 |
| Standard Retrieval + Oracle Filling | 83.8 | 66.5 | 62.8 | 45.5 | 40.2 | 46.7 | 52.3 |

Despite retrieval having the most room for improvement, we also see some evidence filling struggles in certain multilingual transfer cases; for example, providing gold spans can improve en→th transfer by +16.7%. As such, there may be ample opportunity for optimizing the retrieval and filling modules.

A core difference between scenario-based and non-scenario-based (seq2seq; autoregressive or non-autoregressive) models may be that scenario-based models “know” of all scenarios beforehand, while seq2seq models do not, and therefore have to purely rely on generalization. We further quantify the impact that this has by dividing overall EM using two groups: (1) Known vs. Unknown—scenarios in the training dataset vs. test dataset and (2) In-Domain vs. Out-of-Domain—scenarios with a supported intent vs. unsupported intent (e.g., IN:UNSUPPORTED_*).

TABLE 11
Comparing EM on Known vs. Unknown and In-Domain (ID) vs.
Out-of-Domain (OD) frames. RAF performs better on unknown
frames but struggles with out-of-domain frames.

| | | Known | Unknown | ID | OOD |
|---|---|---|---|---|---|
| Model | EM | EM | EM | EM | EM |
| RAF_{BASE} | 87.14 | 88.30 | 59.96 | 88.67 | 44.11 |
| SpanPointer_{BASE} | 86.76 | 88.50 | 46.20 | 88.07 | 49.70 |
| BART_{BASE} | 86.72 | 88.33 | 49.15 | 88.03 | 49.69 |

From the results in Table 11, we may draw a couple of conclusions. First, RAF outperforms on Unknown EM given that we index unique scenarios across the train, eval, and test datasets before fine-tuning. Second, RAF outperforms on In-Domain EM but underperforms on Out-of-Domain EM. Because RAF leverages intrinsic descriptions of scenarios, the word “unsupported” may not precisely capture what it means for an utterance to be in- vs. out-of-domain.

Visualizations

Because RAF encodes utterances and scenarios into a joint embedding space, we can directly visualize this space to further understand our models' inner-workings. We present two case studies: domain development and error analysis.

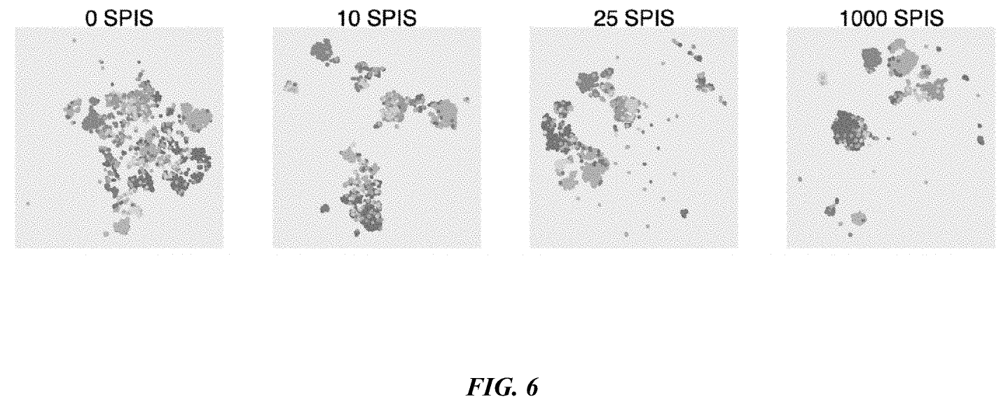

FIG. 6 illustrates an example visualization of the semantic space for the weather domain as the model is trained on more and more data. Here, we train RAF with 4 dataset sizes (0 SPIS, 10 SPIS, 25 SPIS, and 1,000 SPIS) to simulate zero-shot, few-shot, low-resource, and high-resource settings, respectively. We visualize the index prior to any training (0 SPIS) to low-resource (10, 25 SPIS) and high resource (1000 SPIS). The graphs are TSNE projections of the utterance vectors used for retrieval color coded by the scenario each utterance belongs to. Each utterance (from the high-resource split) is projected using an utterance encoder and colored according to its gold scenario. Interestingly, the zero-shot setting has multiple, apparent clusters, but the overall performance is poor given many scenarios overlap with each other. The clusters spread further apart as the dataset size increases, suggesting the scenarios may become more well-defined.

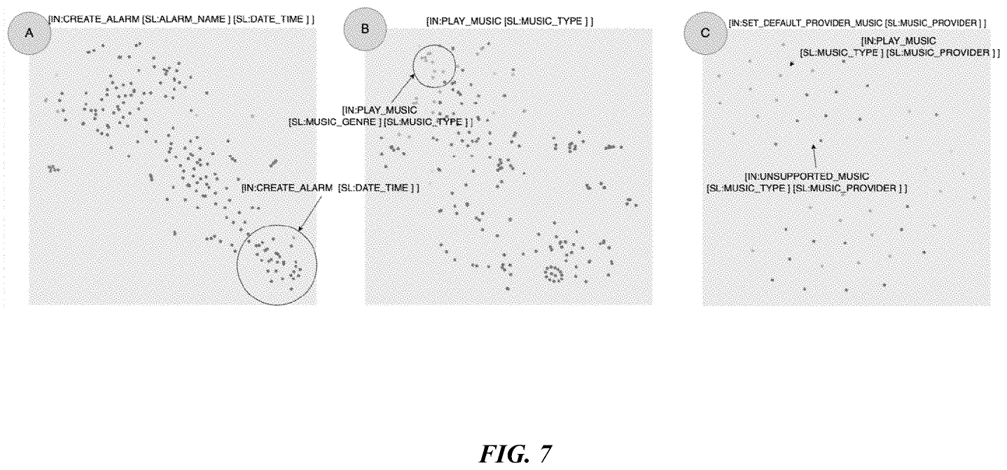

While we have demonstrated how RAF refines the utterance-scenario space as we increase dataset size, we now dive deeper into how each space can be used to further analyze domain semantics. FIG. 7 illustrates an example depiction of scenario visualizations. In FIG. 7, using our high-resource-trained RAF model, we create multiple scenario spaces: each utterance is projected using an utterance encoder and colored according to its predicted frame. Each is a TSNE projection of utterances belonging to the specified scenario color coded by the predicted scenario. We use these scenario spaces in several debugging exercises:
Slot Ambiguity: In FIG. 7 (A), we investigate the scenario [IN:CREATE_ALARM [SL:ALARM_NAME] [SL:DATE_TIME], showing a case of ambiguity of alarm names. Here, we notice a cluster of predictions with the frame [IN:CREATE_ALARM [SL:DATE_TIME] missing the [SL:ALARM_NAME]. These map to utterances such as “I want to wake up at 7 am” where the annotation has “wake up is SL:ALARM_NAME; however, our model does not identify this. There are other examples, such as “wake me up at 7 am”, which are annotated without SL:ALARM_NAME, leading to ambiguity of whether or not “wake up” is an alarm name.
Incorrect Annotations: In FIG. 7 (B), we investigate the scenario [IN:PLAY_MUSIC [SL:MUSIC_TYPE] where annotations are missing the slot “music type”. Here, we notice a cluster of predictions with the frame [IN:PLAY_MUSIC [SL:MUSIC_GENRE] [SL:MUSIC_TYPE] adding the [SL:MUSIC_GENRE]. These map to utterances such as “Play 1960s music” where here the annotation only has “music” as SL:MUSIC_TYPE, but our model predicts “1960s” as SL:MUSIC_GENRE. We believe this may be an incorrect annotation in this cluster.
Underfitting: In FIG. 7 (C), we investigate the scenario [IN:SET_DEFAULT_PROVIDER_MUSIC [SL:MUSIC_PROVIDER], showing how our model requires more support here as the predictions for this scenario span OOD and music domain. This cluster is highly diverse, consisting of predictions from other music intents (e.g., IN:PLAY_MUSIC) and out-of-domain intents (e.g., IN.UNSUPPORTED_MUSIC). This scenario may need more data in order to be more properly defined.

Related Work

Recent trends in semantic parsing have started to shift towards the seq2seq paradigm (Aghajanyan et al., 2020; Rongali et al., 2020; Li et al., 2021). However, seq2seq modeling typically has high latency, impeding application in real-world settings. One line of work aims at efficient parsing through logarithmic time decoding; for example, insertion parsing (Zhu et al., 2020), bottom-up parsing (Rubin and Berant, 2021), and breadth-first parsing (Liu et al., 2021). Alternative strategies include leveraging insertion transformers to recursively insert ontology tokens into the input, making the model's decoding complexity in the number of intent-slot tokens (Mansimov and Zhang, 2021). Babu et al. (2021) introduces a one-shot CMLM (Ghazvininejad et al., 2019)-style approach for non-autoregressive semantic parsing, where we model target tokens independently. However, such parses struggle in generalization due to the rigidity of the length prediction tasks. Shrivastava et al. (2021) further augment this with span-based decoding, leading to more consistent length prediction and, as a result, generalizable modeling.

The embodiments disclosed herein continues in the direction of one-shot decoding by leveraging span-based, non-autoregressive decoding, however, rather than relying on length prediction, we rely on scenario retrieval. We find scenario retrieval as a more interpretable and scalable intermediate task.

Another critical property of semantic parses lies in reducing data requirements to stand up new domains and scenarios. Existing works rely on leveraging large language models such as BART (Lewis et al., 2020) with augmentations for scaling. In particular Chen et al. (2020b) introduce a meta-learning approach to improve domain scaling in the low-resource setting. Other works such as (Liu et al., 2021; Zhu et al., 2020; Mansimov and Zhang, 2021) aim to improve scaling through new decoding formulations. Desai et al. (2021) introduce the concept of intrinsic modeling where we provide a human-readable version of the semantic parsing ontology as context to encoding to improve few-shot generalization.

The embodiments disclosed herein leverage the intrinsic modeling paradigm by building a function R to convert each intent-slot scenario into a readable representation via intent slot descriptions and example priming. Furthermore, our bi-encoder based retrieval setup may allow us to inject additional context into each scenario and cache it to an index in order to retain inference efficiency.

Finally, there has been a recent trend towards dense retrieval in various NLP domains such as machine translation (Cai et al., 2021), question answering (Karpukhin et al., 2020), text generation (Cai et al., 2019) and language modeling (Borgeaud et al., 2018). Recent works also introduce retrieval-based semantic parsing (Gupta et al., 2021; Pasupat et al., 2021). RetroNLU (Gupta et al., 2021) and CASPER (Pasupat et al., 2021) both leverage a retrieval step to provide examples as context to seq2seq models.

The embodiments disclosed herein differ in two ways: (1) We phrase our problem as utterance-to-scenario retrieval rather than utterance-to-utterance retrieval. This may allow us to look into supporting new scenarios with minimal-to-no-data required for retrieval. (2) Prior work may leverage a separate module (Pasupat et al., 2021) or separate iteration (Gupta et al., 2021) for retrieval. We may conduct our retrieval after encoding but prior to decoding as an intermediate step for non-autoregressive parsing. This may allow our model to retain similar inference speed to one shot non-autoregressive decoding despite leveraging retrieval.

### CONCLUSION

The embodiments disclosed herein tackle scenario-based semantic parsing with retrieve-and-fill (RAF), a coarse-to-fine model which may (a) retrieve a scenario with the best alignment to an utterance and (b) fill the scenario with utterance spans in leaf positions. Exper-iments show our model achieves strong results in high-resource, low-resource, and multilingual settings. The modular nature of our architecture may also lend itself well to interpretability and debuggability; we perform several case studies uncovering the inner-workings of our approach.

### REFERENCES

The following list of references correspond to the citations above:
Armen Aghajanyan, Jean Maillard, Akshat Shrivastava, Keith Diedrick, Michael Haeger, Haoran Li, Yashar Mehdad, Veselin Stoyanov, Anuj Kumar, Mike Lewis, and Sonal Gupta. 2020. Conversational Semantic Parsing. In Proceedings of the Conference on Empirical Methods in Natural Language Processing and the International Joint Conference on Natural Language Processing (EMNLP-IJCNLP).
Armen Aghajanyan, Akshat Shrivastava, Anchit Gupta, Naman Goyal, Luke Zettlemoyer, and Sonal Gupta. 2021. Better Fine-tuning by Reducing Representational Collapse. In Proceedings of the International Conference on Learning Representations (ICLR).
Jacob Andreas. 2020. Good-Enough Compositional Data Augmentation. In Proceedings of the Annual Meeting of the Association for Compositional Linguistics (ACL).
Arun Babu, Akshat Shrivastava, Armen Aghajanyan, Ahmed Aly, Angela Fan, and Marjan Ghazvininej. 2021. Non-Autoregressive Semantic Parsing for Compositional Task-Oriented Dialog. In Proceedings of the Annual Conference of the North American Chapter of the Associationfor Computational Linguistics (NAACL).
Sebastian Borgeaud, Arthur Mensch, Jordan Hoffmann, Trevor Cai, Eliza Rutherford, Katie Millican, George van den Driessche, Jean-Baptiste Lespiau, Bogdan Damoc, Aidan Clark, Diego de Las Casas, Aurelia Guy, Jacob Menick, Roman Ring, Tom Hennigan, Saffron Huang, Loren Maggiore, Chris Jones, Albin Cassirer, Andy Brock, Michela Paganini, Geoffrey Irving, Oriol Vinyals, Simon Osindero, Karen Simonyan, Jack W. Rae, Erich Elsen, and Laurent Sifre. 2018. Improving Language Models by Retrieving from Trillions of Tokens. arXiv preprint arXiv:2112.04426.
Tom B. Brown, Nick Ryder Benjamin Mann, Melanie Subbiah, Jared Kaplan, Prafulla Dhariwal, Arvind Neelakantan, Pranav Shyam, Girish Sastry, Amanda Askell, Sandhini Agarwal, Ariel Herbert-Voss, Gretchen Krueger, Tom Henighan, Rewon Child, Aditya Ramesh, Daniel M. Ziegler, Jeffrey Wu, Clemens Winter, Christopher Hesse, Mark Chen, Eric Sigler, Mateusz Litwin, Scott Gray, Benjamin Chess, Jack Clark, Christopher Berner, Sam McCandlish, Alec Radford, Ilya Sutskever, and Dario Amodei. 2020. Language Models are Few-Shot Learners. In Proceedings of the Conference on Neural Information Processing Systems (NeurIPS).
Deng Cai, Yan Wang, Wei Bi, Zhaopeng Tu, Xiao-jiang Liu, and Shuming Shi. 2019. Retrieval-guided Dialogue Response Generation via a Matching-to-Generation Framework. In Proceedings of the Conference on Empirical Methods in Natural Language Processing and the International Joint Conference on Natural Language Processing (EMNLP-IJCNLP).
Deng Cai, Yan Wang, Huayang Li, Wai Lam, and Lemao Liu. 2021. Neural Machine Translation with Monolingual Translation Memory. arXiv preprint arXiv:2105.11269.
Ting Chen, Simon Kornblith, Mohammad Norouzi, and Geoffrey Hinton. 2020a. A Simple Framework for Contrastive Learning of Visual Representations. arXivpreprint arXiv:2002.05709.
Xilun Chen, Ashish Ghoshal, Yashar Mehdad, Luke Zettlemoyer, and Sonal Gupta. 2020b. Low-Resource Domain Adaptation for Compositional Task-Oriented Semantic Parsing. In Proceedings of the Conference on Empirical Methods in Natural Language Processing (EMNLP).
Noam Chomsky. 1959. On Certain Formal Properties of Grammars. Elsevier.
Alexis Conneau, Kartikay Khandelwal, Naman Goyal, Vishrav Chaudhary, Guillaume Wenzek, Francisco Guzmin, Edouard Grave, Myle Ott, Luke Zettlemoyer, and Veselin Stoyanov. 2020. Unsupervised Cross-lingual Representation Learning at Scale. In Proceedings of the Annual Meeting of the Association for Computational Linguistics (ACL).
Alice Coucke, Alaa Saade, Adrien Ball, Theodore Bluche, Alexandre Caulier, David Leroy, Clement Doumouro, Thibault Gisselbrecht, Francesco Caltagirone, Thibaut Lavril, et al. 2018. Snips Voice Platform: An Embedded Spoken Language Understanding System for Private-by-Design Voice Interfaces. arXiv preprint arXiv:1805.10190.
Shrey Desai and Ahmed Aly. 2021. Diagnosing Transformers in Task-Oriented Semantic Parsing. In Proceedings of the Findings of the Association for Computational Linguistics: ACL 2021.
Shrey Desai, Akshat Shrivastava, Alexander Zotov, and Ahmed Aly. 2021. Low-resource task-oriented semantic parsing via intrinsic modeling. arXiv preprint arXiv:2104.07224.
Li Dong and Mirella Lapata. 2018. Coarse-to-Fine Decoding for Neural Semantic Parsing. In Proceedings of the Annual Meeting of the Association for Computational Linguistics (ACL).
Tianyu Gao, Adam Fisch, and Danqi Chen. 2020. Making Pre-trained Language Models Better Few-shot Learners. In Proceedings of the Annual Conference of the Association for Computational Linguistics (ACL).
Marjan Ghazvininejad, Omer Levy, Yinhan Liu, and Luke Zettlemoyer. 2019. Mask-Predict: Parallel Decoding of Conditional Masked Language Models. In Proceedings of the Conference on Empirical Methods in Natural Language Processing and the International Joint Conference on Natural Language Processing (EMNLP-IJCNLP).
Sonal Gupta, Rushin Shah, Mrinal Mohit, Anuj Kumar, and Mike Lewis. 2018. Semantic Parsing for Task Oriented Dialog using Hierarchical Representations. In Proceedings of the Conference on Empirical Methods in Natural Language Processing (EMNLP).
Vivek Gupta, Akshat Shrivastava, Adithya Sagar, Armen Aghajanyan, and Denis Savenkov. 2021. Retronlu: Retrieval augmented task-oriented semantic parsing. arXivpreprint arXiv:2109.10410.
Charles T. Hemphill, John J. Godfrey, and George R. Doddington. 1990. The ATIS Spoken Language Systems Pilot Corpus. In Proceedings of the Workshop on Speech and Natural Language.
Vladimir Karpukhin, Barlas Og\check{ } uz, Sewon Min, Patrick Lewis, Ledell Wu, Sergey Edunov, Danqi Chen, and Wen tau Yih. 2020. Dense Passage Retrieval for Open-Domain Question Answering. arXiv preprint arXiv:2004.04906.
V. I. Levenshtein. 1966. Binary Codes Capable of Correcting Deletions, Insertions and Reversals. Soviet Physics Doklady, 10:707.
Mike Lewis, Yinhan Liu, Naman Goyal, Marjan Ghazvininejad, Abdelrahman Mohamed, Omer Levy, Ves Stoyanov, and Luke Zettlemoyer. 2020. BART: Denoising Sequence-to-Sequence Pre-training for Natural Language Generation, Translation, and Comprehension. In Proceedings of the Annual Meeting of the Association for Computational Linguistics (ACL).
Haoran Li, Abhinav Arora, Shuohui Chen, An-chit Gupta, Sonal Gupta, and Yashar Mehdad. 2021. MTOP: A Comprehensive Multilingual Task-Oriented Semantic Parsing Benchmark. Proceedings of the European Chapter of the Association for Computational Linguistics (EACL).
Yinhan Liu, Myle Ott, Naman Goyal, Jingfei Du, Mandar Joshi, Danqi Chen, Omer Levy, Mike Lewis, Luke Zettlemoyer, and Veselin Stoyanov. 2019. RoBERTa: A Robustly Optimized BERT Pretraining Approach. arXiv preprint arXiv:1907.11692.
Zihan Liu, Genta Indra Winata, Peng Xu, and Pascale Fung. 2021. X2Parser: Cross-Lingual and Cross-Domain Framework for Task-Oriented Compositional Semantic Parsing. arXiv preprint arXiv:2106.03777.
Elman Mansimov and Yi Zhang. 2021. Semantic Parsing in Task-Oriented Dialog with Recursive Insertion-based Encoder. arXiv preprint arXiv:2109.04500.
Inbar Oren, Jonathan Herzig, Nitish Gupta, Matt Gardner, and Jonathan Berant. 2020. Improving Compositional Generalization in Semantic Parsing. In Proceedings of the Findings of the Associationfor Computational Linguistics (EMNLP).
Barlas Og\check{ } uz, Kushal Lakhotia, Anchit Gupta, Patrick Lewis, Vladimir Karpukhin, Aleksandra Piktus, Xilun Chen, Sebastian Riedel, Wen tau Yih, Sonal Gupta, and Yashar Mehdad. 2021. Domain-matched pre-training tasks for dense retrieval. arXiv preprint arXiv:2107.13602.
Panupong Pasupat, Yuan Zhang, and Kelvin Guu. 2021. Controllable semantic parsing via retrieval augmentation. arXiv preprint arXiv:2110.08458.
Gabriel Pereyra, George Tucker, Jan Chorowski, Łukasz Kaiser, and Geoffrey Hinton. 2017. Regularizing Neural Networks by Penalizing Confident Output Distributions. In Proceedings of the International Conference on Learning Representations (ICLR): Workshop Track.
Subendhu Rongali, Luca Soldaini, Emilio Monti, and Wael Hamza. 2020. Don't Parse, Generate!A Sequence to Sequence Architecture for Task-Oriented Semantic Parsing. In Proceedings of the Web Conference (WWW).
Ohad Rubin and Jonathan Berant. 2021. SmBoP: Semi-autoregressive Bottom-up Semantic Parsing. arXiv preprint arXiv:2010.12412.
Timo Schick and Hinrich Schütze. 2021. It's Not Just Size That Matters: Small Language Models Are Also Few-Shot Learners. In Proceedings of the Conference on Annual Conference of the North American Chapter of the Association for Computational Linguistics (NAACL).
Taylor Shin, Yasaman Razeghi, Robert L. Logan I V, Eric Wallace, and Sameer Singh. 2020. AutoPrompt: Eliciting Knowledge from Language Models with Automatically Generated Prompts. In Proceedings of the Conference on Empirical Methods in Natural Language Processing (EMNLP).
Akshat Shrivastava, Pierce Chuang, Arun Babu, Shrey Desai, Abhinav Arora, Alexander Zotov, and Ahmed Aly. 2021. Span Pointer Networks for Non-Autoregressive Task-Oriented Semantic Parsing. In Proceedings of the Findings of the Conference on Empirical Methods in Natural Language Processing (EMNLP).
Jingtao Zhan, Jiaxin Mao, Yiqun Liu, Jiafeng Guo, Min Zhang, and Shaoping Ma. 2021. Optimizing Dense Retrieval Model Training with Hard Negatives. arXiv preprint arXiv:2104.08051.
Qile Zhu, Haidar Khan, Saleh Soltan, Stephen Rawls, and Wael Hamza. 2020. Don't Parse, Insert: Multilingual Semantic Parsing with Insertion Based Decoding. arXivpreprint arXiv:2010.03714.

### Appendix A: Heuristic Negatives

In order to understand the importance of model based hard negatives, we develop a simple heuristic to curate a set of hard negative scenarios for each gold scenario. Our heuristic may involve selecting the top-N scenarios that share the top level intent but have the lowest Levenshtein edit distance (Levenshtein, 1966) compared to the gold scenario. The full algorithm is described in Algorithm 1. In Table 7 we present the full results depicting the importance of model based negative sampling. We show that while our heuristic improves on top of no hard negatives (in-batch negatives only), it may still lag behind model based hard negatives (−1.37%).

Algorithm 1 Heuristic-based negative sampling via edit distance.

| | |
|---|---|
| 1 | procedure EDIT DISTANCE NEGATIVES |
| 2 | S ← all scenarios |
| 3 | s* ← current scenario |
| 4 | S_{same intent} ← |
| | Scenarios with the same top level intent as Si |
| 5 | heap ← min heap of score and structure |
| 6 | for Sᵢ ∈ S_{same intent} do |
| 7 | score ← LevenshteinDistance(s*, Sᵢ) |
| 8 | heappush(heap, score, Sᵢ) |
| | return heap |

### Appendix B: Intrinsic Descriptions

In Table 12 we provide brief examples of the various representation functions used in RAF training. In Tables 13 and 14 we present the intrinsic handmade descriptions used for each intent/slot on TOPv2 (Chen et al., 2020b) respectively.

TABLE 12
List of intrinsic representations used for encoding scenarios in RAF.

| R Type | R Example |
|---|---|
| type-only | [ intent [ slot ] ] |
| automatic-span | [ add time timer [ measurement unit ] ] |
| automatic-type-span | [ intent \| add time timer [ slot \| measurement unit ] ] |
| automatic-type-span-exs | [ intent \| add time timer [ slot \| measurement unit \| sec / min / hr ] ] |
| curated-span | [ add time to timer [ unit of measurement ] ] |
| curated-type-span | [ intent \| add time to timer [ slot \| unit of measurement ] ] |
| curated-type-span-exs | [ intent \| add time to timer [ slot \| unit of measurement \| sec / min / hr ] ] |

TABLE 13
List of intrinsic handmade descriptions for intents in TOPv2 (Chen et al., 2020b).

| Intent Token | Description |
|---|---|
| IN:ADD_TIME_TIMER | add time to timer |
| IN:ADD_TO_PLAYLIST_MUSIC | add music to playlist |
| IN:CANCEL_MESSAGE | cancel message |
| IN:CREATE_ALARM | create alarm |
| IN:CREATE_PLAYLIST_MUSIC | create playlist music |
| IN:CREATE_REMINDER | create reminder |
| IN:CREATE_TIMER | create timer |
| IN:DELETE_ALARM | delete alarm |
| IN:DELETE_REMINDER | delete reminder |
| IN:DELETE_TIMER | delete timer |
| IN:DISLIKE_MUSIC | dislike music |
| IN:GET_ALARM | get alarm |
| IN:GET_BIRTHDAY | get birthday |
| IN:GET_CONTACT | get contact |
| IN:GET_DIRECTIONS | get directions |
| IN:GET_DISTANCE | get distance between locations |
| IN:GET_ESTIMATED_ARRIVAL | get estimated arrival time |
| IN:GET_ESTIMATED_DEPARTURE | get estimated departure time |
| IN:GET_ESTIMATED_DURATION | get estimated duration of travel |
| IN:GET_EVENT | get event |
| IN:GET_EVENT_ATTENDEE | get event attendee |
| IN:GET_EVENT_ORGANIZER | get organizer of event |
| IN:GET_INFO_CONTACT | get info of contact |
| IN:GET_INFO_ROAD_CONDITION | get info of road condition |
| IN:GET_INFO_ROUTE | get info of route |
| IN:GET_INFO_TRAFFIC | get info of traffic |
| IN:GET_LOCATION | get location |
| IN:GET_LOCATION_HOME | get location of my home |
| IN:GET_LOCATION_HOMETOWN | get location of my hometown |
| IN:GET_LOCATION_SCHOOL | get location of school |
| IN:GET_LOCATION_WORK | get location of work |
| IN:GET_MESSAGE | get message |
| IN:GET_RECURRING_DATE_TIME | get recurring date or time |
| IN:GET_REMINDER | get reminder |
| IN:GET_REMINDER_AMOUNT | get amount of reminders |
| IN:GET_REMINDER_DATE_TIME | get date or time of reminder |
| IN:GET_REMINDER_LOCATION | get location of reminder |
| IN:GET_SUNRISE | get info of sunrise |
| IN:GET_SUNSET | get info of sunset |
| IN:GET_TIME | get time |
| IN:GET_TIMER | get timer |
| IN:GET_TODO | get todo item |
| IN:GET_WEATHER | get weather |
| IN:HELP_REMINDER | get help reminder |
| IN:IGNORE_MESSAGE | ignore message |
| IN:LIKE_MUSIC | like music |
| IN:LOOP_MUSIC | loop music |
| IN:NEGATION | negate |
| IN:PAUSE_MUSIC | pause music |
| IN:PAUSE_TIMER | pause timer |
| IN:PLAY_MUSIC | play music |
| IN:PREVIOUS_TRACK_MUSIC | play previous music track |
| IN:REACT_MESSAGE | react to message |
| IN:REMOVE_FROM_PLAYLIST_MUSIC | remove from music playlist |
| IN:REPLAY_MUSIC | replay music |
| IN:PREVIOUS_TRACK_MUSIC | play previous music track |
| IN:REACT_MESSAGE | react to message |
| IN:REMOVE_FROM_PLAYLIST_MUSIC | remove from music playlist |
| IN:REPLAY_MUSIC | replay music |
| IN:REPLY_MESSAGE | reply to message |
| IN:RESTART_TIMER | restart timer |
| IN:RESUME_TIMER | resume timer |
| IN:SELECT_ITEM | select item |
| IN:SEND_MESSAGE | send message |
| IN:SEND_TEXT_MESSAGE | send text message |
| IN:SET_DEFAULT_PROVIDER_MUSIC | set default music provider |
| IN:SILENCE_ALARM | silence alarm |
| IN:SKIP_TRACK_MUSIC | skip music track |
| IN:SNOOZE_ALARM | snooze alarm |
| IN:START_SHUFFLE_MUSIC | start shuffling music |
| IN:STOP_MUSIC | stop music |
| IN:SUBTRACT_TIME_TIMER | subtract time from timer |
| IN:UNSUPPORTED_ALARM | unsupported alarm request |
| IN:UNSUPPORTED_EVENT | unsupported event request |
| IN:UNSUPPORTED_MESSAGING | unsupported messaging request |
| IN:UNSUPPORTED_MUSIC | unsupported music request |
| IN:UNSUPPORTED_NAVIGATION | unsupported navigation request |
| IN:UNSUPPORTED_TIMER | unsupported timer request |
| IN:UNSUPPORTED_WEATHER | unsupported weather request |
| IN:UPDATE_ALARM | update alarm |
| IN:UPDATE_DIRECTIONS | update directions |
| IN:UPDATE_REMINDER | update reminder IN:UPDATE_REMINDER_DATE_TIMER update date time of reminder |
| IN:UPDATE_REMINDER_TODO | update todo of reminder |
| IN:UPDATE_TIMER | update timer |
| IN:UPDATE_REMINDER | update reminder IN:UPDATE_REMINDER_DATE_TIMER update date time of reminder |

TABLE 14
List of intrinsic handmade descriptions for slots in TOPv2 (Chen et al., 2020b).

| Slot Token | Description |
|---|---|
| SL:AGE | age of person |
| SL:ALARM_NAME | alarm name |
| SL:AMOUNT | amount |
| SL:ATTENDEE | attendee |
| SL:ATTENDEE_ADDED | attendee to be added |
| SL:ATTENDEE_EVENT | attendee of event |
| SL:ATTENDEE_REMOVED | attendee to be removed |
| SL:ATTRIBUTE_EVENT | attribute of event |
| SL:BIRTHDAY | birthday |
| SL:CATEGORY_EVENT | category of event |
| SL:CATEGORY_LOCATION | category of location |
| SL:CONTACT | contact |
| SL:CONTACT_RELATED | contact related |
| SL:CONTENT_EMOJI | content text with emoji |
| SL:CONTEnT_EXACT | content text |
| SL:DATE_TIME | date or time |
| SL:DATE_TIME_ARRIVAL | date or time of arrival |
| SL:DATE_TIME_BIRTHDAY | date or time of birthday |
| SL:DATE_TIME_DEPARTURE | date or time of departure |
| SL:DATE_TIME_NEW | new date or time |
| SL:DATE_TIME_RECURRING | recurring date or time |
| SL:DESTINATION | travel destination |
| SL:DURATION | duration |
| SL:FREQUENCY | frequency |
| SL:GROUP | group |
| SL:JOB | job |
| SL:LOCATION | location |
| SL:LOCATION_CURRENT | current location |
| SL:LOCATION_HOME | location of my home |
| SL:LOCATION_MODIFIER | location modifier |
| SL:LOCATION_USER | location of user |
| SL:LOCATION_WORK | location of work |
| SL:MEASUREMENT_UNIT | unit of measurement |
| SL:METHOD_RETRIEVAL_REMINDER | method of retrieving reminder |
| SL:METHOD_TIMER | method of timer |
| SL:METHOD_TRAVEL | method of traveling |
| SL:MUSIC_ALBUM_TITLE | title of music album |
| SL:MUSIC_ARIST_NAME | name of music artist |
| SL:MUSIC_GENRE | genre of music |
| SL:MUSIC_PLAYLIST_TITLE | title of music playlist |
| SL:MUSIC_PROVIDER_NAME | name of music provider |
| SL:MUSIC_RADIO_ID | id of music radio |
| SL:MUSIC_TRACK_TITLE | title of music track |
| SL:MUSIC_TYPE | type of music |
| SL:MUTUAL_EMPLOYER | mutual employer |
| SL:MUTUAL_LOCATION | mutual location |
| SL:MUTUAL_SCHOOL | mutual school |
| SL:NAME_APP | name of app |
| SL:NAME_EVENT | name of event |
| SL:OBSTRUCTION_AVOID | obstruction to avoid |
| SL:ORDINAL | ordinal |
| SL:ORGANIZER_EVENT | obstruction to avoid |
| SL:ORDINAL | ordinal |
| SL:ORGANIZER_EVENT | organizer of event |
| SL:PATH | path |
| SL:PATH_AVOID | path to avoid |
| SL:PERIOD | time period |
| SL:PERSON_REMINDED | person to be reminded |
| SL:PERSON_REMINDED_ADDED | added person to be reminded |
| SL:PERSON_REMINDED_REMOVED | removed person to be reminded |
| SL:POINT_ON_MAP | point on map |
| SL:RECIPIENT | message recipient |
| SL:RECURRING_DATE_TIME | recurring date or time |
| SL:RECURRING_DATE_TIME_NEW | new recurring date or time |
| SL:RESOURCE | resource |
| SL:ROAD_CONDITION | road condition |
| SL:ROAD_CONDITION_AVOID | road condition to avoid |
| SL:SEARCH_RADIUS | search radius |
| SL:SENDER | message sender |
| SL:SOURCE | travel source |
| SL:TAG_MESSGE | tag of message |
| SL:TIMER_NAME | timer name |
| SL:TIME_ZONE | time zone |
| SL:TODO | todo item |
| SL:TODO_NEW | new todo item |
| SL:TYPE_CONTACT | contact type |
| SL:TYPE_CONTENT | content type |
| SL:TYPE_INFO | info type |
| SL:TYPE_REACTION | reaction type |
| SL:TYPE_RELATION | relation type |
| SL:UNIT_DISTANCE | unit of distance |
| SL:WAYPOINT | waypoint |
| SL:WAYPOINT_ADDED | waypoint to be added |
| SL:WAYPOINT_AVOID | waypoint to avoid |
| SL:WEATHER_ATTRIBUTE | weather attribute |
| SL:WEATHER_TEMPERATURE_UNIT | unit of temperature |

### Fully Encrypted Audio for One-Shot Messaging

In particular embodiments, the assistant system 140 may utilize one-shot messaging, which may enable the assistant system 140 to send the right message on the intended platform to the intended contact in a single dialog turn. For example, the assistant system 140 may process a single input like “Hey Assistant, tell Jose on messaging app A that I'm leaving in ten minutes” to correctly send the message “I'm leaving in 10 minutes” on “messaging app A” to “Jose”. Sending messages with conventional voice assistants using voice interactions may be a lengthy, multi-step process, placing increased burden on the user to complete the task. In particular, the problem with sending one-shot messages on a messaging app with end-to-end encryption is, to honor such end-to-end encryption guarantee, the assistant system 140 may not allow users to include message content in the voice command (which may be visible to servers of the assistant system 140). The assistant system 140 may instead ask users to dictate the message content in a subsequent turn which may be only processed on-device. However, users may generally favor giving commands to the assistant system 140 in “one-shot”, or a “single turn”, for simple or high-confidence tasks like sending a message to a single recipient, as opposed to a message to an unnamed group. To address the problem, the assistant system 140 may use an architecture that fully encrypts all voice command audio. The server may only process the audio after the client system 130 determines that the request wasn't intended for an end-to-end encrypted app and sends the decryption key. The encryption/decryption may be quick/cheap in comparison to other parts of the assistant stack, so that may cause negligible latency (e.g., less than 1 ms, compared to 500 ms for the rest of the stack). While this disclosure focuses on solving the problem with preserving privacy on end-to-end encrypted apps, the embodiments disclosed herein may be applicable to any scenario where one wants to limit the amount of audio sent back to remote servers (e.g., for any app that uses end-to-end encryption, or for tasks where the user shares privacy-sensitive content). Although this disclosure describes sending particular messages by particular systems in a particular manner, this disclosure contemplates sending any suitable message by any suitable system in any suitable manner.

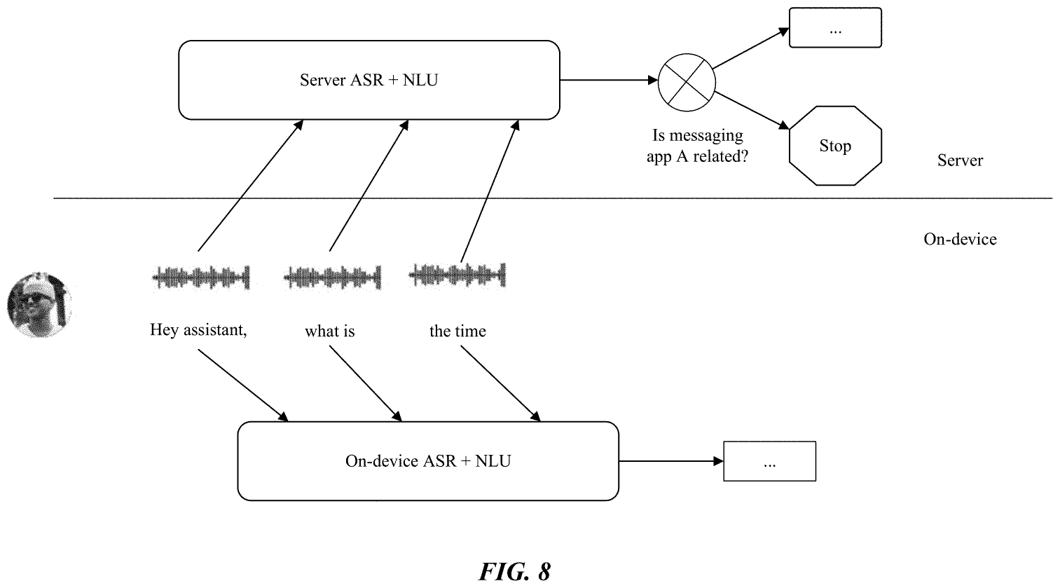

FIG. 8 illustrates an example architecture for a conventional voice assistant. In conventional implementation of voice assistants, the audio may be simultaneously processed by on-device ASR and server ASR, in streaming fashion. This may pose a privacy risk in a specific scenario, wherein the audio is not allowed to send to the server if the audio contains the message content in end-to-end encryption messaging. However, before processing the audio one may not know whether it contains message content. This may lead to the compromise using a 2-step message content solution.

In particular embodiments, the assistant system 140 may solve this problem in a principled way, by not sending data to the server until the client stack performs understanding and has confidence that it is okay to send data to the server for further processing. However, this may post the following technical challenges. If we send audio to server after the client stack finishes ASR and NLU to know what the user is asking, then run the full server ASR processing, and rely on its result to perform the fulfillment, the assistant system 140 may face unacceptable latency penalty. If we don't send audio to server and utilize the on-device ASR, the assistant system 140 may risk higher word error rate (WER) especially in large vocabulary, large entity count scenarios.

In particular embodiments, the assistant system 140 may be able to utilize server ASR processing without incurring unacceptable latency penalty. As an over-simplification, we may think about server ASR latency in the following major components. One major component may comprise preparation, including authentication, loading PLM, streaming audio to server. The bottleneck may be network latency/bandwidth constraints, and data center routing/scheduling. Another major component may comprise computation, which may include just CPU cycles. Another major component may comprise end-pointing, which may be not CPU-bound and need to wait sufficiently long after the end-of-speech to have confidence. These major components may overlap, especially in streaming processing. But they may form a useful framework to deal with latency.

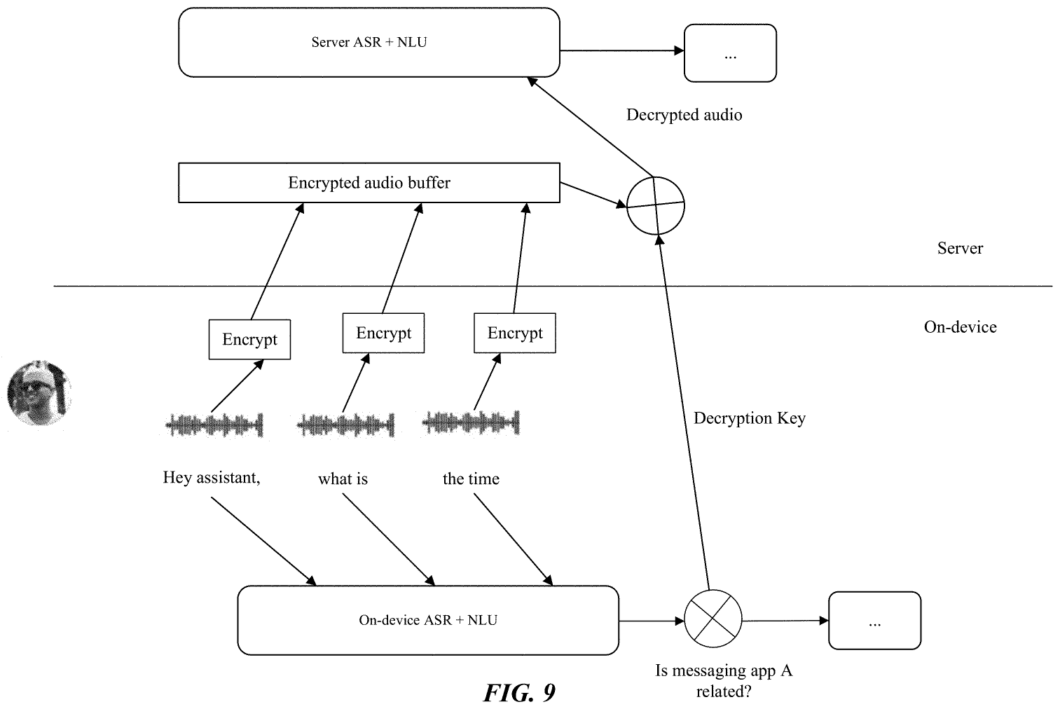

FIG. 9 illustrates an example architecture of one-shot messaging. In particular embodiments, based on the components described above, the assistant system 140 may do the following during runtime. After wake word is triggered on the device, audio may be streamed into on-device ASR for processing. Meanwhile, a random, single-use symmetric encryption key may be generated, and the audio content may be streamed to server, encrypted by the key. The server may then perform authentication, personalize language model loading, buffer the encrypted audio in RAM. After on-device understanding is done, if the orchestrator 206 decides that server processing should not occur, it may send a kill signal to the server, which may abandon the buffered content and stop processing. Otherwise, the client system 130 may send the following to the server: {encryption key, wake word time mark, and end-pointing information}. The server may decrypt the audio already buffered in RAM, ignore the wake word part and end-pointing part, go full steam to process the useful part of the audio, and produce result, which may be used in fulfillment. By doing this, the assistant system 140 may continue to take full advantage of the server ASR in large vocabulary, large entity-count scenarios. The preparation and end-pointing latency components may be ignored in latency penalty (except for the part where the overlapping hides compute time), and the compute time may matter more.

In particular embodiments, assuming back of envelop calculation is 2 seconds audio (which may be with wake word and end-pointing portions cut off) and 0.1 real-time factor (RTF), the assistant system 140 may have 200 ms latency penalty, which may be acceptable given a competitive analysis.

In particular embodiments, the assistant system 140 may perform ASR on encrypted audio directly to maintain privacy.

In particular embodiments, one-shot messaging may have features and messaging support identical to multi-turn messaging. In addition, one-shot messaging may have the following extra features and messaging support. When interplaying with model-based dialog (MBD), dialog may trigger as per MBD cases where there is ambiguity and need for clarification. Model-based dialog may not go into multi-turn flow for one-shot messaging attempt. Model-based dialog may remember the content of the message even if disambiguation is needed (No need to repeat message content if the content was clear). When interplaying with message reply, one-shot messaging may reduce the number of turns needed for message reply by allowing the user to dictate the content of the message in the initial turn, e.g., “hey assistant, reply with ‘I'm on my way’.” When interplaying with cross-provider support, one-shot messaging cases may be tested when question and answering (QA) for cross provider on certain client system (e.g., smart glasses) happens. When interplaying with native communications, one-shot messaging cases may be tested when QA for cross provider on certain client system (e.g., smart glasses) happens.

The following describes example use cases with one-shot messaging. In one use case, the user may say “hey assistant, tell Mom that I'm running late.” The assistant system 140 may then reply “Your message to Mom says, ‘I'm running late’ Ready to send?” In another use case with provider specified, the user may ask “hey assistant, message Mom on messaging app A that I'm running late.” The assistant system 140 may then reply “Your message to Mom on messaging app A says, ‘I'm running late’ Ready to send?” In another use case with message reply, the user may ask “hey assistant, reply with ‘I'm sure we can find a way to make it happen’.” The assistant system 140 may then reply “Your message to Mom on messaging app A says, ‘I'm sure we can find a way to make it happen’Ready to send?”

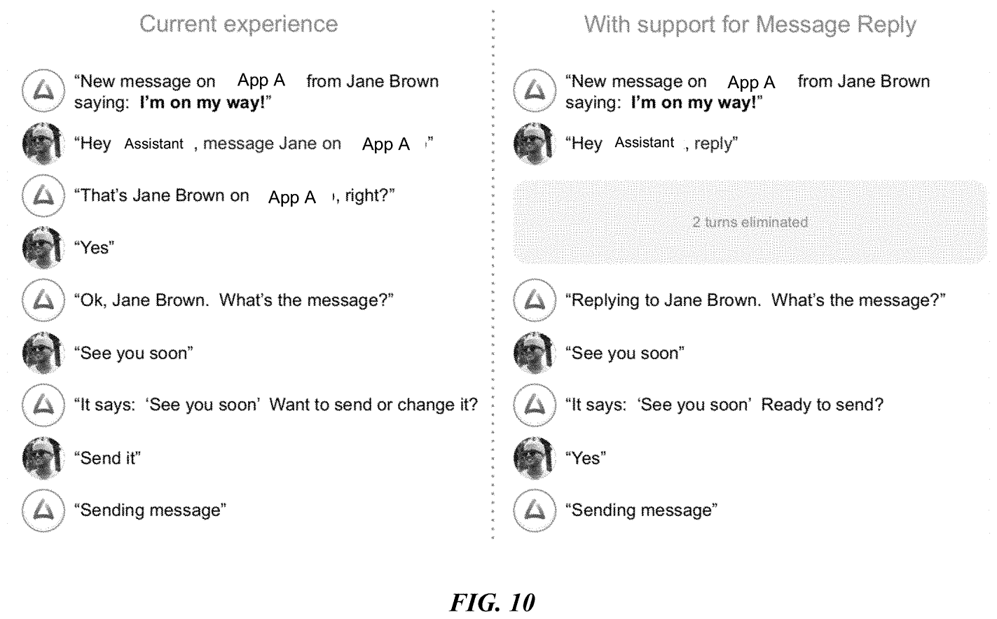

FIG. 10 illustrates an example comparison between current experience of conventional voice assistants and with support for message replay. For current experience of conventional voice assistants, the voice assistant may say “new message on App A from Jane Brown saying: I'm on my way!” The user may then say “Hey assistant, message Jane on App A.” The voice assistant may then say “That's Jane Brown on App A, right?” The user may say “Yes.” The voice assistant may then say “Ok, Jane Brown. What's the message?” The user may say “See you soon.” The voice assistant may then say “It says: ‘See you soon’ Want to send or change it?” The user may say “Send it.” The voice assistant may then say “Sending message.” By contrast, with support for message replay, the assistant system 140 may say “New message on App A from Jane Brown saying: I'm on my way!” The user may then say “Hey assistant, reply.” Two turns may be then eliminated. The assistant system 140 may say “Replying to Jane Brown. What's the message?” The user may then say “See you soon.” The assistant system 140 may then say “It says: ‘See you soon’ Ready to send?” The user may say “Yes.” The assistant system 140 may then say “Sending message.”

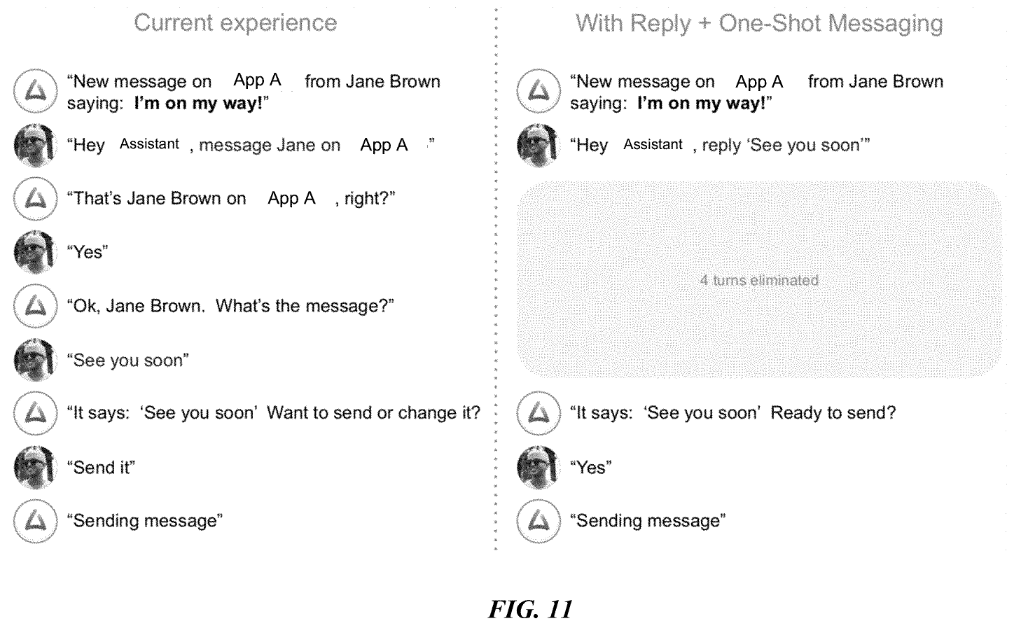

FIG. 11 illustrates an example comparison between current experience of conventional voice assistants and one-shot messaging with support for message replay. For current experience of conventional voice assistants, the voice assistant may say “new message on App A from Jane Brown saying: I'm on my way!” The user may then say “Hey assistant, message Jane on App A.” The voice assistant may then say “That's Jane Brown on App A, right?” The user may say “Yes.” The voice assistant may then say “Ok, Jane Brown. What's the message?” The user may say “See you soon.” The voice assistant may then say “It says: ‘See you soon’ Want to send or change it?” The user may say “Send it.” The voice assistant may then say “Sending message.” By contrast, for one-shot messaging with support for message replay, the assistant system 140 may say “New message on App A from Jane Brown saying: I'm on my way!” The user may then say “Hey assistant, reply ‘see you soon’.” Four turns may be then eliminated. The assistant system 140 may then say “It says: ‘See you soon’ Ready to send?” The user may say “Yes.” The assistant system 140 may then say “Sending message.”

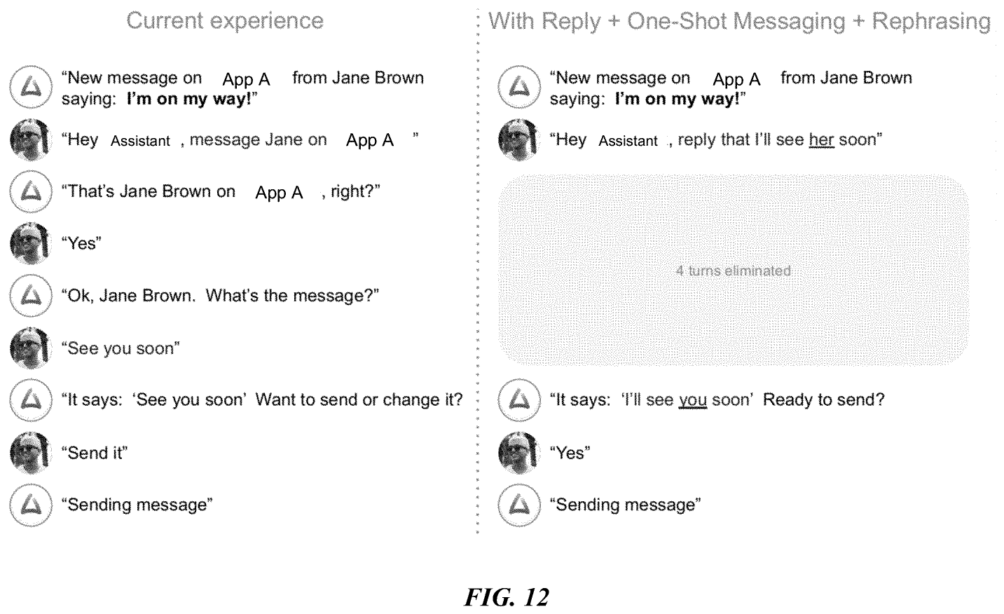

FIG. 12 illustrates an example comparison between current experience of conventional voice assistants and one-shot messaging with support for message replay and rephrasing. For current experience of conventional voice assistants, the voice assistant may say “new message on App A from Jane Brown saying: I'm on my way!” The user may then say “Hey assistant, message Jane on App A.” The voice assistant may then say “That's Jane Brown on App A, right?” The user may say “Yes.” The voice assistant may then say “Ok, Jane Brown. What's the message?” The user may say “See you soon.” The voice assistant may then say “It says: ‘See you soon’ Want to send or change it?” The user may say “Send it.” The voice assistant may then say “Sending message.” By contrast, for one-shot messaging with support for message replay and rephrasing, the assistant system 140 may say “New message on App A from Jane Brown saying: I'm on my way!” The user may then say “Hey assistant, reply that I'll see her soon.” Four turns may be then eliminated. The assistant system 140 may then say “It says: ‘I'll see you soon’ Ready to send?” The user may say “Yes.” The assistant system 140 may then say “Sending message.”

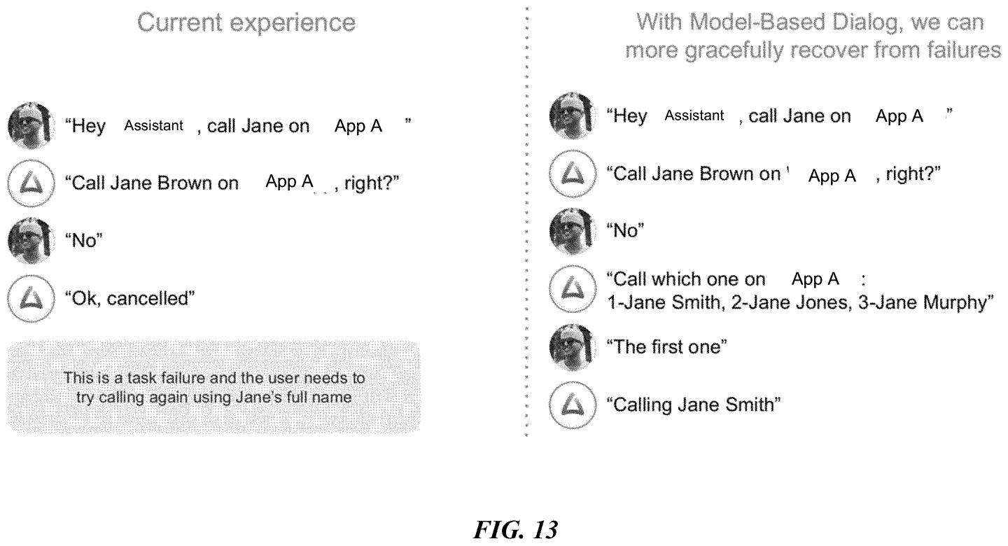

FIG. 13 illustrates an example comparison between current experience of conventional voice assistants and model-based dialog. For current experience of conventional voice assistants, the user may say “Hey assistant, call Jane on App A.” The voice assistant may then say “Call Jane Brown on App A, right?” The user may say “No.” The voice assistant may then say “Ok, cancelled.” By contrast, with model-based dialog, the user may say “Hey assistant, call Jane on App A.” The assistant system 140 may then say “Call Jane Brown on App A, right?” The user may say “No.” The assistant system 140 may then say “Call which one on App A: 1-Jane Smith, 2-Jane Jones, 3-Jane Murphy.” The user may say “The first one.” The assistant system 140 may then say “Calling Jane Smith.” As can be seen, with model-based dialog, the assistant system 140 may more gracefully recover from failures.

### Dynamic End-Pointing Using Domain Classifier

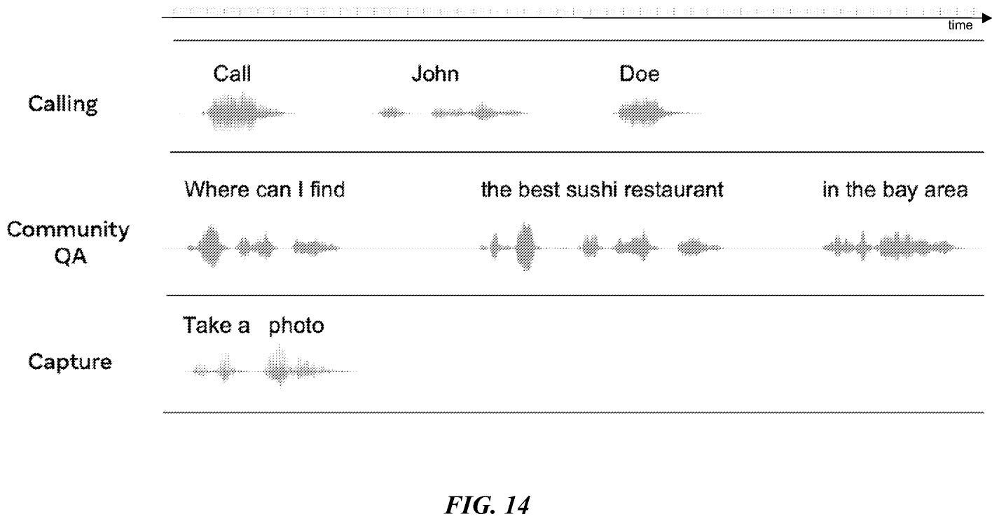

In particular embodiments, the assistant system 140 may perform dynamic end-pointing, which is a generalization of that technique to adjust the endpoint aggressiveness (i.e., shorter or longer) based on the partial decoded utterance for any domain. End-pointing may be defined as the process for determining the time point when a user finishes their voice input so the assistant system 140 may close the microphone and continue downstream processing. For dynamic end-pointing, the assistant system 140 may take an intermediate transcript based on partial audio input to predict the domain and dynamically adjusts the endpoint while audio is still being received. When adding more domains to various assistant surfaces, some domains may require aggressive end-pointing, while others may require conservative end-pointing. For example, capture domain may be considered an aggressive domain. Most utterances in this domain may be short commands like “Take a photo” and require a fast response from the system. Community question and answering (CQA) on the other hand may be considered a conservative domain. Utterances in this domain may comprise multiple sub-phrases, separated by long pauses. An example may be: “Where can I find <pause> the best sushi restaurant <pause> in the bay area.” Calling domain may fall somewhere between these two extremes. FIG. 14 illustrates an example comparison between different domains. As a result, if end-pointing is too short, the assistant system 140 may cut off a user mid-utterance. If end-pointing is too long, the user may be waiting for a response and get frustrated. The assistant system 140 therefore may adjust end-pointing aggressiveness based on the predicted domain of the utterance. In particular embodiments, the assistant system 140 may make use of a domain classifier to infer the domain the utterance falls under. During decoding, the assistant system 140 may have access to the partial transcript of the audio received so far. Every time the partial transcript is changed, the domain classifier may be queried to determine the domain. Based on the predicted domain, the assistant system 140 may dynamically update the end-pointing thresholds for the rest of the utterance. This may comprise static end-pointing thresholds, as well as neural end-pointing thresholds. The domain specific thresholds may be pre-tuned. Dynamic end-pointing may help the assistant system 140 achieve different early cut or latency goals for different domains, ensure natural and fast voice interaction, and minimize latency. Although this disclosure describes performing particular end-pointing by particular systems in a particular manner, this disclosure contemplates performing any suitable end-pointing by any suitable system in any suitable manner.

In conventional systems, speech end-pointing may be based on pure classification methods with hard-coded binary targets without much flexibility to be adjusted in a customized way. In the embodiments disclosed herein, the assistant system 140 may use a regression-based speech end-pointing strategy, which enables an end-pointer to better adjust its output sensitivity based on customized user queries. As an initial step, the assistant system 140 may determine the time point when a user finishes the query so that it knows when to close the microphone and continue downstream processing (e.g., language understanding and taking action). This process may be referred to as speech endpoint detection or end-pointing. In practice, the technical challenge for speech end-pointing may lie in the conflict goals of fast response to user queries and avoidance of early cuts of user speech. Specifically, a rapid close of the microphone and response to user queries may bring a better user experience, but this may inevitably increase the risk of early cutting the queries. The performance of end-pointing may be thus evaluated based on the extent to which this conflict is resolved in practical cases.

In particular embodiments, dynamic end-pointing may make use of a domain classifier to infer the domain the utterance falls under. During decoding, the end-pointer may have access to the partial transcript of the audio received so far. Every time the partial transcript is changed, the domain classifier may be queried to determine the domain. Based on the predicted domain, the assistant system 140 may dynamically update the end-pointing thresholds for the rest of the utterance. This may comprise static end-pointer thresholds, as well as neural end-pointer thresholds. The domain specific thresholds may be pre-tuned and configured as part of the model package.

Table 15 lists example adjustment of end-pointing thresholds based on predicted CQA domain. Table 16 lists example adjustment of end-pointing thresholds based on predicted capture domain. Note “ood” stands for “out of domain” and “cqa” stands for “community question answering”.

TABLE 15
Example adjustment of end-pointing thresholds based on predicted CQA domain.

| | | | | | | | | | | | | |
|---|---|---|---|---|---|---|---|---|---|---|---|---|
| Partial Utterance | Where | can | I | find | the | best | sushi | restaurant | in | the | bay | area |
| Predicted Domain | ood | location | help | cqa | cqa | cqa | cqa | cqa | cqa | cqa | cqa | cqa |
| End-pointing | 250 | 250 | 250 | 700 | 700 | 700 | 700 | 700 | 700 | 700 | 700 | 700 |
| Threshold (ms) | | | | | | | | | | | | |

TABLE 16
Example adjustment of end-pointing thresholds
based on predicted capture domain.

| | | | | | | | |
|---|---|---|---|---|---|---|---|
| Partial Utterance | Take | a | photo | using | the | front | camera |
| Predicted Domain | ood | ood | capture-short | ood | ood | ood | capture-long |
| End-pointing | 300 | 300 | 200 | 300 | 300 | 300 | 150 |
| Threshold (ms) | | | | | | | |

In particular embodiments, the assistant system 140 may use an intent end-pointer to have aggressive end-pointing on capture domain. It may be a separate end-pointer, in addition to the static and neural end-pointers. While it may help improve end-pointing latency for capture domain, it may not be used for reducing early cut in CQA. In other words, the intent end-pointer may only help to make the end-pointer more aggressive and may not make it more conservative.

Dynamic end-pointer, on the other hand, may be not an additional end-pointer. It may help alter the behavior of static and neural end-pointers. It may be more generalizable than intent end-pointer, since it may be made more aggressive as well as more conservative, depending on the predicted domain.

Dynamic end-pointing may require a domain classifier. A domain classifier may take a partial transcript as input and return a predicted domain. In particular embodiments, the assistant system 140 may plug in any domain classifier to use for dynamic end-pointing. As an example and not by way of limitation, the assistant system 140 may use an NLU model hosted on the a predictor service as a domain classifier. As another example and not by way of limitation, the assistant system 140 may use an in-memory domain classifier, with a predetermined list of utterances.

In particular embodiments, for capture, the assistant system 140 may classify the transcripts into one of three “domains”: capture-short, capture-long, and other. “Take a photo” may fall under capture-short, and “Take a photo with the front camera” may fall under capture-long. The end-pointer may be tuned to be mildly aggressive after capture-short, and more aggressive after capture-long. The reason for being only mildly aggressive after capture-short may be to prevent early-cuts in long-form capture phrases.+In particular embodiments, reducing early cut in community QA may require the assistant system 140 to continue listening during long pauses. In the example utterance above, the silence threshold was increased from 250 ms to 700 ms. This may lead to the increase in latency. The higher the latency the assistant system 140 is willing to tolerate, the lower early cut the assistant system 140 may achieve. For CQA, the embodiments disclosed herein reduced the early cut from 22% to 12% at the cost of 400 ms in latency. SPL P50 increased from 600 ms to 1000 ms. For smart watches, the embodiments disclosed herein were able to avoid the tradeoff and simultaneously improve both the early-cut and P50 latency. This was achieved with a combination of dynamic end-pointing and other end-pointer tuning.

In particular embodiments, the assistant system 140 may use dynamic end-pointing to reduce end-pointing latency for a variety of apps. For instance, a poker game application may be suitable for aggressive end-pointing. Most of the utterances in this application may be short commands related to poker actions. Low latency may be important for realistic poker playing. Given the nature of the domain, low latency may be also achievable by appropriate end-pointer tuning.

In particular embodiments, speech with disfluencies may be a domain that requires conservative end-pointing. With conventional end-pointing defaults, stuttering speech may have a high likelihood of being early cut. The assistant system 140 may improve it with dynamic end-pointing.

In particular embodiments, the assistant system 140 may control the model aggressiveness by a parameter of required trigger counts. This may be equivalent to number of frames of silence observed. In particular embodiments, the assistant system 140 may use “posterior slope” as a measure of aggressiveness. In particular embodiments, the assistant system 140 may have a combined model for domain prediction as well as endpoint prediction.

In particular embodiments, the assistant system 140 may use a speech end-pointing strategy based on a regression setting. Accordingly, an end-pointer may be optimized for soft-coded regression targets during training, and the training targets may be dynamically categorized by including expected pause information contained in the queries. Intuitively, speech end-pointing may be handled as binary classification, where the training targets may be formulated as hardcoded values of 0 and 1. At the prediction stage, a decision threshold may be applied to the model output of end-pointing confidence. In a regression setting, the overall pipeline may remain similar, except that the input training targets may be modified to be continuous float values from 0 to 1.

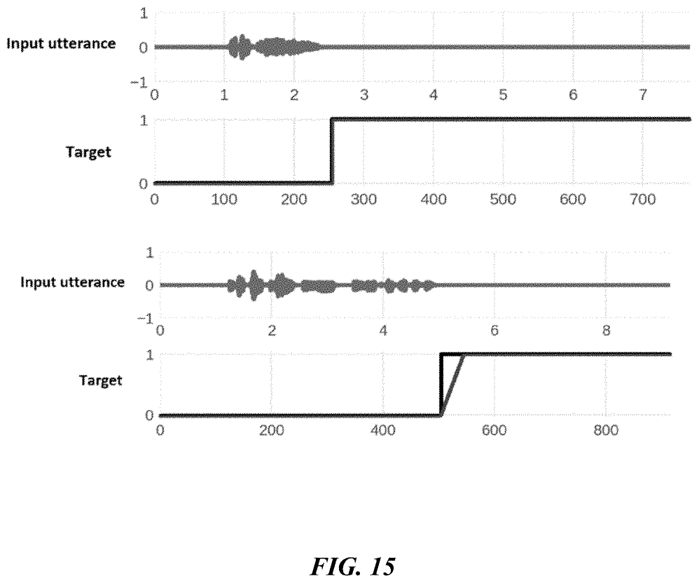

FIG. 15 illustrates example targets for end-pointer training based on hardcoded binary values and soft-coded float values. As indicated in FIG. 15, there may be an additional transition region between the user speech and the end of query. The motivation of the regression-based modeling may be that the expected model sensitivity for training targets may be adjusted based on the slope of the transition region. The top plot of FIG. 15 is an example where the training target of the regression model yields effectively the same aggression level as a classification target. At the bottom, the regression target enforces the model to be less aggressive, with a smoother slope at the transition region.

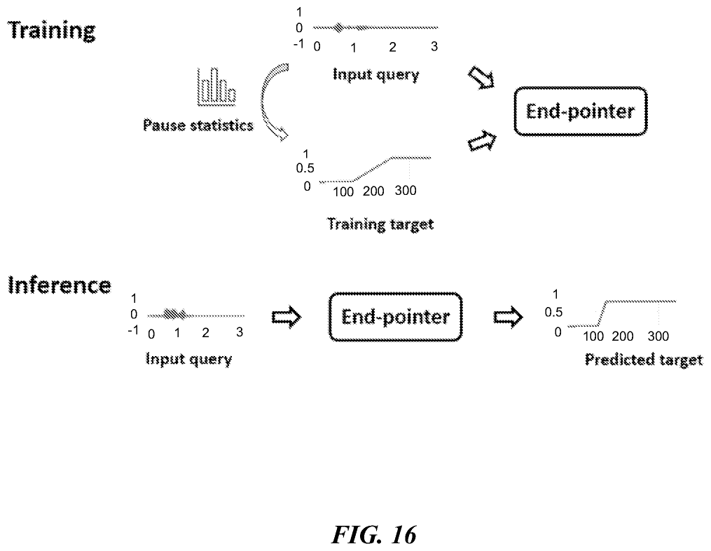

FIG. 16 illustrates an example overall pipeline of end-pointing with regression. To enable a dynamic output behavior of the end-pointer, the transition slope of the training targets may be quantified based on unique patterns (e.g., expected pause) of individual input queries. In particular embodiments, the assistant system 140 may use a method to compute and leverage the pause statistics of queries for this purpose. During inference, the end-pointer may only take as inputs original queries, and a decision threshold may be applied to the model outputs for end-pointing decision.

The embodiments disclosed herein compared the l1 (absolute error) and the l2 (squared error) loss for end-pointer training. The embodiments disclosed herein found that the l2 loss may yield a more stable model performance. The loss function is given as follows:

$$l = \frac{{\sum }_{i = 1}^{n} {( {y}_{t} - y )}^{2}}{n} \qquad ( 1 )$$

where l is the normalized l2 loss. yₜ and y are the training target and output of the end-pointer, respectively. The squared loss of the targets is normalized by the total number of queries n in a training batch.

To enable a dynamic adjustment of the training target, the assistant system 140 may use a method to integrate the expected pause information of the queries. The intuition may be that the ideal end-pointing sensitivity may be affected by the expected speech pause following a query, and the expected duration of pause following a query may be relevant to the semantic structure of its word transcription. For example, the chance that a user keeps speaking following an utterance “please” may be bigger than the chance following the utterance “please call (someone)”, since the latter may tend to be a complete query. Thus, it may be reasonable to adjust the transition slope of the training target to be smoother for the first utterance so that the end-pointer may learn to wait following “please”. The slope may be steeper for the second utterance so that the end-pointer may respond more quickly (aggressively) after the end of the query. Hence, the assistant system 140 may estimate the expected duration of the succeeding pause for each input query and apply this to adjust the training targets.

To enable a systematic modeling of the end-pause information, the assistant system 140 may categorize the complete word transcriptions of all possible queries in the training set and aggregate their succeeding pause statistics. Since the same word transcription may be shared by multiple queries and even as part of longer queries, the assistant system 140 may categorize the transcriptions based on prefix. In the embodiments disclosed herein, a word transcription may be defined as the prefix of a query if the complete transcription is covered at the beginning of the query in the same sequential word order. For example, the transcription “what is the weather” may be considered as a prefix of the queries “what is the weather”, “what is the weather in Seattle”, or “what is the weather today”. However, the transcription “what is the weather” may be not considered to be a prefix of the query “please tell me what is the weather”. In the setting of the embodiments disclosed herein, a single letter may also be a valid prefix as long as it meets the above definition. For example, the transcription “a” may be a prefix of the query “a car”. However, it may be not a prefix of the query “apple” because the word transcription of “apple” does not contain the word “a”. To reduce the computational complexity, our definition may require a strict match of transcriptions while determining prefixes. Hence, the utterances “what is the weather” and “what would be the weather” may be considered to be two independent utterances, though they are semantically similar. The pool of unique prefixes may then be obtained by looping over all queries in a training set.

While the total number of user queries may be significant in a user dataset, the pool of possible prefixes may be much smaller. The introduction of prefixes may also provide a natural categorization of user queries based on their semantic structures. For each query, the assistant system 140 may then check the associated prefix represented by its complete word transcription and examine the 95th percentile statistics of the succeeding pause duration for that prefix. This may be viewed as the expected succeeding pause of that query and be used to adjust its target. It is noted that during aggregation, the succeeding pause of end-of-query silence may be handled as 0, because it is technically not a “pause” in a query. Besides, the assistant system 140 may choose the 95th percentile statistics rather than the mean to reduce the risk of early cut.

In addition to the computed pause statistics, the assistant system 410 may also include a scaling factor by taking into account the user's actual speed of speech. To obtain this, the assistant system 140 may first aggregate all existing speech duration of a query based on its associated prefix and calculate the average for that prefix. Then, the relative duration of a query may be calculated by the division between the actual duration of that query and the average duration of the prefix. The complete formulation to compute the transition slope of the training targets is then as given follow:

$$\frac{1}{s} = \frac{{T}_{q}}{\overline{T}} \times μ \qquad ( 2 )$$

where s is the transition slope for individual training targets. T_{q} and T are the actual duration of an input query and the average duration of the corresponding prefix, respectively. μ is the expected pause in millisecond following the query.
Qualitative Data Analysis for Federated Analytics with Smart Keyboards

In particular embodiments, the assistant system 140 may curate a vocabulary for language models by incorporating differential privacy with multi-round training with removal of highest-frequency words in each round to allow effective training of next highest-frequency words. Based on determining why distribution of words/noise was bad in datasets with exponential frequency drop offs and understanding the problem of high-frequency words polluting low-frequency words because of all the noise generated by high-frequency words, the assistant system 140 may use a particular federated analytics mechanism/algorithm where one can get recall@10K=90%. Although this disclosure describes curating particular vocabularies by particular systems in a particular manner, this disclosure contemplates curating any suitable vocabulary by any suitable system in any suitable manner.

In particular embodiments, the assistant system 140 may use federated analytics to collect the most popular/frequent words to curate a vocabulary (word domain) for a language model for a smart keyboard (e.g., on a VR headset). However, the noise created by the differential privacy model on the client systems 130 may create much noise with respect to the highest-frequency words that low-frequency words cannot be differentiated from the noise. As such, one may want to know a metric by which the assistant system 140 can qualitatively define how accurate the ranking of words is for a given N top of words. One may also want to know if the current way of data collection can lead to bad data when curating the vocabulary for smart keyboard language models and if the assistant system 140 can utilize a mechanism/algorithm that can help curate high-quality vocabulary for the language models. In addition, the assistant system 140 may need to maintain the privacy promises made to users. In particular embodiments, the privacy promises may be measured quantitively by ε=5.0 and domain size (“bucket size”)=1000. Here, higher ε value may indicate that the model is truthful more often (less noise). Lower F value may indicate that the model is lying more often (more noise). The assistant system 140 may need to achieve the lowest ε value possible while still generating data that is useful/statistically significant. In particular embodiments, ε being as close as possible to 1 may be ideal.

For smart keyboard language models on VR headsets (and most other devices), the most popular 10K words typed by users may be most important. This may be because the language model on VR headsets may be in the order of about 6000 words and may be lower for lower powered devices (e.g., smart watches).

The embodiments disclosed herein may define a metric “recall@K” as a qualitative metric to evaluate the data collection mechanism. Since one may not look at the real-world data on a user device, the assistant system 140 may use some proxy dataset (or use a distribution collected once using federated analytics). Different federated analytics mechanisms may then be compared for this metric. For example, if there are two federated analytics mechanisms to collect the most frequent words for smart keyword language models on VR headsets, the assistant system 140 may choose the one with higher recall@10K words, for a proxy dataset.

The federated analytics mechanisms of collecting data used in conventional systems may be not robust. The recall@10K may be 60% for these federated analytics mechanisms. That means out of the 10000 top words that the federated analytics data collection may predict 6000 words are actually from the top 10000 words. The difference may be due to the added F noise. The problem may be further compounded as many (about 500) of these top words get discarded because of integrity issues. In a bad scenario one may end up with recall@6K of about 50%, meaning the language model vocabulary being curated may have only 3000 of the actual top 6000 words after some top words are removed because of integrity issues. This may impact the smart keyboard click-through-rate (CTR) negatively.

In particular embodiments, the assistant system 140 may use a particular federated analytics mechanism/algorithm where one may get recall@10K=90%. To begin with, the assistant system 140 may start with a large vocabulary list. The assistant system 140 may then run multiple rounds of data collection. For each round, the assistant system 140 may remove the top 1000 most frequent word collected from all previous rounds, collect data for a number of (e.g., 9) days (data taken from content objects an online social network), get the most frequent 1000 words from this round and add it to the global list of most frequent words, and stop when top N words have been collected.

In particular embodiments, collecting word frequencies using a single task may be noisy. Accordingly, the assistant system 140 may launch 3-5 independent tasks and then average the results across these tasks to get more reliable word frequencies (thereby raking). This behavior may be again due to ε=5.0 and bucket size=1000. The assistant system 140 may ensure that launching independent parallel data collection tasks do not reduce privacy budgets.

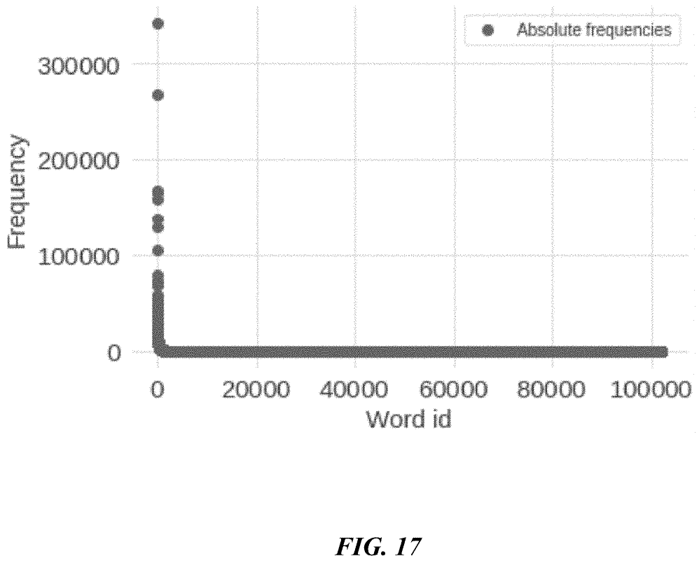

The embodiments disclosed herein performed several analyses. One analysis may be on the proxy dataset. The embodiments disclosed herein used a word frequency dataset collected by conventional federated analytics (collected for 21 days) as a proxy dataset for analysis. Even though the dataset itself has some noise baked into it because of differential privacy, it may be still a reliable reflection of what users may be typing when using VR headsets. FIG. 17 illustrates an example frequency distribution of the proxy dataset. It may be observed that head words (top 10 most frequent words) are almost outliers in this distribution. It may be also observed that the sum of frequency of top 10 words is larger than the sum of frequency of all the rest of the words combined.

Another analysis may be on preconditions. Another analysis may be on preconditions. For the analysis, ε is set to 5.0 and bucket size is set to 1000. Because of the randomized nature of differential privacy, all simulations are performed 5 times and then average is used to compute the results and analysis.

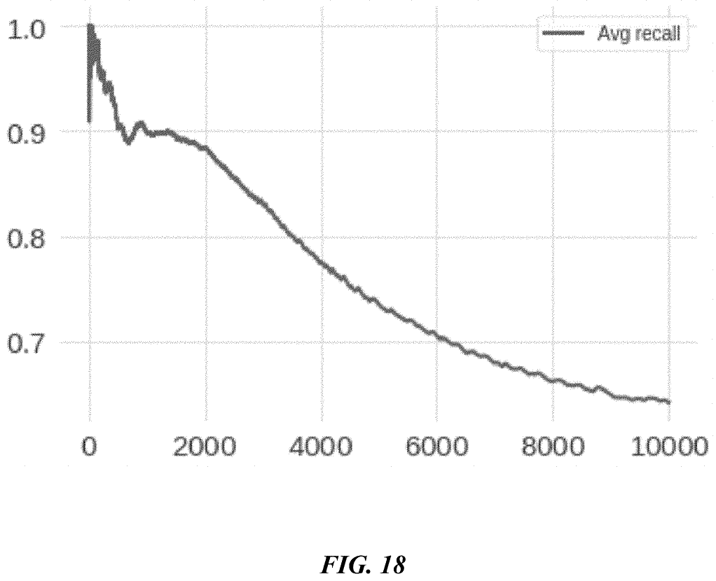

The embodiments disclosed herein further performed analysis on data collection using the federated analytics disclosed herein. FIG. 18 illustrates an example graph showing the Recall@10K for the federated analytics mechanism disclosed herein. Table 17 lists example recalls.

TABLE 17
Example recalls.

| | prod recall |
|---|---|
| recall@1000 | 0.970600 |
| recall@2000 | 0.942700 |
| recall@3000 | 0.884667 |
| recall@4000 | 0.812250 |
| recall@5000 | 0.752120 |
| recall@6000 | 0.707800 |
| recall@7000 | 0.675686 |
| recall@8000 | 0.647525 |
| recall@9000 | 0.626111 |
| recall@10000 | 0.607180 |

As can be seen, recall@3K onwards may see a dramatic decline. The problem it causes may be that in a bad scenario, one may end up with recall@6K of ˜50%, meaning the vocabulary of the language model being curated may have only 3000 of the actual top 6000 words after some top words are removed because of integrity issues. This may impact the smart keyboard CTR negatively.

The embodiments disclosed herein present the following hypothesis. The first hypothesis may be that a reason for drop in recall after Recall@3K may be because the high frequency words are adding more noise to other words. This may mean a dataset that has a very high dynamic range (few high frequency outlier words) in frequency may pollute the estimated frequency of lower frequency words. The second hypothesis may be that, given the privacy budget, it may be just not possible to determine with good accuracy frequency (thereby ranking) for words that have frequencies in 100s or 1000s.

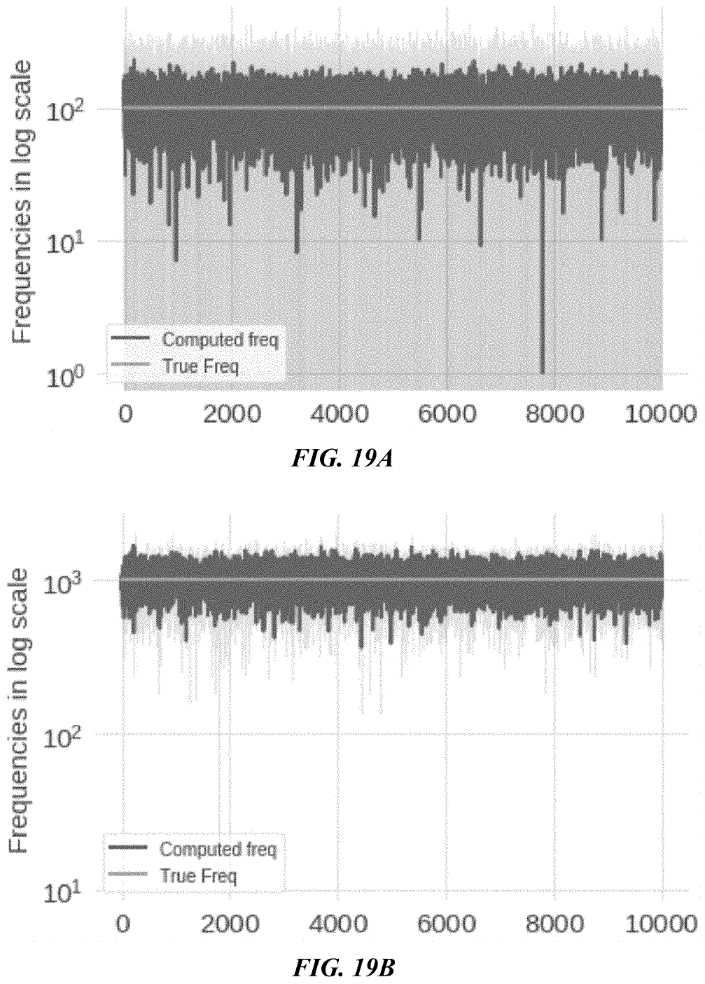

The embodiments disclosed herein performed the following hypothesis testing. To test the hypothesis, one may change the frequency distribution of the above dataset. Three scenarios were tried. In the first scenario, the embodiments disclosed herein assign all words a constant frequency of 100 and 1000 to see if one may know how noisy the federated analytics is when trying to collect word frequency with the privacy budget. One may not need to look at the recall metric in this case. This may be to understand if the second hypothesis is valid or not. FIGS. 19A-19B illustrate example graphs for hypothesis testing. FIG. 19A shows the federated analytics estimate of word frequencies when the frequency of all words is 100. FIG. 19B shows frequency estimates when frequencies of all words were set at 1000. Although the courts are noisy (because of differential privacy), they may be still within reasonable limits to determine the frequency of words in production.

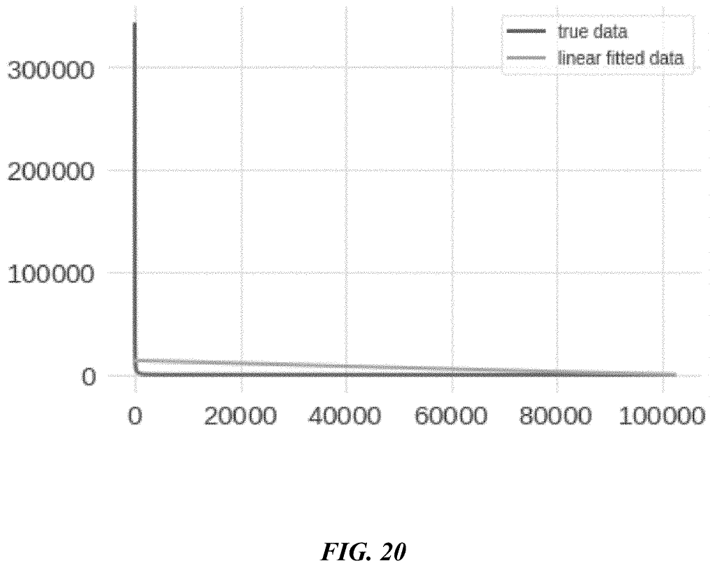

In the second scenario, instead of using the proxy data frequency distribution, the embodiments disclosed herein use a more linear data distribution to see how that impacts recall@10K. FIG. 20 illustrates example impact to recall@10K.

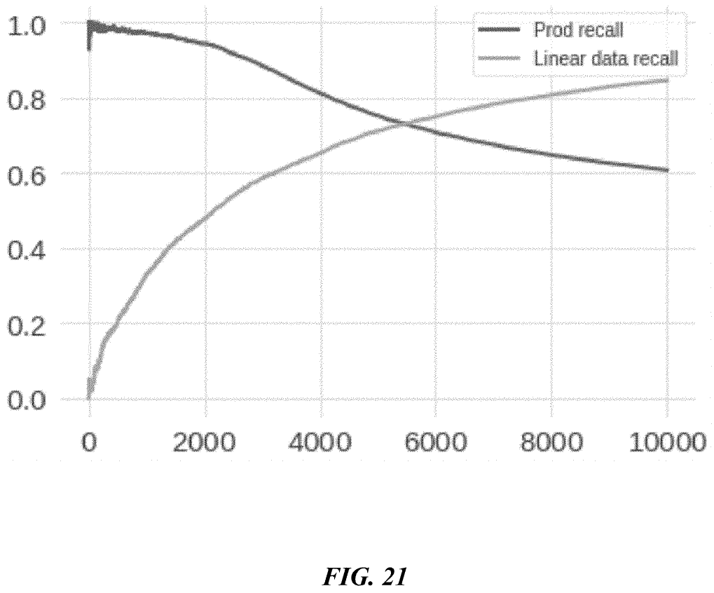

In the third scenario, the embodiments disclosed herein discarded the frequencies of the first 100 most frequent words and fitting a straight line. FIG. 21 illustrates an example graph regarding recall@10K for a linear data distribution. As can be seen from the graph, the light blue line which shows the recall@10K for the linear data distribution is about 20% higher. However, because the embodiments disclosed herein reduced the frequency of the top words, the recall@1K to recall@6K may have suffered quite a bit. But this may confirm that high frequency words contribute to a lot of noise for lower frequency words.

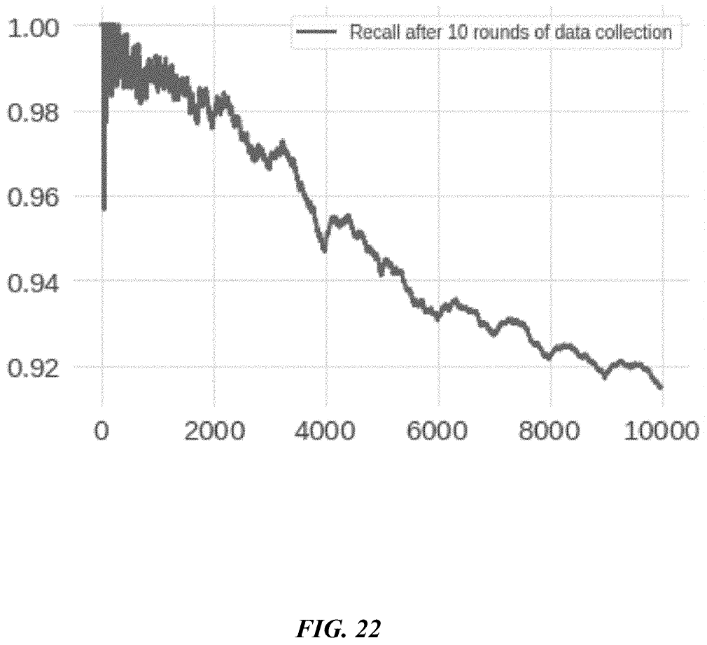

FIG. 22 illustrates example graphs showing recall@10K by running the iterative data collection mechanism disclosed herein for 10 rounds. Table 18 shows the recall@K comparison between the federated analytics mechanism disclosed herein and the conventional federated analytics mechanism.

TABLE 18
Recall@K comparison between the federated analytics mechanism
disclosed herein and the conventional federated analytics mechanism.

| | prod recall | multi round |
|---|---|---|
| recall@1000 | 0.970600 | 0.985000 |
| recall@2000 | 0.942700 | 0.976500 |
| recall@3000 | 0.884667 | 0.966333 |
| recall@4000 | 0.812250 | 0.947250 |
| recall@5000 | 0.752120 | 0.941200 |
| recall@6000 | 0.707800 | 0.930500 |
| recall@7000 | 0.675686 | 0.927143 |
| recall@8000 | 0.647525 | 0.921625 |
| recall@9000 | 0.626111 | 0.917111 |
| recall@10000 | 0.607180 | 0.915100 |

### Improving ASR Models Through Semi-Supervise Learning

In particular embodiments, the assistant system 140 may use a new semi-supervised learning framework for training ASR (automatic speech recognition) models, which takes three steps to ensure we select the most informative and clean transcriptions, and balances uncertainty and diversity during the data selection process. The first step may be “combine.” As a starting point, we may take a baseline model to generate a second view of the pseudo labels. Then we may use different ways to ensemble the outputs from the helper model and the base model. The second step may be “balance.” To further mine data that is more helpful (or informative) for model training, we may experiment with different confidence and combine them with various diversity metrics to balance uncertainty and diversity. The third step may be “lightweight supervision.” To address the issue about incorrect predictions from the confidence approach, we may design and implement a lightweight supervision approach. In particular, since the method designs an extremely lightweight supervision, it may take a low amount of effort from human annotators but may effectively resolve or mitigate the drawbacks of the purely automatic approach using only pseudo labels. Although this disclosure describes training particular models by particular systems in a particular manner, this disclosure contemplates training any suitable model by any suitable system in any suitable manner.

Conventionally, ASR models may be trained by speech data from the voice assistant domains and videos publicly shared by users, without any live traffic utterances. In order to boost the model accuracy, we may collect live traffic audios and generate pseudo labels with existing ASR models to augment the training datasets.

To begin with, the embodiments disclosed herein collected 16 million live traffic utterances. Pseudo-labels may be generated using existing ASR models, and the confidence score over the utterance (average over tokens) may be used here as an empirical metric for data selection. After the confidence thresholding (e.g., confidence score >0.95), 8 million out of the 16 million may be left. The live traffic audios annotated with pseudo labels may be used to fine tune the baseline model.

As mentioned above, conventional approaches may rely on confidence scores to infer the correctness of the pseudo labels (i.e., labels automatically generated by a machine-learning model). These approaches, although being intuitive and effective, may suffer from a severe drawback: it may include transcriptions where the models are confident but make mistakes. These errors, when included in the resulting data, may be amplified in the data selection process and exacerbate the model's existing deficiencies. The embodiments disclosed herein may solve this issue.

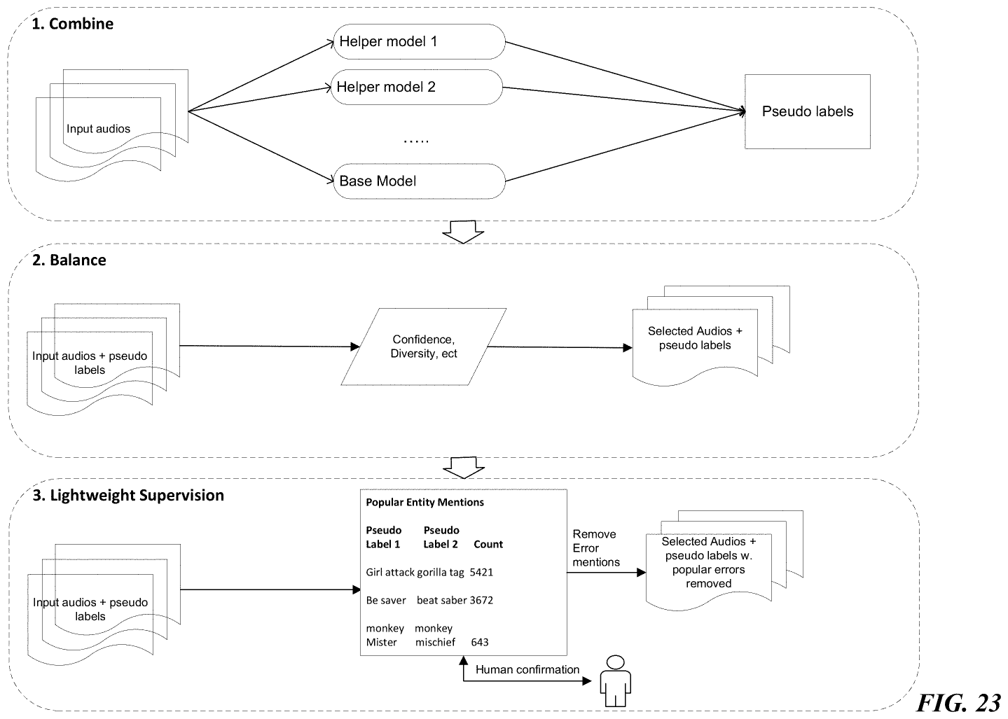

FIG. 23 illustrates an example workflow of using semi-supervised learning with lightweight supervision to improve ASR models. As illustrated in FIG. 23, the assistant system 140 may address or greatly mitigate the aforementioned issue through three main approaches. In the step of “combine”, as a starting point, we may take the base model to generate a second view of the pseudo labels. Then we may use different ways to ensemble the outputs from the helper model and the base model. For example, one way is confidence based, where we select the pseudo labels with higher confidence above a threshold. Another way is vote based, where we select examples when only the vote is above a threshold. This multi-view approach may improve the quality of the selected pseudo labels.

In the step of “balance,” to further mine the data that are more helpful (or informative) for model training, we may experiment with different confidence windows (e.g., lower: below 0.7, moderate: [0.3, 0.9], etc.), and combine them with various diversity metrics (such as token frequency, n-gram count, embeddings, etc.) to balance uncertainty and diversity. Here, the confidence windows may be picked based on heuristics due to the resource constraints. Diversity metrics such as token frequency and n-gram count may be applied to the transcriptions. This may allow the model to focus more on examples that can bring the most additional information.

Last, to address the issue mentioned above about incorrect predictions from the confidence approach, we may design and implement a super light-weight supervision approach. First, likely label errors may be identified by identifying pseudo labels where the models disagreed and where the pseudo labels do not match expected terms (e.g., intents/slot names). Then the highest-count mismatches may be selected and reviewed by a human reviewer. Only minimal human efforts (less than 15 minutes) and a very small dataset (approximately the top 50 examples) may be involved. Take the app name as an example, which is one of the most important use cases for on VR systems. This type of error may easily cause “catastrophic errors” for downstream processing. For instance, when the user tries to search an app, if an error happens in the stop words, downstream models may be able to recover and still fulfill the request. But when errors happen in the app name, the request may be likely to fail.

To address this problem, we may first select transcriptions containing app names, and aggregate the transcribed app names by frequency. From the frequency map, we may analyze approximately 50 most frequent app names, and identify about 20 top name errors. These top name errors may be used to exclude utterances contained in the 8-million live traffic utterances. For example, for “gorilla tag”, we may remove transcriptions with pseudo labels containing the error like “girl attach”. This simple approach may effectively help us identify the most important errors in popular application names for the VR system, which would be hard and expensive to find in the human annotation process, and can easily cause task failures when included in the resulting data. Note that these errors have over 50 k occurrences in the original 8 million dataset. Some example errors identified are listed below in Table 19.

TABLE 19
Example error mentions and correct transcriptions
identified from lightweight supervision.

| Error transcription | Correct transcription |
|---|---|
| vr chat | vrchat |
| super hot | superhot |
| girl attack | gorilla tag |
| be saver | beat saber |
| monkey mister | monkey mischief |

Beyond app names, we may also expand the coverage into other critical entities such as game category, genre, etc. This approach may be to show how we may use minimum effort to effectively address an important weakness from the semi-supervised approach.

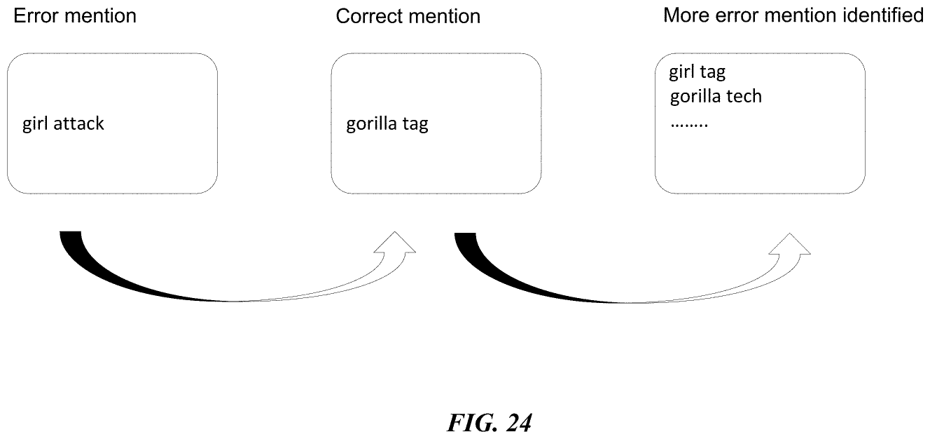

FIG. 24 illustrates an example process of expanding coverage of lightweight supervision. Three enhancements may be added to increase the benefit from the lightweight supervision. First, instead of removing the error mentions, we may correct them and include the correct transcription into the selected data. This step may potentially be more effective in correcting the existing errors in the target entity names. Then we may use the identified entity names as seeds, and then use them to find more errors mentioned from the pseudo labels. In particular embodiments, if we have a predefined list of entity names, such as app names in this case, we may use the predefined list to identify possible error mentions, and expand the coverage of the lightweight supervision. In particular embodiments, the error mention table may be cached and refreshed less frequently compared to the data to minimize the human efforts.

In addition to WER, Rare Recall Miss is a metric that is designed to consider deletion and substitution (recall) error for sentences containing any “rare word”. Here, “rare” may be defined as words not in the last 10% of the word frequency CDF (based on video data). It may amount to all words that are not one of the approximate 3000 most common words. And, since the metric is defined for the recall miss, lower values may be preferred.

In particular embodiments, we used four test sets to evaluate the trained RNN-T (recurrent neural network transducer) models. The first set may be referred as live_traffic_2022_01_02. The second set may be referred as live_traffic_2022_05_06. The third set may be referred as live_traffic_open. The fourth set may be referred as v16_voice_command. Among these test sets, the first two live traffic test sets are from the same source as that of the 16-million live traffic data, with no overlap guaranteed among our training and test sets on the utterance level. The live_traffic_open set is a small test set containing 366 utterances starting with the word “open”.

For RNN-T training, we may use the fine-tuning approach for model training. The seed model may be the baseline model trained. There may be no live traffic data in the training datasets for the seed model. The training datasets here may include supervised, unsupervised, video unsupervised, calling TTS, and different additional datasets, which in total comprises more than 1.8 million hours of audios.

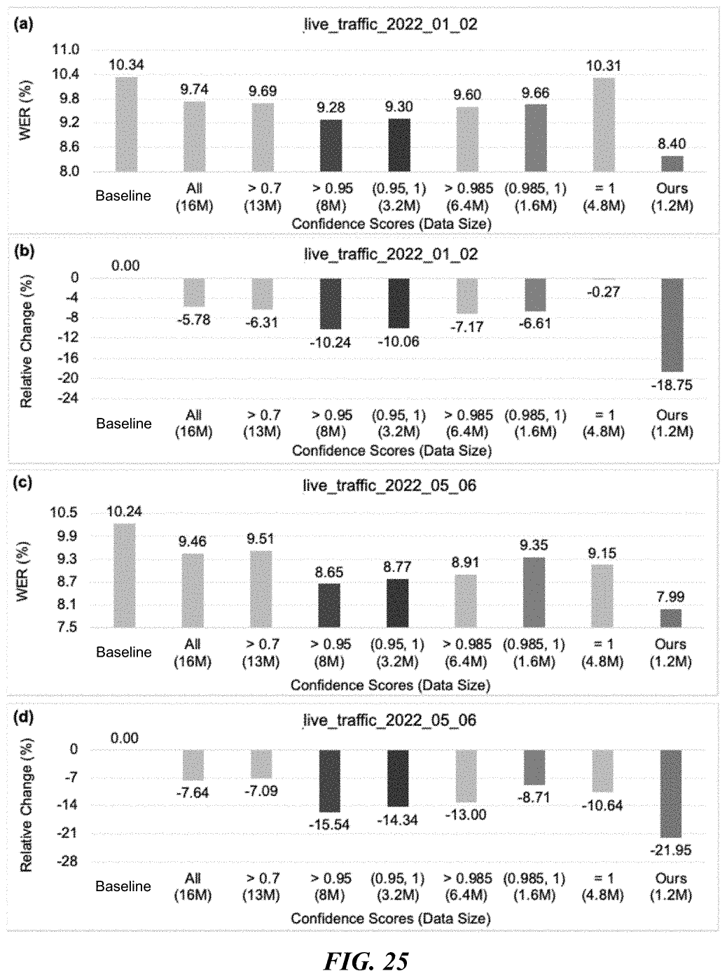

FIG. 25 illustrates example performances of different RNN-T models trained with live traffic data except the leftmost bar (the baseline model). We may have the following observations from FIG. 7. The best model that uses the confidence approach on live traffic is the purple bars, which achieves a relative improvement of 10.2-15.5% from the baseline model. As shown by the pink bars, we achieve 18.7-22% relative improvement from the baseline model. This improves relatively by 7.6-9.4% from the strong baseline (purple bars).

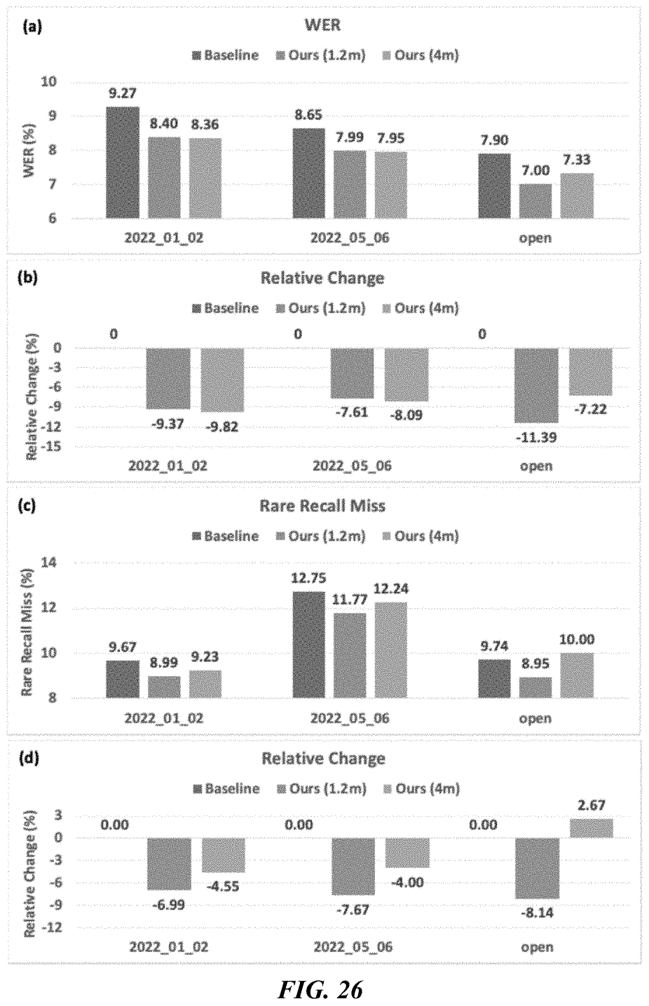

FIG. 26 illustrates example evaluations of ASR models trained with different sizes of data on three live traffic test sets. To investigate the effect of data size on the model training, we experiment with 2 sizes of data: 1.2 million and 4 million. In particular embodiments, we may select the 1.2 million examples through tri-training and supervision from a super tiny set with only about 50 examples from the 8-million live traffic data using label error detection and overwrite. More information on label error detection and overwrite may be found in U.S. Patent Application No. 63/381,211, filed 27 Oct. 2022, which is incorporated by reference. These examples may contain frequent errors that occur in the most popular apps, and may be likely to cause task failures in search and voice command requests for the head use cases. The results are shown in FIG. 26. Models may be built by fine tuning the baseline model with live traffic utterances. These utterances are selected from the 8-million dataset by our method. FIG. 26(a) shows the absolute WER. FIG. 26(b) shows the relative WER change from the baseline (the blue bar in a). FIG. 26(c) shows the absolute Rare Recall Miss. FIG. 26(d) shows the relative change from the baseline. The baseline mode in this work is the model using all the 8-million live traffic utterances for fine tuning. The sizes of the datasets are indicated in the parentheses in the legend. Tables 20-21 show more results for all test sets from the data size experiments.

TABLE 20
Results for all test sets from the data size experiments using WER metric.

| | WER (%) | | | | |
|---|---|---|---|---|---|
| | | 1.2 m | | 4 m | |
| Test Set | Strong Baseline | Ours | Relative Change* | Ours | Relative Change |
| live_traffic_2022_01_02 | 9.27 | 8.40 | −9.37 | 8.36 | −9.82 |
| live_traffic_2022_05_06 | 8.65 | 7.99 | −7.61 | 7.95 | −8.09 |
| live_traffic_open | 7.90 | 7.00 | −11.39 | 7.33 | −7.22 |
| v16_voice_command | 8.83 | 8.45 | −4.30 | 8.57 | −2.94 |

*Relative change with respect to the strong baseline.

TABLE 21
Results for all test sets from the data size experiments using Rare Recall Miss metric.

| | Rare Recall Miss (%) | | | | |
|---|---|---|---|---|---|
| | | 1.2 m | | 4 m | |
| Test Set | Strong Baseline | Ours | Relative Change* | Ours | Relative Change |
| live_traffic_2022_01_02 | 9.67 | 8.99 | −6.99 | 9.23 | −4.55 |
| live_traffic_2022_05_06 | 12.75 | 11.77 | −7.67 | 12.24 | −4.00 |
| live_traffic_open | 9.74 | 8.95 | −8.14 | 10.00 | 2.67 |
| v16_voice_command | 13.39 | 11.94 | −10.85 | 13.31 | −0.60 |

*Relative change with respect to the strong baseline results for all test sets from the light supervision experiments (data size: 1.2 million).

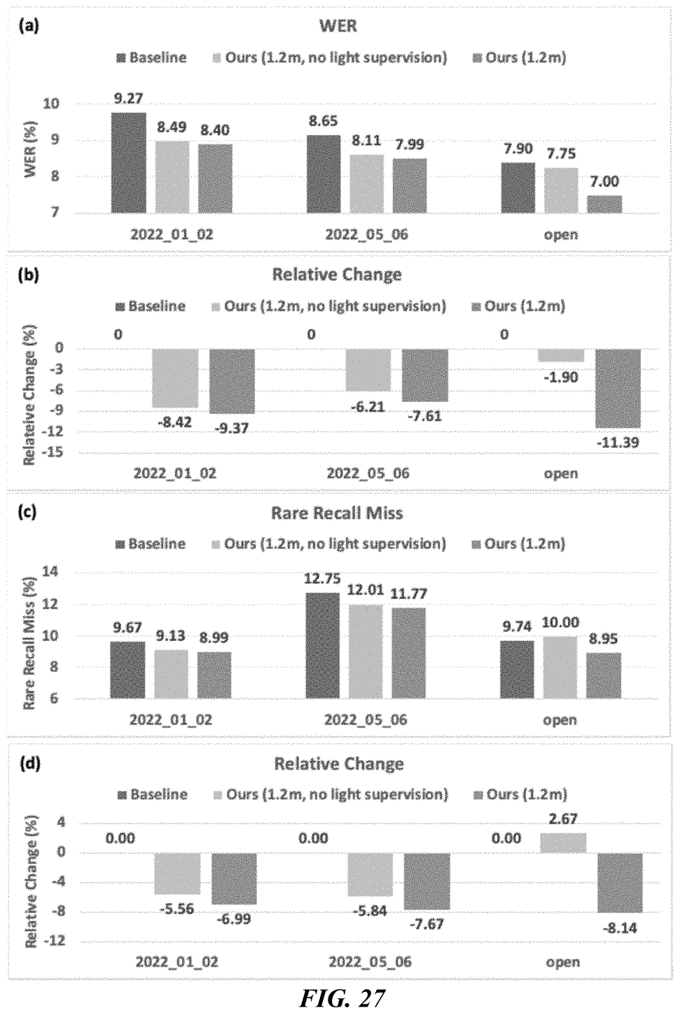

FIG. 27 illustrates example evaluations of ASR models trained on light-weight supervision on three live traffic test sets. To understand the impact from the light-weight supervision, we also conduct an experiment without this human intervention. Results are shown in FIG. 27. FIG. 27(a) shows the absolute WER. FIG. 27(b) shows the relative WER change from the baseline (the blue bar in a). FIG. 27(c) shows the absolute Rare Recall Miss. FIG. 27(d) shows the relative change from the baseline. The baseline mode in this work is the model using all the 8-million live traffic utterances for fine tuning. The model without light supervision is shown in the yellow bar.

We may have the following observations and insights from FIG. 27. Without the lightweight supervision, our approach has been able to achieve significant relative improvement from the baseline model, e.g., 6.2-8.4% by WER and 5.6-5.8% by the rare recall miss for the first two test sets. However, this is not the case for the live_traffic_open test set, which achieves no significant gains. With the lightweight supervision, we see marginal additional gains in the first two test sets. However, for the live_traffic_open set, the light-weight supervision results in a substantial model improvement. Comparing models from datasets without and with supervision, the relative improvement by WER and rare recall miss from the baseline model increases from −1.90% to −11.39%, and 2.67% to −8.14%, by WER and Rare Recall Miss, respectively. As mentioned above, the live_traffic_open test set contains utterances starting with the word “open”. Those utterances have a high probability to contain app names or rare words. Therefore, the effect from the super light-weight supervision is more effective and expected. The improvement from light-weight supervision on both metrics from almost all the test sets are consistent across different models with light-weight supervision compared to those without.

Tables 22-23 show more results for all test sets from the lightweight supervision experiments.

TABLE 22
Results for all test sets from the lightweight supervision experiments using WER metric.

| | WER (%) | | | | |
|---|---|---|---|---|---|
| | | No Light Supervision | | With Light Supervision | |
| Test Set | Strong Baseline | New | Relative Change* | New | Relative Change |
| live_traffic_2022_01_02 | 9.27 | 8.49 | −8.42 | 8.40 | −9.37 |
| live_traffic_2022_05_06 | 8.65 | 8.11 | −6.21 | 7.99 | −7.61 |
| live_traffic_open | 7.90 | 7.75 | −1.90 | 7.00 | 11.39 |
| v16_voice_command | 8.83 | 8.89 | 0.64 | 8.45 | −4.30 |

*Relative change with respect to the strong baseline.

TABLE 23
Results for all test sets from the lightweight supervision
experiments using Rare Recall Miss metric.

| | Rare Recall Miss (%) | | | | |
|---|---|---|---|---|---|
| | | No Light Supervision | | With Light Supervision | |
| Test Set | Strong Baseline | New | Relative Change* | New | Relative Change |
| live_traffic_2022_01_02 | 9.67 | 9.13 | −5.56 | 8.99 | −6.99 |
| live_traffic_2022_05_06 | 12.75 | 12.01 | −5.84 | 11.77 | −7.67 |
| live_traffic_open | 9.74 | 10.00 | 2.67 | 8.95 | −8.14 |
| v16_voice_command | 13.39 | 13.39 | 0.00 | 11.94 | −10.85 |

*Relative change with respect to the strong baseline.

### Vector Spaces and Embeddings

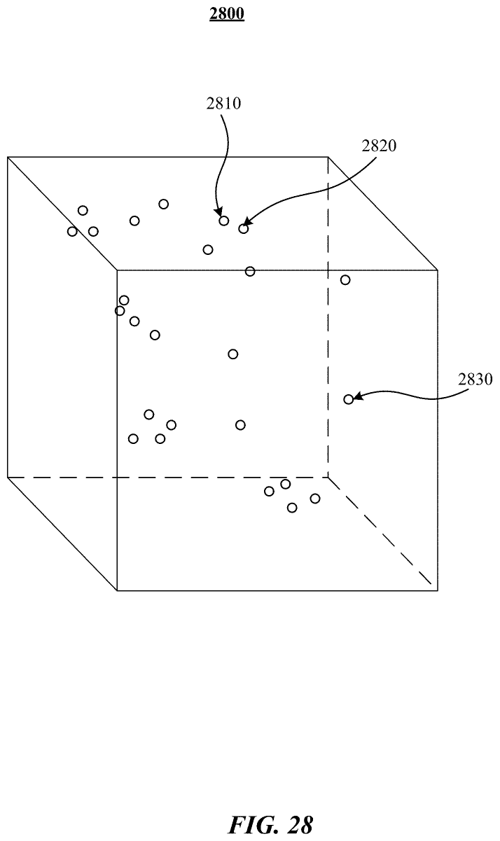

FIG. 28 illustrates an example view of a vector space 2800. In particular embodiments, an object or an n-gram may be represented in a d-dimensional vector space, where d denotes any suitable number of dimensions. Although the vector space 2800 is illustrated as a three-dimensional space, this is for illustrative purposes only, as the vector space 2800 may be of any suitable dimension. In particular embodiments, an n-gram may be represented in the vector space 2800 as a vector referred to as a term embedding. Each vector may comprise coordinates corresponding to a particular point in the vector space 2800 (i.e., the terminal point of the vector). As an example and not by way of limitation, vectors 2810, 2820, and 2830 may be represented as points in the vector space 2800, as illustrated in FIG. 28. An n-gram may be mapped to a respective vector representation. As an example and not by way of limitation, n-grams t₁ and t₂ may be mapped to vectors [symbol] and [symbol] in the vector space 2800, respectively by applying a function [symbol] defined by a dictionary, such that [symbol] = [symbol] (t₁) and [symbol] = [symbol] (t₂). As another example and not by way of limitation, a dictionary trained to map text to a vector representation may be utilized, or such a dictionary may be itself generated via training. As another example and not by way of limitation, a word-embeddings model may be used to map an n-gram to a vector representation in the vector space 2800. In particular embodiments, an n-gram may be mapped to a vector representation in the vector space 2800 by using a machine leaning model (e.g., a neural network). The machine learning model may have been trained using a sequence of training data (e.g., a corpus of objects each comprising n-grams).

In particular embodiments, an object may be represented in the vector space 2800 as a vector referred to as a feature vector or an object embedding. As an example and not by way of limitation, objects e₁ and e₂ may be mapped to vectors [symbol] and [symbol] in the vector space 2800, respectively, by applying a function [symbol] , such that [symbol] = [symbol] (e₁) and [symbol] = [symbol] (e₂). In particular embodiments, an object may be mapped to a vector based on one or more properties, attributes, or features of the object, relationships of the object with other objects, or any other suitable information associated with the object. As an example and not by way of limitation, a function [symbol] may map objects to vectors by feature extraction, which may start from an initial set of measured data and build derived values (e.g., features). As an example and not by way of limitation, an object comprising a video or an image may be mapped to a vector by using an algorithm to detect or isolate various desired portions or shapes of the object. Features used to calculate the vector may be based on information obtained from edge detection, corner detection, blob detection, ridge detection, scale-invariant feature transformation, edge direction, changing intensity, autocorrelation, motion detection, optical flow, thresholding, blob extraction, template matching, Hough transformation (e.g., lines, circles, ellipses, arbitrary shapes), or any other suitable information. As another example and not by way of limitation, an object comprising audio data may be mapped to a vector based on features such as a spectral slope, a tonality coefficient, an audio spectrum centroid, an audio spectrum envelope, a Mel-frequency cepstrum, or any other suitable information. In particular embodiments, when an object has data that is either too large to be efficiently processed or comprises redundant data, a function [symbol] may map the object to a vector using a transformed reduced set of features (e.g., feature selection). In particular embodiments, a function [symbol] may map an object e to a vector [symbol] (e) based on one or more n-grams associated with object e. Although this disclosure describes representing an n-gram or an object in a vector space in a particular manner, this disclosure contemplates representing an n-gram or an object in a vector space in any suitable manner.

In particular embodiments, the social-networking system 160 may calculate a similarity metric of vectors in vector space 2800. A similarity metric may be a cosine similarity, a Minkowski distance, a Mahalanobis distance, a Jaccard similarity coefficient, or any suitable similarity metric. As an example and not by way of limitation, a similarity metric of [symbol] and [symbol] may be a cosine similarity

$$\frac{\vec{{v}_{1}} \cdot \vec{{v}_{2}}}{‖ \vec{{v}_{1}} ‖ ‖ \vec{{v}_{2}} ‖} .$$

As another example and not by way of limitation, a similarity metric of [symbol] and [symbol] may be a Euclidean distance ∥ [symbol] − [symbol] ∥. A similarity metric of two vectors may represent how similar the two objects or n-grams corresponding to the two vectors, respectively, are to one another, as measured by the distance between the two vectors in the vector space 2800. As an example and not by way of limitation, vector 2810 and vector 2820 may correspond to objects that are more similar to one another than the objects corresponding to vector 2810 and vector 2830, based on the distance between the respective vectors. Although this disclosure describes calculating a similarity metric between vectors in a particular manner, this disclosure contemplates calculating a similarity metric between vectors in any suitable manner.

More information on vector spaces, embeddings, feature vectors, and similarity metrics may be found in U.S. patent application Ser. No. 14/949,436, filed 23 Nov. 2015, U.S. patent application Ser. No. 15/286,315, filed 5 Oct. 2016, and U.S. patent application Ser. No. 15/365,789, filed 30 Nov. 2016, each of which is incorporated by reference.

### Privacy

In particular embodiments, one or more objects (e.g., content or other types of objects) of a computing system may be associated with one or more privacy settings. The one or more objects may be stored on or otherwise associated with any suitable computing system or application, such as, for example, a social-networking system 160, a client system 130, an assistant system 140, a third-party system 170, a social-networking application, an assistant application, a messaging application, a photo-sharing application, or any other suitable computing system or application. Although the examples discussed herein are in the context of an online social network, these privacy settings may be applied to any other suitable computing system. Privacy settings (or “access settings”) for an object may be stored in any suitable manner, such as, for example, in association with the object, in an index on an authorization server, in another suitable manner, or any suitable combination thereof. A privacy setting for an object may specify how the object (or particular information associated with the object) can be accessed, stored, or otherwise used (e.g., viewed, shared, modified, copied, executed, surfaced, or identified) within the online social network. When privacy settings for an object allow a particular user or other entity to access that object, the object may be described as being “visible” with respect to that user or other entity. As an example and not by way of limitation, a user of the online social network may specify privacy settings for a user-profile page that identify a set of users that may access work-experience information on the user-profile page, thus excluding other users from accessing that information.

In particular embodiments, privacy settings for an object may specify a “blocked list” of users or other entities that should not be allowed to access certain information associated with the object. In particular embodiments, the blocked list may include third-party entities. The blocked list may specify one or more users or entities for which an object is not visible. As an example and not by way of limitation, a user may specify a set of users who may not access photo albums associated with the user, thus excluding those users from accessing the photo albums (while also possibly allowing certain users not within the specified set of users to access the photo albums). In particular embodiments, privacy settings may be associated with particular social-graph elements. Privacy settings of a social-graph element, such as a node or an edge, may specify how the social-graph element, information associated with the social-graph element, or objects associated with the social-graph element can be accessed using the online social network. As an example and not by way of limitation, a particular photo may have a privacy setting specifying that the photo may be accessed only by users tagged in the photo and friends of the users tagged in the photo. In particular embodiments, privacy settings may allow users to opt in to or opt out of having their content, information, or actions stored/logged by the social-networking system 160 or assistant system 140 or shared with other systems (e.g., a third-party system 170). Although this disclosure describes using particular privacy settings in a particular manner, this disclosure contemplates using any suitable privacy settings in any suitable manner.

In particular embodiments, the social-networking system 160 may present a “privacy wizard” (e.g., within a webpage, a module, one or more dialog boxes, or any other suitable interface) to the first user to assist the first user in specifying one or more privacy settings. The privacy wizard may display instructions, suitable privacy-related information, current privacy settings, one or more input fields for accepting one or more inputs from the first user specifying a change or confirmation of privacy settings, or any suitable combination thereof. In particular embodiments, the social-networking system 160 may offer a “dashboard” functionality to the first user that may display, to the first user, current privacy settings of the first user. The dashboard functionality may be displayed to the first user at any appropriate time (e.g., following an input from the first user summoning the dashboard functionality, following the occurrence of a particular event or trigger action). The dashboard functionality may allow the first user to modify one or more of the first user's current privacy settings at any time, in any suitable manner (e.g., redirecting the first user to the privacy wizard).

Privacy settings associated with an object may specify any suitable granularity of permitted access or denial of access. As an example and not by way of limitation, access or denial of access may be specified for particular users (e.g., only me, my roommates, my boss), users within a particular degree-of-separation (e.g., friends, friends-of-friends), user groups (e.g., the gaming club, my family), user networks (e.g., employees of particular employers, students or alumni of particular university), all users (“public”), no users (“private”), users of third-party systems 170, particular applications (e.g., third-party applications, external websites), other suitable entities, or any suitable combination thereof. Although this disclosure describes particular granularities of permitted access or denial of access, this disclosure contemplates any suitable granularities of permitted access or denial of access.

In particular embodiments, one or more servers 162 may be authorization/privacy servers for enforcing privacy settings. In response to a request from a user (or other entity) for a particular object stored in a data store 164, the social-networking system 160 may send a request to the data store 164 for the object. The request may identify the user associated with the request and the object may be sent only to the user (or a client system 130 of the user) if the authorization server determines that the user is authorized to access the object based on the privacy settings associated with the object. If the requesting user is not authorized to access the object, the authorization server may prevent the requested object from being retrieved from the data store 164 or may prevent the requested object from being sent to the user. In the search-query context, an object may be provided as a search result only if the querying user is authorized to access the object, e.g., if the privacy settings for the object allow it to be surfaced to, discovered by, or otherwise visible to the querying user. In particular embodiments, an object may represent content that is visible to a user through a newsfeed of the user. As an example and not by way of limitation, one or more objects may be visible to a user's “Trending” page. In particular embodiments, an object may correspond to a particular user. The object may be content associated with the particular user, or may be the particular user's account or information stored on the social-networking system 160, or other computing system. As an example and not by way of limitation, a first user may view one or more second users of an online social network through a “People You May Know” function of the online social network, or by viewing a list of friends of the first user. As an example and not by way of limitation, a first user may specify that they do not wish to see objects associated with a particular second user in their newsfeed or friends list. If the privacy settings for the object do not allow it to be surfaced to, discovered by, or visible to the user, the object may be excluded from the search results. Although this disclosure describes enforcing privacy settings in a particular manner, this disclosure contemplates enforcing privacy settings in any suitable manner.

In particular embodiments, different objects of the same type associated with a user may have different privacy settings. Different types of objects associated with a user may have different types of privacy settings. As an example and not by way of limitation, a first user may specify that the first user's status updates are public, but any images shared by the first user are visible only to the first user's friends on the online social network. As another example and not by way of limitation, a user may specify different privacy settings for different types of entities, such as individual users, friends-of-friends, followers, user groups, or corporate entities. As another example and not by way of limitation, a first user may specify a group of users that may view videos posted by the first user, while keeping the videos from being visible to the first user's employer. In particular embodiments, different privacy settings may be provided for different user groups or user demographics. As an example and not by way of limitation, a first user may specify that other users who attend the same university as the first user may view the first user's pictures, but that other users who are family members of the first user may not view those same pictures.

In particular embodiments, the social-networking system 160 may provide one or more default privacy settings for each object of a particular object-type. A privacy setting for an object that is set to a default may be changed by a user associated with that object. As an example and not by way of limitation, all images posted by a first user may have a default privacy setting of being visible only to friends of the first user and, for a particular image, the first user may change the privacy setting for the image to be visible to friends and friends-of-friends.

In particular embodiments, privacy settings may allow a first user to specify (e.g., by opting out, by not opting in) whether the social-networking system 160 or assistant system 140 may receive, collect, log, or store particular objects or information associated with the user for any purpose. In particular embodiments, privacy settings may allow the first user to specify whether particular applications or processes may access, store, or use particular objects or information associated with the user. The privacy settings may allow the first user to opt in or opt out of having objects or information accessed, stored, or used by specific applications or processes. The social-networking system 160 or assistant system 140 may access such information in order to provide a particular function or service to the first user, without the social-networking system 160 or assistant system 140 having access to that information for any other purposes. Before accessing, storing, or using such objects or information, the social-networking system 160 or assistant system 140 may prompt the user to provide privacy settings specifying which applications or processes, if any, may access, store, or use the object or information prior to allowing any such action. As an example and not by way of limitation, a first user may transmit a message to a second user via an application related to the online social network (e.g., a messaging app), and may specify privacy settings that such messages should not be stored by the social-networking system 160 or assistant system 140.

In particular embodiments, a user may specify whether particular types of objects or information associated with the first user may be accessed, stored, or used by the social-networking system 160 or assistant system 140. As an example and not by way of limitation, the first user may specify that images sent by the first user through the social-networking system 160 or assistant system 140 may not be stored by the social-networking system 160 or assistant system 140. As another example and not by way of limitation, a first user may specify that messages sent from the first user to a particular second user may not be stored by the social-networking system 160 or assistant system 140. As yet another example and not by way of limitation, a first user may specify that all objects sent via a particular application may be saved by the social-networking system 160 or assistant system 140.

In particular embodiments, privacy settings may allow a first user to specify whether particular objects or information associated with the first user may be accessed from particular client systems 130 or third-party systems 170. The privacy settings may allow the first user to opt in or opt out of having objects or information accessed from a particular device (e.g., the phone book on a user's smart phone), from a particular application (e.g., a messaging app), or from a particular system (e.g., an email server). The social-networking system 160 or assistant system 140 may provide default privacy settings with respect to each device, system, or application, and/or the first user may be prompted to specify a particular privacy setting for each context. As an example and not by way of limitation, the first user may utilize a location-services feature of the social-networking system 160 or assistant system 140 to provide recommendations for restaurants or other places in proximity to the user. The first user's default privacy settings may specify that the social-networking system 160 or assistant system 140 may use location information provided from a client system 130 of the first user to provide the location-based services, but that the social-networking system 160 or assistant system 140 may not store the location information of the first user or provide it to any third-party system 170. The first user may then update the privacy settings to allow location information to be used by a third-party image-sharing application in order to geo-tag photos.

In particular embodiments, privacy settings may allow a user to specify one or more geographic locations from which objects can be accessed. Access or denial of access to the objects may depend on the geographic location of a user who is attempting to access the objects. As an example and not by way of limitation, a user may share an object and specify that only users in the same city may access or view the object. As another example and not by way of limitation, a first user may share an object and specify that the object is visible to second users only while the first user is in a particular location. If the first user leaves the particular location, the object may no longer be visible to the second users. As another example and not by way of limitation, a first user may specify that an object is visible only to second users within a threshold distance from the first user. If the first user subsequently changes location, the original second users with access to the object may lose access, while a new group of second users may gain access as they come within the threshold distance of the first user.

In particular embodiments, the social-networking system 160 or assistant system 140 may have functionalities that may use, as inputs, personal or biometric information of a user for user-authentication or experience-personalization purposes. A user may opt to make use of these functionalities to enhance their experience on the online social network. As an example and not by way of limitation, a user may provide personal or biometric information to the social-networking system 160 or assistant system 140. The user's privacy settings may specify that such information may be used only for particular processes, such as authentication, and further specify that such information may not be shared with any third-party system 170 or used for other processes or applications associated with the social-networking system 160 or assistant system 140. As another example and not by way of limitation, the social-networking system 160 may provide a functionality for a user to provide voice-print recordings to the online social network. As an example and not by way of limitation, if a user wishes to utilize this function of the online social network, the user may provide a voice recording of his or her own voice to provide a status update on the online social network. The recording of the voice-input may be compared to a voice print of the user to determine what words were spoken by the user. The user's privacy setting may specify that such voice recording may be used only for voice-input purposes (e.g., to authenticate the user, to send voice messages, to improve voice recognition in order to use voice-operated features of the online social network), and further specify that such voice recording may not be shared with any third-party system 170 or used by other processes or applications associated with the social-networking system 160.

### Systems and Methods

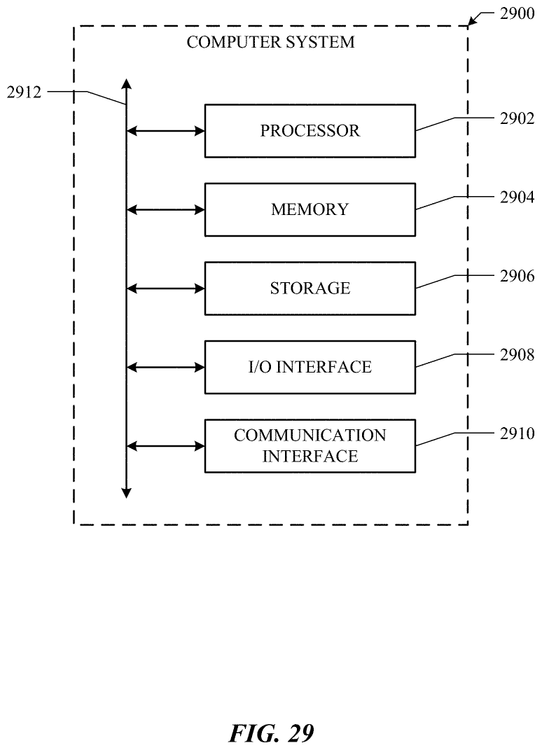

FIG. 29 illustrates an example computer system 2900. In particular embodiments, one or more computer systems 2900 perform one or more steps of one or more methods described or illustrated herein. In particular embodiments, one or more computer systems 2900 provide functionality described or illustrated herein. In particular embodiments, software running on one or more computer systems 2900 performs one or more steps of one or more methods described or illustrated herein or provides functionality described or illustrated herein. Particular embodiments include one or more portions of one or more computer systems 2900. Herein, reference to a computer system may encompass a computing device, and vice versa, where appropriate. Moreover, reference to a computer system may encompass one or more computer systems, where appropriate.

This disclosure contemplates any suitable number of computer systems 2900. This disclosure contemplates computer system 2900 taking any suitable physical form. As example and not by way of limitation, computer system 2900 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 2900 may include one or more computer systems 2900; be unitary or distributed; span multiple locations; span multiple machines; span multiple data centers; or reside in a cloud, which may include one or more cloud components in one or more networks. Where appropriate, one or more computer systems 2900 may perform without substantial spatial or temporal limitation one or more steps of one or more methods described or illustrated herein. As an example and not by way of limitation, one or more computer systems 2900 may perform in real time or in batch mode one or more steps of one or more methods described or illustrated herein. One or more computer systems 2900 may perform at different times or at different locations one or more steps of one or more methods described or illustrated herein, where appropriate.

In particular embodiments, computer system 2900 includes a processor 2902, memory 2904, storage 2906, an input/output (I/O) interface 2908, a communication interface 2910, and a bus 2912. Although this disclosure describes and illustrates a particular computer system having a particular number of particular components in a particular arrangement, this disclosure contemplates any suitable computer system having any suitable number of any suitable components in any suitable arrangement.

In particular embodiments, processor 2902 includes hardware for executing instructions, such as those making up a computer program. As an example and not by way of limitation, to execute instructions, processor 2902 may retrieve (or fetch) the instructions from an internal register, an internal cache, memory 2904, or storage 2906; decode and execute them; and then write one or more results to an internal register, an internal cache, memory 2904, or storage 2906. In particular embodiments, processor 2902 may include one or more internal caches for data, instructions, or addresses. This disclosure contemplates processor 2902 including any suitable number of any suitable internal caches, where appropriate. As an example and not by way of limitation, processor 2902 may include one or more instruction caches, one or more data caches, and one or more translation lookaside buffers (TLBs). Instructions in the instruction caches may be copies of instructions in memory 2904 or storage 2906, and the instruction caches may speed up retrieval of those instructions by processor 2902. Data in the data caches may be copies of data in memory 2904 or storage 2906 for instructions executing at processor 2902 to operate on; the results of previous instructions executed at processor 2902 for access by subsequent instructions executing at processor 2902 or for writing to memory 2904 or storage 2906; or other suitable data. The data caches may speed up read or write operations by processor 2902. The TLBs may speed up virtual-address translation for processor 2902. In particular embodiments, processor 2902 may include one or more internal registers for data, instructions, or addresses. This disclosure contemplates processor 2902 including any suitable number of any suitable internal registers, where appropriate. Where appropriate, processor 2902 may include one or more arithmetic logic units (ALUs); be a multi-core processor; or include one or more processors 2902. Although this disclosure describes and illustrates a particular processor, this disclosure contemplates any suitable processor.

In particular embodiments, memory 2904 includes main memory for storing instructions for processor 2902 to execute or data for processor 2902 to operate on. As an example and not by way of limitation, computer system 2900 may load instructions from storage 2906 or another source (such as, for example, another computer system 2900) to memory 2904. Processor 2902 may then load the instructions from memory 2904 to an internal register or internal cache. To execute the instructions, processor 2902 may retrieve the instructions from the internal register or internal cache and decode them. During or after execution of the instructions, processor 2902 may write one or more results (which may be intermediate or final results) to the internal register or internal cache. Processor 2902 may then write one or more of those results to memory 2904. In particular embodiments, processor 2902 executes only instructions in one or more internal registers or internal caches or in memory 2904 (as opposed to storage 2906 or elsewhere) and operates only on data in one or more internal registers or internal caches or in memory 2904 (as opposed to storage 2906 or elsewhere). One or more memory buses (which may each include an address bus and a data bus) may couple processor 2902 to memory 2904. Bus 2912 may include one or more memory buses, as described below. In particular embodiments, one or more memory management units (MMUs) reside between processor 2902 and memory 2904 and facilitate accesses to memory 2904 requested by processor 2902. In particular embodiments, memory 2904 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 2904 may include one or more memories 2904, where appropriate. Although this disclosure describes and illustrates particular memory, this disclosure contemplates any suitable memory.

In particular embodiments, storage 2906 includes mass storage for data or instructions. As an example and not by way of limitation, storage 2906 may include a hard disk drive (HDD), a floppy disk drive, flash memory, an optical disc, a magneto-optical disc, magnetic tape, or a Universal Serial Bus (USB) drive or a combination of two or more of these. Storage 2906 may include removable or non-removable (or fixed) media, where appropriate. Storage 2906 may be internal or external to computer system 2900, where appropriate. In particular embodiments, storage 2906 is non-volatile, solid-state memory. In particular embodiments, storage 2906 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 2906 taking any suitable physical form. Storage 2906 may include one or more storage control units facilitating communication between processor 2902 and storage 2906, where appropriate. Where appropriate, storage 2906 may include one or more storages 2906. Although this disclosure describes and illustrates particular storage, this disclosure contemplates any suitable storage.

In particular embodiments, I/O interface 2908 includes hardware, software, or both, providing one or more interfaces for communication between computer system 2900 and one or more I/O devices. Computer system 2900 may include one or more of these I/O devices, where appropriate. One or more of these I/O devices may enable communication between a person and computer system 2900. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 2908 for them. Where appropriate, I/O interface 2908 may include one or more device or software drivers enabling processor 2902 to drive one or more of these I/O devices. I/O interface 2908 may include one or more I/O interfaces 2908, where appropriate. Although this disclosure describes and illustrates a particular I/O interface, this disclosure contemplates any suitable I/O interface.

In particular embodiments, communication interface 2910 includes hardware, software, or both providing one or more interfaces for communication (such as, for example, packet-based communication) between computer system 2900 and one or more other computer systems 2900 or one or more networks. As an example and not by way of limitation, communication interface 2910 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 2910 for it. As an example and not by way of limitation, computer system 2900 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 2900 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 2900 may include any suitable communication interface 2910 for any of these networks, where appropriate. Communication interface 2910 may include one or more communication interfaces 2910, where appropriate. Although this disclosure describes and illustrates a particular communication interface, this disclosure contemplates any suitable communication interface.

In particular embodiments, bus 2912 includes hardware, software, or both coupling components of computer system 2900 to each other. As an example and not by way of limitation, bus 2912 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 2912 may include one or more buses 2912, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

### Miscellaneous

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising, by one or more computing system:
receiving, at a client system, an utterance from a user;
determining a scenario associated with the utterance, wherein the scenario is based on an intent-slot template comprising a plurality of variables;
generating a final frame for the utterance by imputing one or more spans associated with the utterance into the determined scenario; and
executing one or more tasks corresponding to the utterance, wherein the one or more tasks are determined based on the final frame.

2. A method comprising, by one or more computing system:
detecting, at the client system, a wake word from a user;
encrypting subsequent speech input from the user by an encryption key, wherein the subsequent speech input corresponds to a task;
transmitting, from the client system to a remote server, the encrypted subsequent speech input;
determining, based on the subsequent speech input, that executing the task requires a processing of the subsequent speech input on the remote server;
transmitting, from the client system to the remote server, the encryption key; and
receiving, at the client system from the remote server, a processing result of the decrypted subsequent speech input on the remote server.

3. A method comprising, by one or more computing systems:
receiving, from a client system associated with a user during a first turn of a dialog session, a first portion of a speech input from the user;
predicting, based on the first portion of the speech input by a domain classifier during the first turn of the dialog session, a domain associated with the speech input;
determining, based on the predicted domain, an end-pointing threshold for the speech input;
upon detecting the speech input reaching the end-pointing threshold, executing a task corresponding to the speech input; and
sending, to the client system, instructions for presenting a response associated with an execution of the task.

4. A method comprising, by one or more computing systems:
accessing a vocabulary list comprising a plurality of vocabularies; and
for each of a plurality of rounds until a predetermined number of top words for a global list of most frequent words have been collected:
removing top 1000 most frequent words collected from one or more previous rounds;
collecting, based on a federated analytics mechanism, a plurality of words from one or more online social networks for a predetermined number of days;
determining top 1000 most frequent words from the plurality of collected words in this round; and
adding the determined top 1000 most frequent words to the global list.

5. A method comprising, by one or more computing systems:
accessing a plurality of audios, wherein each of the plurality of audios comprises a user utterance;
determining, based on one or more helper model and a baseline model, a plurality of pseudo labels for the plurality of audios, respectively;
selecting, based on one or more uncertainty metrics and one or more diversity metrics, a subset of the plurality of audios;
identifying one or more incorrect pseudo labels associated with one or more audios from the subset of the plurality of audios;
generating a training set from the subset of the plurality of audios by removing the one or more audios associated with the incorrect pseudo labels from the subset; and
training an automatic speech recognition (ASR) model based on the training set.
